(19) United States
(12) Patent Application Publication
(10) Pub. No.: US 2009/0081387 A1
(43) Pub. Date: Mar. 26, 2009

(54) Method of Producing Cyclic Polyolefin Film, Cyclic Polyolefin Film Produced by the Production Method, Method of Preparing Liquid Dispersion of Fine Particles, Liquid Dispersion of Fine Particles and Method of Preparing Dope

(75) Inventor: Masaya Suzuki, Kanagawa (JP)

Correspondence Address: BUCHANAN, INGERSOLL & ROONEY PC, POST OFFICE BOX 1404, ALEXANDRIA, VA, 22313-1404, US

(73) Assignee: FUJIFILM Corporation, Minato-ku, Tokyo (JP)

(21) Appl. No.: 12/066,669

(22) PCT Filed: Sep. 13, 2006
(86) PCT No.: PCT/JP2006/318549

§ 371 Date: Apr. 4, 2008

(30) Foreign Application Priority Data
Sep. 13, 2005 (JP) 2005-265475
Sep. 26, 2005 (JP) 2005-277603

(51) Int. Cl. B29C 41/24; C08J 5/18; C08J 3/09; G02B 5/30; G02F 1/1335; C08G 61/08; C08K 3/36

(52) U.S. Cl. 428/1.1; 264/331.15; 264/129; 264/291; 428/328; 428/331; 428/220; 428/500; 524/553; 524/493

(57) ABSTRACT

A method of producing a cyclic polyolefin film comprising: dissolving or dispersing a cyclic polyolefin resin and at least one compound selected from a higher fatty acid and a derivative of the higher fatty acid in a solvent; a casting step; a drying step; and a taking-up step; and a method of preparing a liquid dispersion of fine particles, which comprises: subjecting fine particles, an organic solvent and a dispersant to a dispersing treatment, wherein the dispersant contains a cyclic olefin resin.

### TECHNICAL FIELD

The present invention concerns an optically-compensatory film, a polarizing plate, a protective film for use in polarizing plate, as well as a liquid crystal display device using them. It particularly relates to a cyclic polyolefin film for use in them, and a producing process thereof.

Further, the present invention concerns a method of preparing a liquid dispersion of fine particles and a method of preparing a dope used for the production of a cyclic olefin resin for use in optical application and, more in particular, it concerns a polarizing plate and an image display device such as a method of preparing a liquid dispersion of fine particles preferred for production of a cyclic olefin resin film suitable to various functional films such as a phase difference film or, view angle enlarging film used for liquid crystal display devices, etc., and an anti-reflection film used for plasma displays, as well as a cyclic olefin resin film, polarizing plate protective film, etc. using a liquid dispersion of fine particles obtained by the preparation method described above.

### BACKGROUND ART

A polarizing plate is usually produced by bonding a protective film comprising cellulose triacetate as a main ingredient on both sides of a polarizing film formed by orienting and adsorbing iodine or dichroic dye to a polyvinyl alcohol. Cellulose triacetate has been used generally as the protective film for polarizing plates due to the features such as high toughness, flame retardancy, and high optical isotropy (low retardation value). The liquid crystal display device comprises a polarizing plate, a liquid crystal cell, etc. At present, in a TN mode TFT liquid crystal display device which is predominant in the liquid crystal devices, a liquid crystal device of high display quality has been attained by inserting an optically-compensatory sheet (also referred as an optically-compensatory film) between a polarizing plate and a liquid crystal cell as described in JP-A No. 8-50206. However, since cellulose triacetate films absorb or permeate much water content, they involve a problem of tending to change the optical compensation performance or deteriorate a polarizer. Further, the TN liquid crystal display device involves a problem that leakage of light occurs at four sides of a screen due to aging after turning on of a power source or the VA mode liquid crystal display device involves a problem that leakage of light occurs at four corners due to aging after turning-on of the power source.

A cyclic polyolefin film has attracted attention as a film capable of improving the hygroscopicity or moisture permeability of the cellulose triacetate film, and a protective film for use in the polarizing plate by melting film formation and solution film formation has been developed. Further, the cyclic polyolefin films have high developability of optical characteristics and, further, undergo less changes for the optical characteristics due to the change of temperature and humidity, and have been developed as a phase difference membrane (also referred to as a phase difference film) (JP-A Nos. 2003-212927, 2004-126026, and 2002-114827, pamphlet of WO-2004/049011. JP-A No. 2004-151573 discloses a technique of producing a norbornene type film containing fine inorganic particles and a lubricant by the melting film formation. JP-A No. 2005-43740 discloses an optical film comprising a cyclic olefin ring-opened polymer.

### DISCLOSURE OF THE INVENTION

However, the modulus of elasticity of a cyclic polyolefin is generally about 300 kgf/mm² or less, which is lower compared with about 400 kgf/m² of a cellulose acetate film, and creases, etc. tend to occur during handling in the film preparation or fabrication to a polarizing plate or the like and, further, optical characteristics change tending to cause unevenness by stresses considered to occur in this case. Particularly, the solution film forming method which is excellent in the planarity and an excellent film forming method as an optical film compared with the melt-casting method involves a problem that handlability in the film formation is more difficult. Although the apparent reason has not yet been known, this may be attributable to that a film is transported by rollers, etc. also before complete drying in the solution film formation, and apparent modulus of elasticity is decreased more and, at the same time, the frictional property is deteriorated more in the film containing a residual solvent. Further, when a cyclic polyolefin film is stretched, the retardation value and the angle of retarded phase axis tend to result in unevenness in the film forming direction and the direction perpendicular thereto thereby causing image unevenness, etc. when the film is used for liquid crystal display devices and this is a subject to be dissolved.

Further, while it has been known to add fine inorganic particles in the cellulose acetate film, for improving the handlability during film formation, the fine inorganic particles had a drawback of increasing the haze to lower the transparency which is significant to an optical film. Particularly in the melting film formation, when obstacles are added, streaky defects referred to as a dye line occur making it difficult to use as an optical film.

In summary, in the cyclic polyolefin films proposed so far, handling characteristic and occurrence of optical unevenness are not improved, in addition to the provision of characteristic required so far such as excellent hygroscopicity or moisture permeability and with less change of the optical characteristic caused by the change of temperature and humidity, and a development has been demanded for cyclic polyolefin films having all of such characteristics.

First purpose of the present invention is to provide a cyclic polyolefin film excellent in the hygroscopicity or moisture permeability, with less change of the optical characteristic due to the change of temperature and humidity and, further, excellent in the handling characteristic and with no optical unevenness. The invention further intends to provide a polarizing plate or a liquid crystal display device excellent in the stability and the fabrication characteristics in the film formation and with no image unevenness.

In addition, since cyclic olefin film has poor slipperiness between the surfaces of the formed films to each other, it sometimes cause problems that creasing failure tends to occur making handling. For suppressing the creasing failure, it is necessary to provide a film with slipperiness to some extent.

Further, for using the cyclic olefin resin as a polarizing plate in a liquid crystal display, slipperiness on the surface of the film is particularly required. That is, in a case of preparing a polarizing plate by using a polarizing film and the film described above, a hydrophilic treatment of the film, a bonding step for the polarizing film and the film by means of an adhesive, a coating step of applying a hard coat to the film and, further, a transporting operation for conducting such steps. Then, in a case where the scratch resistance at the film surface is not sufficient, the film surface is injured during the operation and a liquid crystal display incorporated with such a film has a fetal display defect.

Generally, for improving the scratch resistance of plastic films, it has been known to incorporate various particles, etc in the film. For example, it has been known to incorporate particles of inorganic compounds or polymeric compounds in a polysulfone polymer film (JP-A No. 6-268522, etc.)

The film of the cyclic olefin resin can be obtained by a solution film forming method in which a dope formed by dissolving, for example, a cyclic olefin resin in a properly selected organic solvent (for example, cyclohexane) is cast on a continuously rotating drum or moving band (support) and then evaporating the solvent. Also for improving the scratch resistance of the cyclic olefin resin, the inorganic compound or the polymeric compound used for the polysulfone polymer film can be used. That is, slipperiness can be provided by dispersing fine particles of the inorganic compound or the polymeric compound in a solvent or a solution comprising a solvent and a small amount of a dispersant, mixing the obtained liquid dispersion with the dope described above and then casting and drying the liquid mixture to form unevenness on the film surface.

In the method of adding fine particles as a matting agent for improving the slipperiness of a film, the dispersed state or dispersion stability of the fine particles are important when using them as the matting agent and an improvement has been demanded therefor.

JP-A No. 2005-103815 discloses an example of forming a cyclic olefin film by adding fine particles as the matting agent.

JP-A No. 2005-103815 discloses a method of obtaining a cast dope by mixing a liquid dispersion of fine particles prepared by dispersion with a dope for producing a cyclic olefin resin film containing fine particles as the matting agent.

However, according to the study of the present inventor, it has been found, in a case of using the liquid dispersion of fine particles obtained by a dispersing treatment using only the solvent and the fine particles disclosed in JP-A No. 2005-103815, that fine particles detached from the film surface are present although the slipperiness at the surface is improved, and it has also been found that the detached particles cause additional problems of resulting in frictional damages or increasing the surface haze to lower the transmittance, or the detached particles act as obstacles to lower the yield in the fabrication step of the polarizing plate. Further, since the dispersion state of the liquid dispersion is instable, coagulates occur unintentionally upon filtration of the liquid dispersion or the dope, to decrease the amount of fine particles in the film by the trapping of the fine particles in the filter material, or trapped fine particles are flown out to cause a worry for the of occurrence of obstacles due to the fine particles.

Accordingly, second purpose of the present invention is to provide a liquid dispersion of fine particles and a dope for producing a cyclic olefin resin film excellent in the slipperiness and light transmittance and reduced with frictional injuries damages and obstacles during fabrication of a polarizing plate by a solution casting method. The invention intends, thirdly, to provide a cyclic olefin resin film excellent in the slipperiness and light transmittance, and reduced with scratch injuries and obstacles during fabrication of the polarizing plate. Fourthly, the invention further intends to provide a protective film for use in polarizing plate, as well as a polarizing plate and a liquid crystal display device excellent in the productivity and obtained at high yield.

As a result of an earnest study, the present inventors have succeeded in improving the handlability during film formation, remarkably mitigating occurrence of creases caused by squeaking upon winding and, at the same time, suppressing increase of the haze by incorporating cyclic polyolefin resins, as well as at least one compound selected from higher fatty acids and derivatives thereof. As a result, it has further been found that a cyclic polyolefin film unexpectedly reduced with the optical unevenness can be obtained to accomplish the invention. Further, it has been found that the subject can be solved more effectively by incorporating fine particles with an average primary grain size of from 0.001 μm to 20 μm as the ingredient of the cyclic polyolefin resin film.

As a result of an earnest study, the present inventor has found that the problems described above are caused by the instable dispersed state of fine particles in an addition solution and has found that the dispersed state of the liquid dispersion is stabilized by applying a dispersing treatment of the fine particles under the presence of a cyclic olefin resin as a dispersant and, further, by changing the kind of the resin used for the dispersant. The present inventor has optimized them to accomplish the invention.

That is, the invention has the following constitution.

(1) A method of producing a cyclic polyolefin film comprising:

dissolving or dispersing a cyclic polyolefin resin and at least one compound selected from a higher fatty acid and a derivative of the higher fatty acid in a solvent;

a casting step; a drying step; and a taking-up step.

(2) A method of producing a cyclic polyolefin film comprising:

dissolving a cyclic polyolefin resin in a solvent;

a casting step; a drying step; and a taking-up step,

wherein the method further comprises coating a coating solution containing at least one compound selected from a higher fatty acid and a derivative of the higher fatty acid on at least one surface of a film after casting.

(3) The method of producing a cyclic polyolefin film as described in (1) or (2) above,

wherein the derivative of the higher fatty acid is a metal salt of the higher fatty acid, an amide compound of the higher fatty acid or an ester compound of the higher fatty acid.

(4) The method of producing a cyclic polyolefin film as described in any of (1) to (3) above,

wherein fine particles having a primary average grain size of from 0.001 μm to 20 μm are added to the cyclic polyolefin resin.

(5) The method of producing a cyclic polyolefin film as described in (4) above,

wherein the fine particles are metal oxides or inorganic silicon compounds.

(6) The method of producing a cyclic polyolefin film as described in any of (1) to (5) above,

wherein a film formed from the solvent is stretched after the casting step.

(7) A cyclic polyolefin film produced by a method as described in any of (1) to (6) above.

(8) The cyclic polyolefin film as described in (7) above,

wherein the cyclic polyolefin film has a thickness of from 20 μm to 500 μm, and a light transmittance of the cyclic polyolefin film at a measured wavelength of 550 nm is 88% or more.

(9) A protective film for a polarizing plate, which comprises a cyclic polyolefin film as described in (7) or (8) above.

(10) An optically-compensatory film comprising a cyclic polyolefin film as described in (7) or (8) above.

(11) A polarizing plate comprising a protective film for a polarizing plate as described in (9) above or an optically-compensatory film as described in (10) above.

(12) A liquid crystal display device comprising at least one of a cyclic polyolefin film as described in (7) or (8) above, a protective film for a polarizing plate as described in (9) above, an optically-compensatory film as described in (10) above and a polarizing plate as described in (11) above.

(13) A method of preparing a liquid dispersion of fine particles, which comprises:

subjecting fine particles, an organic solvent and a dispersant to a dispersing treatment,

wherein the dispersant contains a cyclic olefin resin.

(14) The method of preparing a liquid dispersion of fine particles as described in (13) above,

wherein the cyclic olefin resin has a polar group at a substituent.

(15) The method of preparing a liquid dispersion of fine particles as described in (13) or (14) above,

wherein the fine particles comprise an inorganic compound or a polymeric compound, and an average primary particle size of the inorganic compound or the polymeric compound is from 10⁻³ to 100 μm.

(16) The method of preparing a liquid dispersion of fine particles as described in any of (13) to (15) above,

wherein the fine particles are fine silicon dioxide particles.

(17) A liquid dispersion of fine particles produced by a method of preparing a liquid dispersion of fine particles as described in any of (13) to (16) above.

(18) A method of preparing a dope comprising:

admixing a liquid dispersion of fine particles as described in (17) above to a cyclic olefin resin solution containing a cyclic olefin resin and an organic solvent.

(19) The method of preparing a dope as described in (18) above, which comprises:

transporting the liquid dispersion of the fine particles by a conduit;

in-line adding the liquid dispersion of the fine particles to the cyclic olefin resin solution transported by another conduit at a joint pipe; and then

mixing by an inline mixer.

(20) The method of preparing a dope as described in (18) or (19) above,

wherein the cyclic olefin resin in the liquid dispersion of the fine particles and the cyclic olefin resin in the cyclic olefin resin solution are identical.

(21) The method of preparing a dope as described in any of (18) to (20) above,

wherein the liquid dispersion of the fine particles is obtained by filtration through a filter with an absolute filtration rating of from 10 to 100 μm.

(22) A cyclic olefin resin film produced by a solution casting film forming method utilizing a dope produced by a preparation method as described in any of (18) to (21) above.

(23) The cyclic olefin resin film as described in (22) above,

wherein a static friction coefficient between identical materials to each other is 0.8 or less.

(24) A polarizing plate comprising:

a polarizer; and

at least two protective films disposed on both sides of the polarizer,

wherein at least one of the at least two protective films is a cyclic olefin resin film as described in (22) or (23) above,

(25) A liquid crystal display device comprising at least one of a cyclic olefin resin film as described in (22) or (23) above and a polarizing plate as described in (24) above.

Further, the liquid crystal display device preferably includes the following embodiments.

(26) A TN mode liquid crystal display device as described in (25) above,

wherein at least one of the at least two protective films constituting a polarizing plate used in a liquid crystal display device has an in-plane retardation Re (630) of 15 nm or less, a retardation Rth (630) in a thickness direction is 40 nm or more and, 120 nm or less, and a discotic liquid crystal layer is laminated.

(27) A VA liquid crystal display device as described in (25) above,

wherein at least one of the at least two protective films constituting a polarizing plate used in a liquid crystal display device has an in-plane retardation Re (630) of 15 nm or less, a retardation Rth (630) in a thickness direction is 120 nm or more and, 300 nm or less and a rod-like liquid crystal layer is laminated.

(28) An OCB liquid crystal display device as described in (25) above,

wherein at least one of the at least two protective films constituting a polarizing plate used in a liquid crystal display device has an in-plane retardation Re (630) of 30 nm or more and 70 nm or less, a retardation Rth (630) in a thickness direction is 120 nm or more and 300 nm or less and a discotic liquid crystal layer is laminated.

Re (λ) and Rth (λ) represent Re and Rth measured at a wavelength of λ nm.

### BRIEF DESCRIPTION OF THE DRAWING

FIG. 1 is a view schematically showing an apparatus for measuring the absolute filtration rating;

FIG. 2 is a partial sectional view showing one mode (three layers) of a layer structure of a cyclic polyolefin film according to the invention; and

FIG. 3 is a partial sectional view showing one mode (two layers) of a layer structure of a cyclic polyolefin film according to the invention,

wherein 1 denotes base layer and 2 denotes superficial layer,

### BEST MODE FOR CARRYING OUT THE INVENTION

The present invention is to be described specifically.

In the present specification, descriptions: “(numerical value 1)−(numerical value 2)”, and “(numerical value 1)” to “(numerical value 2)” mean “(numerical value 1) or more and (numerical value 2) or less”.

At first, a method of producing a cyclic polyolefin film and a cyclic polyolefin film obtained by the production method according to the invention, which achieve the first purpose of the present invention, are to be described.

The cyclic polyolefin film of the invention is produced at least containing a cyclic polyolefin resin.

### (Cyclic Polyolefin Resin)

In the invention, the cyclic polyolefin resin represents a polymer resin having a cyclic polyolefin structure. Further, in the invention, the cyclic polyolefin resin is also referred to as a cyclic polyolefin.

Example of the polymer resin having the cyclic olefin structure used in the invention includes (1) norbornene type polymer, (2) polymer of mononuclear cyclic olefin, (3) polymer of cyclic conjugated diene, (4) vinyl cycloaliphatic hydrocarbon polymer, and hydrogenated products of (1) to (4) described above. The polymer resin used preferably in the invention is an addition (co)polymer of cyclic polyolefin containing at least one repetitive units represented by the following formula (1-II) and an addition (co)polymer of cyclic polyolefin further containing optionally at least one repetitive units represented by the formula (1-I). Further, a ring-opening (co)polymer containing at least one repetitive cyclic units represented by the formula (1-III) can also be used suitably.

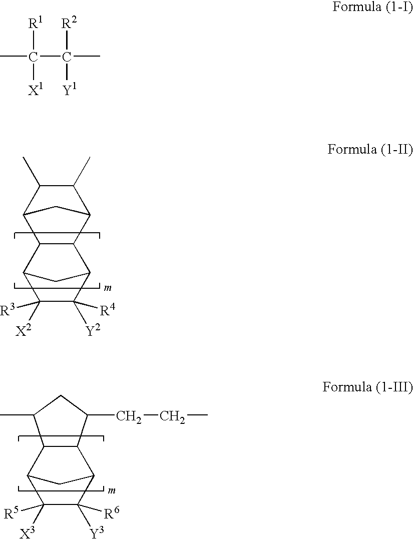

In the formulae, m represents an integer of 0 to 4. R¹ to R⁶ each represents a hydrogen atom or hydrocarbon group of 1 to 10 carbon atoms, X¹ to X³, and Y¹ to Y³ each represents a hydrogen atom, hydrocarbon group of 1 to 10 carbon atoms, halogen atom, hydrocarbon group of 1 to 10 carbon atoms substituted with halogen atom, —(CH₂)ₙCOOR¹¹, —(CH₂)ₙOCOR¹², —(CH₂)ₙNCO, —(CH₂)ₙNO₂, —(CH₂)ₙCN, —(CH₂)ₙCONR¹³R¹⁴, —(CH₂)ₙNR¹³R¹⁴, —(CH₂)ₙOZ, —(CH₂)ₙW, or (—CO)₂O or (—CO)₂NR¹⁵ constituted with X¹ and Y¹, X² and Y², or X³ and Y³. R¹¹, R¹², R¹³, R¹⁴, and R¹⁵ each represents a hydrogen atom, hydrocarbon group of 1 to 20 carbon atoms, Z represents a hydrocarbon group or halogen-substituted hydrocarbon group, W represents SiR¹⁶ₚD₃₋ₚ (R¹⁶ represents a hydrocarbon group of 1 to 10 carbon atoms, D represents a halogen atom, —OCOR¹⁶ or —OR¹⁶, p represents an integer of 0 to 3), and n represents an integer of 0 to 10.

By introducing a highly polarizing functional group to the substituents of X¹ to X³ and Y¹ to Y³, retardation in the width direction of the optical film (Rth) can be increased to increase the developability of the in-plane retardation (Re). A film of high Re developability can increase the Re value by stretching in the course of film formation.

As the norbornene type addition (co)polymer, those described in JP-A No. 10-7732, JP-W No. 2002-504184, Specification of USP 2004-229157-A1, or a pamphlet of WO-2004/070463 A1 can be used. They can be obtained by addition polymerization of norbornene type polycyclic unsaturated compounds to each other. Optionally, unsaturated norbornene type polycyclic compound can be put to addition polymerization with ethylene, propylene, butene, conjugated dienes such as butadiene and isoprene; non-conjugated diene such as ethylidene norbornene; and linear diene compounds such as acrylonitrile, acrylic acid, methacrylic acid, maleic acid anhydride, acrylic acid esters, methacrylic acid ester, maleimide, vinyl acetate, and vinyl chloride.

As the norbornene type addition (co)polymer, commercial products can also be used. Specifically, they are marketed under the trade name of APEL from Mitsui Chemical Co. including those grades, for example, of APL 8008T (Tg 70° C.), APL 6013T (Tg 125° C.) or APL 6015T (Tg 145° C.) of different glass transition temperatures (Tg). Pellets such as TOPAS 8007, 6013, and 6015 are marketed from Polyplastic Co. Further, Appear 3000 is marketed from Ferrania Co.

As the hydrogenated products of norbornene type polymer, those prepared from unsaturated polycyclic compound by addition polymerization or metathesis ring opening polymerization and then hydrogenation can be used as disclosed in JP-A Nos. 1-240517, 7-196736, 60-26024, 62-19801, 2003-1159767, or 2004-309979. In the norbornene type polymer used in the invention, R⁵ to R⁶ are preferably hydrogen atom or —CH₃ and X³ and Y³ are preferably hydrogen atom, Cl, or —COOCH₃, and other groups are selected properly. For the norbornene type resin, commercial products can also be used and, specifically, they are marketed from JRS Co. under the trade name of Arton G or Arton F. Further, they are marketed from Nippon Zeon Co, under the trade names of Zeonor ZF14, or ZF16 and Zeonex 250 or Zeonex 280, which can be used.

In the cyclic polyolefin resin used in the invention, the average mass molecular weight (Mw) measured by gel permeation chromatography (GPC) is, preferably, from 5,000 to 1000,000 and, more preferably, from 10,000 to 500,000 and, further preferably, from 50,000 to 300,000 based on the polystyrene molecular weight. Further, the molecular weight distribution (Mw/Mn; Mn is a number average molecular weight measured by GPC) is, preferably, 10 or less, more preferably, 5.0 or less and, further preferably, 3.0 or less. The glass transition temperature (Tg, measured by DSC) is within a range, preferably, from 50 to 350° C., more preferably, from 80 to 330° C. and, further preferably, from 100 to 300° C.

### (Higher Fatty Acid and Derivative Thereof)

In the invention, by using at least one compound selected from higher fatty acids and derivatives thereof (hereinafter both of them are sometimes referred to collectively as “hither fatty acids”) to the cyclic polyolefin resin, it is possible to further improve the stability in film formation, fabricability of the film, and decrease creases, flexing and optical unevenness of the film due to squeaking during winding. This is considered to be attributable to that the friction coefficient on the surface of the film is lowered to reduce the stress applied on the film upon film handing by the use of at least one compound selected from the higher fatty acids and derivatives thereof.

As the higher fatty acid usable in the invention, saturated or unsaturated chained carboxylic acids of 8 or more and 30 or less of carbon atoms, preferably, 12 or more and 22 or less of carbon atoms can be used. The saturated fatty acid includes, for example, butyric acid, capronic acid, caprylic acid, capric acid, lauric acid, myristic acid, palmitic acid, stearic acid, 1,2-hydroxystearic acid, arachidic acid, behenic acid, lignoceric acid, cerotinic acid, montanic acid, and melissic acid. The unsaturated fatty acids include, for example, caproleic acid, linderic acid, myristoleic acid, palmitoleic acid, petrocenic acid, oleic acid, vaccenic acid, gadoleic acid, eicosenic acid, cetoleic acid, erucic acid, selacoleic acid, linoic acid, hiragoic acid, and linolenic acid. Among them, lauric acid, myristic acid, palmitic acid, stearic acid, arachic acid, behenic acid, lindelic acid, myristoleic acid, palmitoleic acid, petrocenic acid, oleic acid, vaccenic acid, gadoleic acid, eicosenic acid, cetoleic acid, and erucic acid can be used suitably. Further, lauric acid, stearic acid, and behenic acid are favorable in view of stability and slipping property and can be used suitably.

In the invention, derivatives of the higher fatty acids can also used preferably and, as the derivatives, metal salts, amide compounds, and ester compounds are preferred. Among all, metal salts are preferred with a view point of the effect.

The metal salts usable in the invention include those salts of calcium, magnesium, barium, lead, zinc, copper, aluminum, sodium, and potassium. Calcium, barium, zinc, and lead can be used preferably. Specific usable compounds include suitably, for example, calcium laurate, barium laurate, zinc laurate, lead laurate, calcium stearate, barium stearate, zinc stearate, lead stearate, calcium behenate, barium behenate, zinc behenate, and lead behenate.

The amide compounds usable in the invention include higher fatty acid amides and higher fatty acid bisamides. Specifically, they include stearic acid amide, oleic acid amide, behenic acid amide, ethylene bis stearic acid amide, ethylene bis oleic acid amide, etc.

The ester compounds usable in the invention include esterification products of the higher fatty acids described above and mono hydric alcohols, and polyhydric alcohols. Specifically, they can include stearic acid monoglyceride, oleic acid monoglyceride, behenic acid monoglyceride, pentaerythritol tetrastearic acid ester, pentaerythritol tetraoleic acid ester, pentaerythritol tetrabehenic acid ester, dipentaerythritol hexastearic acid ester, dipentaerythritol hexaoleic acid ester, and dipentaerythritol hexabehenic acid ester.

The higher fatty acids and derivatives thereof of the invention can be used each alone or two or more of them may be used in admixture.

At least one compound selected from the higher fatty acids and the derivatives thereof in the invention can be used in a molecular dispersed state or particulate dispersed state.

In particle dispersion, since haze increases to lower the transparency, the average grain size is, preferably, from 0.001 μm to 100 μm, more preferably, from 0.01 μm to 10 μm and, further preferably, from 0.01 μm to 5 μm.

Further, irrespective of the case where they are dispersed in a particulate form or an indefinite shape, or in a case where they are dispersed in a molecular state, the content is, preferably, from 0.0001 mass % to 10 mass %, more preferably, from 0.001 mass % to 5 mass % and, further preferably, from 0.01 mass % to 3 mass % in the entire cyclic polyolefin film. (In this specification, mass ratio is equal to weight ratio.)

A preferred range for the light transmittance of the cyclic olefin film in the invention is 88.0% or more, more preferably, 89.0% or more and, particularly preferably, 90.0% or more. The transmittance was measured for a specimen of 13 mm×40 mm, at 25° C., 60% RH by a photospectrometer (U-3210, produced by Hitachi Ltd.) at a measuring wavelength of 550 nm.

In the cyclic olefin film with addition of the higher fatty acid and the derivative thereof, the dynamic friction coefficient is, preferably, 0.8 or less, more preferably, 0.5 or less and, particularly preferably, 0.3 or less. The dynamic friction coefficient can be measured by using a steel ball in accordance with a method specified by JIS or ASTM.

While there is no particular restriction on the methods of incorporating the compound in the film, they include, for example, a method of forming a film by casting a solution containing a cyclic polyolefin resin and the compound described above, a method of coating a coating solution containing the compound described above to a film after casting a cyclic polyolefin resin, or a method of stacked layer casting. In the invention, the cyclic polyolefin film is produced by one of the following two production methods.

l. A method of producing a cyclic polyolefin film including a step of dissolving or dispersing cyclic polyolefin resins, as well as at least one compound selected from higher fatty acids and derivatives thereof in a solvent, a casting step, a drying step and a taking-up step.
2. A method of producing a cyclic polyolefin film including a step of dissolving a cyclic polyolefin resin in a solvent, a casting step, a drying step and a taking-up step in which the method includes a step of coating a coating solution containing at least one compound selected from higher fatty acids and derivatives thereof on one surface of the film after casting.

A cyclic polyolefin film suitable to an optical film excellent in planarity, uniformness, etc. can be produced by either of the two methods described above.

In the method 1 described above, a solution containing the cyclic polyolefin resin and the compound described above is cast to form a film. In this method, the compound may be dissolved or dispersed upon preparing the cyclic polyolefin solution, or a solution or a liquid dispersion of the compound may be added just before casting the cyclic polyolefin solution, In the preparation of the liquid dispersion, known methods using, for example, a usual stirrer, a high speed stirrer for use in a homogenizer, dispersion using media such as a ball mill, paint shaker or DYNO-mill or a supersonic disperser can be used. In a case of dispersing the compound into the cyclic polyolefin solution, a surfactant or a polymer used usually as a dispersion aid may be added by a small amount.

In the method 2 described above, “coating solution” may suffice to contain the compound as the main ingredient. Simply, a solution or a liquid dispersion in which the compound is dissolved or dispersed in an appropriate solvent may be coated on the surface of a layer comprising the olefinic resin as a main ingredient (that is, a film after casting). Further, the coating solution may also contain a binder, or a layer containing the compound may be formed by coating the coating solution.

The coating solution can be coated on one side or both sides of a layer comprising the cyclic polyolefin resin as the main ingredient.

The binder for forming the layer of the compound is not particularly restricted and it may be an oleophilic binder or a hydrophilic binder. As the oleophilic binder, known thermoplastic resin, thermosetting resin, radiation-curable resin, reactive resin, and a mixture thereof can be used. Tg of the resin is, preferably, from 80° C. to 400° C. and, more preferably, from 120° C. to 350° C. The average mass molecular weight of the resin is, preferably, from 10,000 to 1,000,000 and, more preferably, from 10,000 to 500,000. In a case of dispersing the compound in the coating solution, the dispersion method identical with the method 1 described above can be used, and a surfactant used usually as a dispersion aid or a polymer may be added in a small amount.

The thermoplastic resin includes vinylic copolymers such as vinyl chloride-vinyl acetate copolymer, copolymers of vinyl chloride or vinyl acetate with vinyl alcohol, maleic acid and/or acrylic acid, vinyl chloride-acrylonitrile copolymer, vinyl chloride-acrylonitrile copolymer, and ethylene-vinyl acetate copolymer, cellulose derivatives such as nitrocellulose, cellulose acetate propionate, cellulose acetate butyrate resins, rubber type resins such as cyclic polyolefin resin, acrylic resin, polyvinyl acetal resin, polyvinyl butyral resin, polyester polyurethane resin, polyether polyurethane, polycarbonate polyurethane resin, polyester resin, polyether resin, polyamide resin, amino resin, styrene-butadiene resin, butadiene-acrylonitrile resin, silicone type resin, and fluoro resin.

The thickness of the layer containing the compound described above is, preferably, from 0.0001 to 10 μm, more preferably, from 0.001 to 5 μm and, further preferably, from 0.01 to 1 μm.

Further details for the method of producing the cyclic polyolefin film are to be described later.

### (Fine Particles)

In the invention, by adding fine particles to the cyclic polyolefin resin and the higher fatty acids, the stability in the film formation and fabricability of the film can be further improved to reduce the optical unevenness in the film caused by squeaking winding, etc. As the fine particles usable in the invention, fine particles of organic or inorganic compounds can be used.

As the inorganic compound, compounds containing silicon, silicon dioxide, titanium oxide, zinc oxide, aluminum oxide, barium oxide, zirconium oxide, strontium oxide, antimony oxide, tin oxide, tin-antimony oxide, calcium carbonate, talc, clay, baked kaolinite, baked calcium silicate, hydrated calcium silicate, aluminum silicate, magnesium silicate, calcium silicate, etc. are preferred, and, silicon-containing organic compounds or metal oxides are further preferred. That is, in the invention, metal oxides or inorganic silicon compounds are used preferably as the fine particles. In the invention, silicon dioxide is used particularly preferably since the cloudiness of the film can be decreased. As the fine particles of silicon dioxide, commercial products, for example, having the commercial names such as Aerosil R972, R974, R812, 200, 300, R202, OX50, TT600 (produced by Nippon Aerosil Co.) can be used. As the fine particles of zirconium oxide, those marketed under the commercial names, for example, of aerosol R976 and R811 (all of them produced by Nippon Aerosil Co.) can be used.

The organic compound includes polytetrafluoroethylene, cellulose acetate, polystyrene, polymethyl methacrylate, polypropyl methacrylate, polymethyl acrylate, polyethylene carbonate, and starch, as well as include pulverized classified products thereof. Alternatively, polymeric compounds synthesized by a suspension polymerization method, polymeric compounds formed into a spheric shape by a spray dry method or a dispersion method, etc. can also be used.

The average primary particle grain size of the fine particles is, preferably, from 0.001 μm to 20 μm, more preferably, from 0.001 μm to 10 μm, further preferably, from 0.002 μm to 1 μm and, particularly preferably, from 0.005 μm to 0.5 μm with a view point of restricting the haze to a low level. The primary average particle size of the fine particles can be measured by determining the average grain size of the particles by a transmission type electron microscope. Since purchased fine particles are often agglomerated, it is preferred to disperse them by a known method before use. It is preferred that the secondary particle size is controlled by dispersion, preferably, to 0.2 μm to 1.5 μm and, more preferably, 0.3 μm to 1 μm. The addition amount of the fine particles based on 100 mass parts of the cyclic polyolefin resin is, preferably, from 0.01 mass parts to 0.3 mass parts, more preferably, from 0.05 mass parts to 0.2 mass parts and, most preferably, 0.08 mass parts to 0.12 mass parts.

### (Additive)

Various additives (for example, aging inhibitor, UV-ray inhibitor, retardation (optical anisotropy) developer, fine particle separation accelerator, plasticizer, IR absorbent, etc.) can be added to the cyclic polyolefin film of the invention depending on the application use in each of the film producing steps, and they may be either solids or oily products. That is, they are not particularly restricted in view of the melting point and the boiling point thereof. For example, they include mixtures of UV-ray absorbing materials of 20° C. or lower and 20° C. or higher and in the same manner, mixtures of aging inhibitors, Furthermore, IR-absorbing dye is described, for example, in JP-A No. 2001-194522. Further, as the timing of addition, they may be added at any stage in the step of preparing the cyclic polyolefin solution (dope), they may be added by additionally providing a step of adding and preparing additives at the final preparation step of the dope preparation step. Furthermore, the addition amount for each of the materials is not particularly restricted so long as the function is developed. Further, in a case where the cyclic polyolefin film is formed of multiple layers, the kind and the addition amount of the additives in each of the layers may be different.

### (Aging Inhibitor)

In the invention, known aging (oxidizing) inhibitors can be added to the cyclic polyolefin solution and, for example, they include phenol or hydroquinone type antioxidant such as 2,6-di-t-butyl, 4-methylphenol, 4,4′-thiobisp(6-t-butyl-3-methylphenol), 1,1′-bis(4-hydroxyphenyl)cyclohexanone, 2,2′-methylenebis(4-ethyl-6-t-butylphenol), 2,5-di-t-butylhydroquinone, and pentaerythrityl-tetrakiss[3-(3,5-di-t-butyl-4-hydroxyphenyl) propionate]. Further, it is preferred to add phosphoric antioxidants such as tris(4-methoxy-3,5-diphenyl)phosphate, tris(nonylphenyl)phosphite, tris(2,4-di-t-butylphenyl)phosphite, bis(2,6-di-t-butyl-4-methylphenyl)pentaerythritol diphosphite, and bis(2,4-di-t-butylphenyl)pentaerythritol diphosphite. The addition amount of the antioxidant is from 0.05 to 5.0 mass parts based on 100 parts of the cyclic polyolefin resin.

### (UV-Absorbent)

In the Invention, a UV-Absorbent is Used Preferably to the Cyclic Polyolefin solution with a view point of preventing the deterioration of a polarizing plate or liquid crystals, UV-absorbents with less absorption for visible light at a wavelength of 400 nm or more are used preferably with a view point of excellent absorbancy of UV-light at a wavelength of 370 nm or less and favorable liquid crystal display property. Specific examples of the UV-absorbents used preferably in the invention include, for example, hindered phenol type compounds, oxybenzophenon type compounds, benzotriazole type compound, salicylate ester type compounds, benzophenone type compounds, cyanoacrylate type compounds, and nickel complex salt type compounds. Examples of the hindered phenolic compounds include, for example, 2,6-di-tert-butyl-p-cresole, pentaerythrityl-tetrakis[3-(3,5-di-tert-butyl-4-hydroxyphenyl)propionate], N,N′-hexamethylenebis(3,5-di-tert-butyl-4-hydroxy-hydrocinnamide), 1,3,5-trimethyl-2,4,6-tris(3,5-di-tert-butyl-4-hydroxybenzyl)benzene, and tris-(3,5-di-tert-butyl-4-hydroxybenzyl)-isocyanurate. Examples of the benzotriazole type compounds include, for example, 2-(2′-hydrixy-5′-methylphenyl)benzotriazole, 2,2-methylenebis(4-(1,1,3,3-tetramethylbutyl)-6-(2H-benzotriazol-2-yl)phenol), (2,4-bis-(n-octylthio)-6-(4-hydroxy-3,5-di-tert-butylanilino)-1,3,5-triazine, triethyleneglycol-bis[3-(3-tert-butyl-5-methyl-4-hydroxyphenyl)propionate], N,N′-hexamethylenebis(3,5-di-tert-butyl-4-hydroxy-hydrocinnamide), 1,3,5-trimethyl-2,4,6-tris(3,5-di-tert-butyl-4-hydroxybenzyl)benzene, 2(2′-hydroxy-3′,5′-di-tert-butylphenyl)-5-chlorbenzotriazole, 2(2′-hydroxy-3′,5′-di-tert-amylphenyl)-5-chlorbenzotriazole, 2,6-di-tert-butyl-p-crezole, and pentaerythrityl-tetrakis[3-(3,5-di-tert-butyl-4-hydroxyphenyl)propionate]. The addition amount of the UV-inhibitor is, preferably, from 1 ppm to 1.0% and, more preferably, from 10 to 1000 ppm at the mass ratio based on the entire cyclic polyolefin film.

### (Retardation Developer)

In the invention, a compound having at least two aromatic rings can be used as a retardation developer for developing a retardation value. In a case of using the retardation developer, it is, preferably, used in a range from 0.05 to 20 mass parts, more preferably, used in a range from 0.1 to 10 mass parts, further preferably, used in a range from 0.2 to 5 mass parts and, most preferably, used in a range from 0.5 to 2 mass parts based on 100 mass parts of the cyclic polyolefin resin. Two or more kinds of retardation developers may also be used in combination.

The retardation developer preferably has a maximum absorption in a wavelength region from 250 to 400 nm and, preferably, has no substantial absorption in a visible region.

In the present specification, “aromatic ring” includes an aromatic hetero ring in addition to the aromatic hydrocarbon ring. The aromatic hydrocarbon ring is particularly preferably a 6-membered ring (that is, benzene ring). The aromatic hetero ring is generally an unsaturated hetero ring. The aromatic hetero ring is, preferably, a 5-membered ring, 6-membered ring or 7-membered ring and, further preferably, 5-membered ring or 6-membered ring. Aromatic hetero rings generally have utmost double bonds. As the hetero atom, a nitrogen atom, an oxygen atom, and a sulfur atom are preferred, with the nitrogen atom being particularly preferred. Examples of the aromatic hetero ring include a furan ring, thiphene ring, pyrrole ring, oxazole ring, isooxazole ring, thiazole ring, isothiazole ring, imidazole ring, pyrazole ring, furazan ring, triazole ring, pyran ring, pyridine ring, pyridazine ring, pyrimidine ring, pyridine ring, and 1,3,5-triazine ring. As the aromatic ring, benzene ring, furan ring, thiophene ring, pyrrole ring, oxazole ring, thiazole ring, imidazole ring, triazole ring, pyridine ring, pyrimidine ring, pyrazine ring, and 1,3,5-triazine ring are preferred, 1,3,5-triazine ring being used particularly preferably. Specifically, those compounds described, for example, in the JP-A No 2001-166144 are used preferably.

The retardation developer has aromatic rings by the number of, preferably, from 2 to 20, more preferably, from 2 to 12, further preferably, from 2 to 8 and, more preferably, 2 to 6. The connection relation between the two aromatic rings can be classified into (a) a case of forming a condensed ring, (b) a case of direct coupling by a single bond and (c) a case of bonding by way of a connection group (spiro bonding can not be formed in view of the heterocyclic rings). The bonding relation may be any of (a) to (c).

Examples of the condensed ring (condensed ring of two or more aromatic rings) in (a) include indene ring, naphthalene ring, azulene ring, fluorene ring, phenanthrene ring, anthracene ring, acenaphthylene ring, biphenylene ring, naphthacene ring, pyrene ring, indole ring, isoindole ring, benzofuran ring, benzothiophene ring, indolizine ring, benzooxazole ring, benzothiazole ring, benzoimidazole ring, benzotriazole ring, purine ring, indazole ring, chromene ring, quinoline ring, isoquinoline ring, quinolidine ring, quinazoline ring, cynnoline ring, quinoxaline ring, phthalazine ring, pteridine ring, carbazole ring, acridine ring, phenanthridine ring, xanthene ring, phenazine ring, phenothiazine ring, phenoxathine ring, phenoxadine ring, and thianthrene ring. Naphthalene ring, azulene ring, indole ring, benzooxazole ring, benzothiazole ring, benzoimidazole ring, benzotriazole ring, and quinoline ring are preferred.

Single bond in (b) is preferably a bond between carbon atoms of the two aromatic rings. An aliphatic ring or non-aromatic heterocyclic ring may also be formed between two aromatic rings by bonding two aromatic rings with two or more single bonds.

Also the connection group in (c) is preferably bonded with carbon atoms of the two aromatic rings. The connection group is preferably alkylene group, alkenylene group, alkynylene group, —CO—, —O—, —NH—, —S—, or combination thereof, Example of the connection group comprising the combination are shown below. The left-to-right relation for the following connection groups may be in an opposite relation.

c1: —CO—O—

### C2: —CO—NH—

C3: -alkylene-O—

### C4: —NH—CO—NH—

### C5: —NH—CO—O—

### C6: —O—CO—O—

### C7: —O-alkylene-O—

### C8: —CO-alkenylene-

### C9: —CO-alkenylene-NH—

### C10: —CO-alkenylene-O—

C11: -alkylene-CO—O-alkylene-O—CO-alkylene-

### C12: —O-alkylene-CO—O-alkylene-O—CO-alkylene-O—

### C13: —O—CO-alkylene-CO—O—

### C14: —NH—CO-alkenylene-

### C15: —O—CO-alkenylene-

The aromatic ring and the connection group may have a substituent. Examples of the substituent include halogen atoms (F, Cl, Br, I), hydroxyl, carboxyl, cyano, amino, nitro, sulfo, carbamoyl, sulfamoyl, ureido, alkyl group, alkenyl group, alkynyl group, aliphatic acid group, aliphatic acyloxy group, alkoxy group, alkoxycarbonyl group, alkoxycarbonylamino group, alkylthio group, alkylsulfonyl group, aliphatic amide group, aliphatic sulfoneamide group, aliphatic substituted amino group, aliphatic substituted carbamoyl group, aliphatic substituted sulfamoyl group, aliphatic substituted ureido group, and non-aromatic heterocyclic ring.

The number of carbon atoms in the alkyl group is, preferably, from 1 to 8. A chained alkyl group is preferred to a cyclic alkyl group and a linear alkyl group is particularly preferred. The alkyl group may further have a substituent (for example, hydroxyl, carboxy, alkoxy group, alkyl-substituted amino group). Examples of the alkyl group (including substituted alkyl group) include methyl, ethyl, n-butyl, n-hexyl, 2-hydroxethyl, 4-carboxybutyl, 2-methoxyethyl and 2-diethylamino ethyl.

The number of carbon atoms in the alkenyl group is preferably, from 2 to 8. A chained alkenyl group is preferred to a cyclic alkenyl group and a linear alkenyl group is particularly preferred, The alkenyl group may further have a substituent. Examples of the alkenyl group include vinyl, allyl, and 1-hexenyl. The number of carbon atoms in the alkynyl group is, preferably, from 2 to 8. A chained alkynyl group is preferred to a cyclic alkenyl group and a linear alkynyl group is particularly preferred. The alkynyl group may further have a substituent. Examples of the alkynyl group include, ethynyl, 1-butynyl, and 1-hexynyl.

The number of carbon atoms in the aliphatic acyl group is, preferably, from 1 to 10. Examples of the aliphatic acyl group include acetyl, propanoyl, and butanoyl. The number of carbon atoms in the aliphatic acyloxy group is, preferably, from 1 to 10. Examples of the aliphatic acyloxy group include acetoxy. The number of carbon atoms in the alkoxy group is, preferably, from 1 to 8. The alkoxy group may have substituent (for example, alkoxy group). Examples of the alkoxy group (including substituted alkoxy group) include methoxy, ethoxy, butoxy, and methoxyethoxy. The number of carbon atoms in the alkoxy carbonyl group is, preferably, from 2 to 10. Examples of the alkoxycarbonyl group include methoxycarbonyl and ethocycarbonyl. The number of carbon atoms in the alkoxycarbonyl group is, preferably, from 2 to 10. Examples of the alkoxycarbonyl amino group include methoxycarbonyl amino and ethoxycarbonyl amino.

The number of carbon atoms in the alkylthio group is, preferably, from 1 to 12. Examples of the alkylthio group include methylthio, ethylthio, and octylthio. The number of carbon atoms in the alkylsulfonyl group is, preferably, from 1 to 8. Examples of the alkylsulfonyl group include methane sulfonyl and ethane sulfonyl. The number of carbon atoms in the aliphatic amino group is, preferably, from 1 to 10. Examples of the aliphatic amide group include acetoamide. The number of carbon atoms in the aliphatic sulfone amide is, preferably, from 1 to 8. Examples of the aliphatic sulfone amide group include methane sulfone amide, butane sulfone amide, and n-octane sulfone amide. The number of carbon atoms in the aliphatic substituted amino group is, preferably, from 1 to 10. Examples of the aliphatic substituted amino group include dimethyl amino group, diethylamino, and 2-carboxyethylamino.

The number of carbon atoms in the aliphatic substituted carbamoyl group is, preferably, from 2 to 10. Examples of the aliphatic substituted carbamoyl group include methyl carbamoyl and diethyl carbamoyl. The number of carbon atoms in the aliphatic substituted sulfamoyl group is, preferably, from 1 to 8. Examples of the aliphatic substituted sulfamoyl group include methyl sulfamoyl and diethyl sulfamoyl. The number of carbon atoms in the aliphatic substituted ureido group is, preferably, from 2 to 10.

Examples of the aliphatic substituted ureido group include methyl ureido. Examples of the non-aromatic heterocyclic group include piperidino and morpholino. The molecular weight of the retardation developer is, preferably, from 300 to 800.

In the invention, a rod-like compound having a linear molecular structure in addition to the compound using the 1,3,5-triazine ring can also be used preferably. The linear molecular structure means that the molecular structure of the rod-like compound is linear in the thermodynamically most stable structure The thermodynamically most stable structure can be determined by analysis for crystal structure or molecular orbit calculation. For example, a molecular structure in which the heat of formation of the compound becomes minimum can be determined by conducting molecular orbit calculation using a molecular orbit calculation software (for example, WinMOPAC2000, produced by Fujitsu Co.). A linear molecular structure means that an angle constituted with the main chain in the molecular structure is 140 degree or more in a thermodynamically most stable structure obtained by calculation as described above.

As the rod-like compound having at least two aromatic rings, a compound represented by the following formula (1-IV) is preferred.

Ar¹-L¹-Ar² Formula (1-IV)

In the formula (1-IV) described above, Ar¹ and Ar² each represents independently an aromatic group. In the present specification, the aromatic group includes an aryl group (aromatic hydrocarbon group), substituted aryl group, aromatic heterocyclic ring, and substituted aromatic heterocyclic group. The aryl group and the substituted aryl group are preferred to the aromatic heterocyclic and the substituted aromatic heterocyclic group. The hetero ring in the aromatic heterocyclic group is generally unsaturated. The aromatic heterocyclic group is preferably a 5-membered ring, 6-membered ring, or 7-membered ring, the 5-membered ring or 6-membered ring being more preferred. The aromatic hetero ring generally has utmost double bonds. As the hetero atom, a nitrogen atom, oxygen atom, or sulfur atom is preferred, and the nitrogen atom or sulfur atom is more preferred. As the aromatic ring in the aromatic group, benzene ring, furan ring, thiophene ring, pyrrole ring, oxazole ring, thiazole ring, imidazole ring, triazole ring, pyridine ring, pyrimidine ring, and pyrazine ring are preferred, the benzene ring being particularly preferred.

In the formula (1-IV), L¹ is a bivalent connection group selected from an alkylene group, alkenylene group, alkynylene group, —O—, —CO— and a group comprising a combination thereof. The alkylene group may have a cyclic structure The cyclic alkylene group is preferably cyclohexylene and 1,4-cyclohexylene is particularly preferred. As the chained alkylene group, a linear alkylene group is preferred to the branched alkylene group. The number of carbon atoms in the alkylene group is, preferably, from 1 to 20, more preferably, from 1 to 15, further preferably, from 1 to 10, furthermore preferably, from 1 to 8 and, most preferably, from 1 to 6.

The alkenylene group and the alkynylene group preferably have a chained structure than the cyclic structure, and, more preferably, have a linear structure than the branched structure. The number of the carbon atoms in the alkenylene group and the alkynylene group is, preferably, from 2 to 10, more preferably, from 2 to 8, further preferably, from 2 to 6, furthermore preferably, from 2 to 4 and, most preferably, 2 (vinylene or ethynylene). The number of carbon atoms in the arylene group is, preferably, from 6 to 20, preferably, from 6 to 16 and, more preferably, from 6 to 12. In the molecular structure of the formula (1-IV), the angle formed between Ar¹ and Ar² with L¹ being put therebetween is preferably 140° or more.

As the rod-like compound, a compound represented by the following formula (1-V) is more preferred.

Ar¹-L²-X-L³-Ar² Formula (1-V)

In the formula (1-V), Ar¹ and Ar² each represents independently an aromatic group. The definition and the examples for the aromatic group are identical with those for Ar¹ and Ar² in the formula (1-IV).

In the formula (1-V), L² and L³ each represents independently a bivalent connection group selected from the group consisting of alkylene group, —O—, —CO— and a combination thereof. The alkylene group preferably has a chained structure than the cyclic structure and it is further preferably has a linear structure than the branched structure. The number of the carbon atoms in the alkylene group is, preferably, from 1 to 10, more preferably, from 1 to 8, further preferably, 1 to 6, furthermore preferably, 1 to 4 and, most preferably, 1 or 2 (methylene or ethylene). L² and L³ are particularly preferably —O—CO— or —CO—O—. In the formula (1-V), X is 1,4-cyclohexylene, vinylene, or ethynylene. Rod-like compounds having a maximum absorption wavelength (λmax) shorter than the wavelength of 250 nm in a UV-ray absorption spectrum of the solution may be used by two or more in combination,

The addition amount of the retardation developer is, preferably, from 0.1 to 30 mass parts and, more preferably, from 0.5 to 20 mass parts based on 100 mass parts of the cyclic polyolefin resin,

### (Peeling Accelerator)

As additives for decreasing the peeling resistance of the cyclic polyolefin film, many additives having remarkable effect have been found in the surfactants. As preferred peeling accelerator, phosphate ester type surfactants, carbonate salt type surfactants, sulfonate salt type surfactants, and sulfate ester type surfactants are effective. Further, a fluoro surfactant in which a portion of hydrogen atoms bonded to the hydrocarbon chain of the surfactant is substituted with fluorine atoms is effective, Examples of the peeling accelerator that can be used preferably in the invention are shown below.

### RZ-1: C₈H₁₇O—P(═O)—(OH)₂

### RZ-2: C₁₂H₂₅O—P(═O)—(OK)₂

### RZ-3: C₁₂H₂₅OCH₂CH₂O—P(═O)—(OK)₂

### RZ-4: C₁₅H₃₁(OCH₂CH₂)₅O—P(═O)—(OK)₂

### RZ-5: {C₁₂H₂₅O(CH₂CH₂O)₅}₂—P(═O)—OH

### RZ-6: {C₁₈H₃₅O(OCH₂CH₂O)₈}₂—P(═O)—ONH₄

RZ-7: (t-C₄H₉)₃—C₆H₂—OCH₂CH₂O—P(═O)—(OK)₂
RZ-8: (iso-C₉H₁₉—C₆H₄—O—(CH₂CH₂O)₅—P(═O)—(OK)(OH)

### RZ-9: C₁₂H₂₅SO₃Na

### RZ-10: C₁₂H₂₅OSO₃Na

### RZ-11: C₁₇H₃₃COOH.N(CH₂CH₂OH)₃

RZ-12: iso-C₈H₁₇—C₆H₄—O—(CH₂CH₂O)₃—(CH₂)₂SO₃Na
RZ-14: sodium triisopropyl naphthalene sulfonate
RZ-13: (iso-C₉H₁₉)₂—C₆H₃—O—(CH₂CH₂O)₃—(CH₂)₄SO₃Na
RZ-15: sodium tri-t-butyl naphthalene sulfonate

### RZ-16: C₁₇H₃₃CON(CH₃)CH₂CH₂SO₃Na

### RZ-17: C₁₂H₂₅C₆H₄SO₃.NH₄

The addition amount of the peeling accelerator is, preferably, from 0.05 to 5 mass parts, more preferably, from 0.1 to 2 mass parts and, most preferably, from 0.1 to 0.5 mass parts based on the cyclic polyolefin resin.

### (Plasticizer)

The cyclic polyolefin resin generally lacks in flexibility compared with cellulose acetate and, when the film undergoes bending stress or share stress, cracks, etc, tend to be formed in the film. Further, upon fabrication of an optical film, cracks tend to be formed at a cut portion tending to cause cutting dusts. Formed cutting dusts contaminate the optical film to cause optical defects. In order to improve such problems, a plasticizer can be added. Specifically, they include phthalate esters, trimellitate esters, aliphatic dibasic acid esters, normal phosphate esters, acetate esters, polyester-epoxidized esters, licinolate esters, and polyolefin type and polyethylene glycol type compounds.

The usable plasticizer is preferably selected from compounds which are liquid at a normal temperature and a normal pressure and having a boiling point of 200° C. or higher. Specific compound can include the followings. They include, aliphatic dibasic acid esters, for example, dioctyl adipate (230° C./760 mmHg), dibutyl adipate (145° C./4 mmHg), di-2-ethylhexyl adipate (335° C./760 mmHg), dibutyl glycol adipate (230 to 240° C./2 mmHg), di-2-ethylhexyl azelate (220 to 245° C./4 mmHg), and di-2-ethylhexyl cebacate (377° C./760 mmHg); phthalate diester type, for example, diethyl phthalate (298° C./760 mmHg), dipheptyl phthalate (235 to 245° C./10 mmHg), di-n-octyl phthalate (210° C./760 mmHg), and diisodecyl phthalate (420° C./760 mmHg); and polyolefinic type, for example, paraffin wax such as normal paraffin, isoparaffin, and cycloparaffin (average molecular weight: 330 to 600, melting point: 45 to 80° C.), liquid paraffins (ISOVG8, VG15, VG 32, VG68, VTG100, according to JIS standard K2231, etc.), paraffin pellets (melting point 56 to 58° C., 58 to 60° C., 60 to 62° C., etc.), chlorinated paraffin, low molecular weight polyethylene, low molecular weight polypropylene, low molecular weight polyisobutene, hydrogenated polybutadiene, hydrogenated polyisoprene, and squalane.

The addition amount of the plasticizer based on 100 mass parts of the cyclic polyolefin resin is from 0.5 to 40.0 mass parts, preferably, from 1.0 mass parts to 30.0 mass parts and, more preferably, from 3.0 to 20.0 mass parts. In a case where the addition amount of the plasticizers less than the amount described above, the plasticizing effect is insufficient and the fabricability is not improved. Further, with an excessive amount than described amount, the plasticizer is sometimes separated and leached with lapse of long time, which is not preferred causing optical unevenness, contamination to other components, etc.

A method of producing the cyclic polyolefin film according to the invention is to be described specifically.

In the production method of the invention, the cyclic polyolefin film is produced by any of the two production methods as described above.

1. A method of producing a cyclic polyolefin film including a step of dissolving or dispersing a cyclic polyolefin resin, and at least one compound selected from higher fatty acids and derivatives thereof in a solvent, a casting step, a drying step and a taking-up step.
2. A method of producing a cyclic polyolefin film including a step of dissolving a cyclic polyolefin resin in a solvent, a casting step, a drying step and a taking-up step, in which the method includes a step of coating a coating solution containing at least one compound selected from higher fatty acids and derivatives thereof at least on one surface of the film after casting.

Further, stretching is applied preferably after the casting step described above.

The two production methods 1 and 2 described above are different in the way of incorporating the higher fatty acids to the cyclic polyolefin film as described above in the paragraph of: (higher fatty acid and derivative thereof). In the first method, higher fatty acids are dissolved or dispersed in one identical layer comprising the cyclic polyolefin resin as the main ingredient, whereas the second method is different in that a coating solution containing the higher fatty acids is coated to the layer comprising the cyclic polyolefin resin as the main ingredient. Hereinafter, description is to be made specifically on every steps from (dissolving step, preparation of dope) to (taking-up step after drying). The production method 1 is identical with the production method 2 excepting that the higher fatty acids are dissolved or dispersed and added as described above in the paragraph of: (higher fatty acid and derivative thereof) in (dissolving step, preparation of dope).

At first, the material ingredients are respectively dissolved in a solvent to be described later to prepare a cyclic polyolefin solution (dope). Preparation of the dope includes a method by dissolution under stirring at a room temperature, a cooling-dissolving method of stirring at a room temperature to swell a cyclic polyolefin resin or the like, then cooling from −20 to −100° C. and then dissolving the same by heating again to 20 to 100° C., a high temperature melting method of dissolving while elevating the temperature above the boiling point of a main solvent in a sealed vessel and, further, a method of dissolving by increasing the temperature and the pressure till the critical point of the solvent. A cyclic polyolefin resin of high solubility is preferably dissolved at a room temperature, whereas a cyclic polyolefin resin of poor solubility is dissolved under heating in a sealed vessel. For those having not so poor solubility, it is efficient to select a temperature as low as possible.

In the invention, the viscosity of the cyclic polyolefin solution is, preferably, within a range from 1 to 500 Pa·s at 25° C. More preferably, it is in a range from 5 to 200 Pa·s. The viscosity was measured as described below. 1 mL of a specimen solution was measured by using a Steel Cone of a diameter 4 cm/2° for a rheometer (CLS 500) (both produced by TA Instruments Co.).

After previously keeping the temperature of the specimen solution to a constant liquid temperature for the measurement starting temperature, measurement was started.

A solvent used upon preparation of the dope is to be described. In the invention, solvents that can be used are not particularly restricted so long as the they can attain the purpose to the extent that the cyclic polyolefin resin, etc. can be dissolved, cast, and formed into a film. The solvent used in the invention is, preferably, solvents selected from chloro-solvents, for example, dichloromethane and chloroform, chained hydrocarbons, cyclic hydrocarbons, aromatic hydrocarbons, esters, ketones, and ethers of 3 to 12 carbon atoms. The ester, ketones and ether may have a cyclic structure. Examples of the chained hydrocarbons of 3 to 12 carbon atoms include hexane, octane, isooctasne, and decane, Cyclic hydrocarbons of 3 to 12 carbon atoms include cyclopentane, cyclohexane, and derivatives thereof. Aromatic hydrocarbons of 3 to 12 carbon atoms include, benzene, toluene, and xylene. Examples of the esters having 3 to 12 carbon atoms include ethyl formate, propyl formate, pentyl formate, methyl acetate, ethyl acetate, and pentyl acetate. Examples of the ketones of 3 to 12 carbon atoms include acetone, methyl ethyl ketone, diethyl ketone, diisobutyl ketone, cyclopentanone, cyclohexanone, and methyl cyclohexanone. Examples of the ethers of 3 to 12 carbon atoms include, diisopropyl ether, dimethoxy methane, dimetoxy ethane, 1,4-dioxane, 1,3-dioxolane, tetrahydro furan, anisole, and phenotole. Examples of the organic solvent having two or more kinds of functional groups include 2-ethoxyethyl acetate, 2-methoxy ethanol, and 2-butyxy ethanol. Preferred boiling point of the organic solvent is 35° C. or higher and 150° C. or lower. As the solvent used in the invention, two or more of solvents can be used in admixture for controlling the physical property of the solution such as drying property and viscosity. Further, so long as the mixed solvent dissolves the cyclic polyolefin resin, etc., a poor solvent can also be added to the mixed solvent.

Preferred poor solvent can be selected properly depending on the polymer species used. In a case of using organic chloro-solvent as the good solvent, alcohols can be used suitably. Preferably, the alcohols may be linear, branched or cyclic and, among them, saturated aliphatic hydrocarbons are preferred. The hydroxyl group of the alcohol may be any of primary to tertiary groups. Examples of the alcohol include methanol, ethanol, 1-propanol, 2-propanol, 1-butanol, 2-butanol, t-butanol, 1-pentanol, 2-methyl-2-butanol, and cyclohexanol. As the alcohol, fluoro alcohols are also used. For example, they include also 2-fluoroethanol, 2,2,2-trifluoroethanol, and 2,2,3,3-tetrafluoro-1-propanol. Among the poor solvents, monohydric alcohols, particularly, have an effect of decreasing the peeling resistance and can be used preferably. While particularly preferred alcohols vary depending on the selected good solvent, alcohols having a boiling point of 120° C. or lower are preferred in view of the drying load, monohydric alcohols of 1 to 6 carbon atoms are more preferred and alcohols of 1 to 4 carbon atoms can be used particularly preferably. A particularly preferred mixed solvent for preparing a solution containing the cyclic polyolefin resin, etc, dissolved therein is a combination comprising dichloromethane as a main solvent and one or more alcohols selected from methanol, ethanol, propanol, isopropanol, or butanol as the poor solvent.

The cyclic polyolefin solution has a feature capable of obtaining a dope at high concentration by properly selecting the solvent to be used, and a cyclic polyolefin solution at a high concentration and excellent in the stability can be obtained without relying on the means of concentration. For facilitating dissolution further, it may be dissolved at a low concentration and then concentrated by using concentration means. While method of concentration is not particularly restricted, concentration can be practiced, for example, by a method of introducing a solution at a low concentration between a cylindrical body and a rotational trace at the outer circumference of a rotary vane that rotates in the circumferential direction at the inside thereof, and providing a temperature difference relative to the solution, to evaporate the solvent thereby obtaining a solution at a high concentration (for example, in JP-A No. 4-259511), a method of blowing a heated solution at a low concentration from a nozzle into a vessel, flash-evaporating the solvent between the nozzle to a position hitting the solution on the inner wall of the vessel, extracting the solvent vapor from the vessel and extracting the solution at a high concentration from the bottom of the vessel (for example, in each of the specifications of U.S. Pat. Nos. 2,541,012, 2,858,229, 4,414,34, and 4,504,355), etc.

Undissolved matters and obstacles such as dusts and impurities are preferably removed by filtration from the solution before casting by using an appropriate filter material such as metal gauge or flannel. For the filtration of the cyclic polyolefin solution, a filter having an absolute filtration fineness of from 0.1 μm to 100 μm is used and a filter having an absolute filtration fineness of 0.5 μm to 25 μm is used more preferably. The thickness of the filter is, preferably, from 0.1 μm to 10 μm and, more preferably, from 0.2 mm to 2 mm. In this case, filtration is preferably conducted at a filtration pressure of 1.6 MPa or less, more preferably, 1.3 MPa or less, further preferably, 1.0 MPa or less and, particularly preferably, 0.6 MPa or less. As the filter material, known materials such as glass fibers, cellulose fibers, filter paper, and fluoro resins such as tetrafluoroethylene resin can be used preferably, and ceramics, metals, etc. are also used preferably.

The viscosity of the cyclic polyolefin solution just before film formation may be within such a range that it can be cast upon film formation, which is controlled, preferably, within a range usually from 5 Pa·s to 1,000 Pa·s, more preferably, from 15 Pa·s to 500 Pa·s and, further preferably, from 30 Pa·s to 200 Pa·s. The temperature is not particularly restricted so long as it is a temperature upon casting and, preferably, from −5 to 70° C., and, more preferably, from −5 to 35° C.

As a method of and a facility for producing the cyclic polyolefin film of the invention, a solution casting film formation method and a solution casting film formation apparatus identical with those used so far for the manufacture of cellulose triacetate films can be used. A dope prepared from a dissolving apparatus (tank) (cyclic polyolefin solution) is once stored in a storing tank and then prepared finally by removing foams contained in the dope. The dope is delivered from a dope discharge port, for example, through a pressurized metering gear pump capable of delivering liquid under metering at a high accuracy, for example, depending on the number of rotation to a pressurized die. The die uniformly cast on a metal support in a casting station running in an endless manner from a slit of a pressurized die and a damp-dried dope film (also referred to as web) is peeled from the metal support at a peeling point where the metal support runs for about one turn. The obtained web was put at both ends with clips, transported by a tenter and dried and, successively, transported by a group of rolls of a drying apparatus to complete drying and then taken-up to a predetermined length by a winding machine. The combination of the tenter and the drying apparatus of the roll group varies depending on the purpose. In a solution casting film formation method used for the functional protective film for use in electronic displays, coating apparatus are often added for the surface fabrication of a subbing layer, an antistatic layer, an anti-halation layer, a protective layer, etc. to the film in addition to the solution casting film formation apparatus. Each of the producing steps is to be described briefly which is, however, not restrictive.

The thus prepared cyclic polyolefin solution (dope) is preferably cast on an endless metal support, for example, a metal drum or metal support (band or belt) to evaporate the solvent or a plurality of cyclic polyolefin solutions in two or more layers may be cast. The dope before casting is preferably controlled for the concentration such that the amount of the cyclic polyolefin is from 10 to 35 mass %. The surface of the drum or the band is preferably mirror-finished. The dope is preferably cast on the drum or the band at a surface temperature of 30° C. or lower and the temperature of the metal support is particularly preferably from −50 to 20° C.

Further, cellulose acylate film forming technique described in each of the publications of JP-A Nos. 2000-301555, 2000-301558, 7-032391, 3-193316, 5-086212, 62-037113, 2-276607, 55-014201, 2-111511, and 2-208650 can be applied in the invention.

### (Casting, Stacked Casting)

The cyclic polyolefin solution may be cast as a single layered solution on a smooth band or drum as a metal support or two or more layers of cyclic polyolefin solutions may be cast.

In a case of casting a plurality of cyclic polyolefin solutions, solutions containing cyclic polyolefins may be cast respectively from a plurality of casting ports arranged each at an interval in the advancing direction of the metal support and a film may be prepared while laminating them, and methods described, for example, in each of the publications of JP-A Nos. 61-158414, 1-122419, and 11-198285 can be adopted.

Further, cyclic polyolefin solutions may also be formed into a film by casting from two casting ports, which can be practiced by the method described in each of the publications of JP-B No. 60-27562, and JP-A Nos. 61-94724, 61-947245, 61-104813, 61-158413, and 6-134933. Further, a casting method for a cyclic polyolefin film described in JP-A 56-162617 of surrounding a stream of a cyclic polyolefin solution at high viscosity with a cyclic polyolefin solution at a low viscosity and simultaneously extruding the cyclic polyolefin solutions at high and low viscosities may also be used. Furthermore, it is also a preferred embodiment of incorporating an alcohol ingredient, which is a poor solvent, more in the outer solution than in the inner solution as described in each of the publications of JP-A No. 61-94724 and 61-94725. Alternatively, a film may also be prepared by using two casting ports, peeling a film formed from a first casting port to a metal support and conducting second casting on the side of the film in contact with the metal support surface, which is a method described, for example, in JP-B No. 44-20235. The cyclic polyolefin method may be an identical cyclic polyolefin solution, or different cyclic polyolefin solutions with no particular restriction. For providing functions to a plurality of cyclic polyolefin layers, cyclic polyolefin solutions in accordance with the functions may be extruded from respective casting ports. Further, other functional layers (for example, adhesive layer, dye layer, antistatic layer, anti-halation layer, matting agent layer, UV-absorbent layer, or polarizing layer) may also be cast simultaneously with the cyclic polyolefin solution.

In the single layered film, it is necessary to extrude a cyclic polyolefin solution at a high concentration and a high viscosity in order to obtain a necessary film thickness. In this case, the stability of the cyclic polyolefin is poor to form solids thereby causing grainy failure or poor planarity tending to result in problems. As a countermeasure, by casting a plurality of cyclic polyolefin solutions from a casting port, a solution at a high viscosity can be extruded on the metal support at the same time and the planarity can be improved to prepare a film of excellent surface property, as well as the drying load can be decreased by using a thick cyclic polyolefin solution and the film production speed can be increased.

In a case of co-casting, while the thickness of the inner side and the outer side is not particularly restricted, the outer side is preferably from 1 to 50% and, more preferably, 2 to 30% thickness based on the entire film thickness. In a case of co-casting three or more layers, the total film thickness of the layer in contact with the metal surface and the layer in contact with air is defined as a thickness of the outer side. In a case of co-casting, a cyclic polyolefin film of a laminate structure can be produced by co-casting cyclic polyolefin solutions having different concentrations of the additives described above. For example, a cyclic polyolefin film of such a constitution as skin layer/core layer/skin layer can be prepared. For example, the higher fatty acid, the higher fatty acid derivative and matting agent can be incorporated at a higher content in the skin layer or only in the skin layer. The anti-aging agent or the UV-absorbent can be incorporated at a higher content in the core layer than in the skin layer, or may be incorporated only in the core layer. Further, the kinds of the aging inhibitor and the UV-absorbent can be changed between the core layer and the skin layer. For example, a less volatile aging inhibitor and/or a UV-ray absorbent may be incorporated in the skin layer and a plasticizer excellent in the plasticity, or a UV-absorbent excellent in the UV-absorbancy can also be added to the core layer. Further, it is also preferred to incorporate a peeling accelerator only in the skin layer on the side of the metal support. Further, for gelling the solution by cooling the metal support in the cooling drum method, it is also preferred to add the alcohol as a poor solvent more in the skin layer than in the core layer. Tg may be different between the skin layer and the core layer and it is preferred that Tg of the skin layer is lower than Tg of the core layer. Further, the viscosity of the solution containing the cyclic polyolefin during casting may also be different between the skin layer and the core layer. While it is preferred that the viscosity of the skin layer is lower than the viscosity of the core layer, the viscosity of the core layer may be lower than the viscosity of the skin layer.

### (Casting)

The casting method for the solution includes a method of uniformly extruding a prepared dope from a pressurized die to a metal support, a method by a doctor blade of controlling the thickness of the dope once cast on a metal support by a blade, or a method by a reverse roll coater of controlling the thickness by a roll that rotates in an opposite direction, the method by the pressurized die being preferred. The pressurized die includes a coat hunger type or T-die type, each of which can be used preferably. Further, in addition to the methods described herein, casting can be practiced by various methods of casting cellulose triacetate solutions to form films known so far and the effects identical with the contents described in respective publications can be obtained by setting each of the conditions while considering the difference of the boiling points of solvents used, etc. As the metal support that runs in an endless manner used for the manufacture of the cyclic polyolefin film of the invention, a drum mirror-finished at the surface by chromium plating, or a stainless steel belt (may also be referred to as a band) mirror-finished at the surface by polishing can be used. The pressurized die used for the manufacture of the cyclic polyolefin of the invention may be disposed by one or more above the metal support. Preferably, it is disposed by the number of 1 or 2. In a case of providing the supports by 2 or more, the amount of dope to be cast may be divided into various ratios to respective dies, and the dope may be delivered to the dies from a plurality of precision metering gear pump at each of the ratios. The temperature of the cyclic polyolefin solution used for the casting is, preferably, from −10 to 55° C. and, more preferably, from 25 to 50° C. In this case, the temperature may be identical throughout the step, or may be different at each of the positions in the step. In a case where the temperature is different, it may suffice that the temperature is at a desired temperature just before casting.

### (Drying)

Drying of the dope on the metal support concerned with the manufacture of the cyclic polyolefin film includes generally a method of applying a hot blow on the side of the surface of a metal support (for example, drum or band), that is, from the surface of the web on the metal support, a method of applying a hot blow on the rear face of the drum or the band, liquid heat conduction a method of bringing a liquid controlled for the temperature in contact with the rear face, that is, on the side opposite to the dope casting surface of the band or the drum and heating the drum or the band by heat conduction thereby controlling the surface temperature, with the rear face liquid heat conduction system being preferred, The surface temperature of the metal support before casting may be at any level so long as it is lower than the boiling point of the solvent used for the dope. However, for promoting drying or eliminating the fluidity of the metal support, it is preferred to set a temperature lower by 1 to 10° C. than the boiling point of the solvent having the lowest boiling point among the solvents used. This is not applied to a case of cooling the cast dope and peeling off the same without drying.

### (Peeling)

In a case where a damp-dried film is peeled off from the metal support, when the peeling resistance (peeling load) is large, the film is stretched irregularly in the direction of film formation to cause unevenness in the optical anisotropy. Particularly in a case where the peeling load is large, stretched portions stepwise and not stretched portions are formed stepwise alternately in the direction of the film formation to result in distribution in the retardation. When the film is loaded in the liquid crystal display device, linear or streaky unevenness is observed. In order to avoid the occurrence of such a problem, it is preferred that the peeling load of the film is 0.25N or less per 1 cm of film peeling width. The peeling load is, more preferably, 0.2N/cm or less, further preferably, 0.15N or less and, particularly preferably, 0.10N or less. In a case where the peeling load is 0.2 N/cm or less, unevenness attributable to peeling is not recognized at all even in a liquid crystal display device tending to develop unevenness, which is particularly preferred. The method of decreasing the peeling load includes a method of adding a peeling agent as described above, or a method of selecting the composition of the solvent to be used.

The peeling load is measured as described below. A dope is dripped on a metal plate having the same material and surface roughness as those of the metal support in the film formation apparatus and cast to uniform thickness by using a doctor blade and dried. Recesses each of an equivalent width are cut into the film by a cutter knife, the top end of the film is peeled by fingers and sandwiched by a clip in connection with a strain gage and the change of load is measured while pulling-up the strain gage in the oblique direction at 45°. Volatile component in the peeled film is also measured. Identical measurement is conducted for several times while varying the drying time, and a peeling load is defined when the residual volatile component upon peeling is identical with that in the actual film formation step. The peeling load tends to increase as the feeling speed increases, and it is preferred to measure the peeling load at a peeling speed approximate to an actual case.

A preferred concentration of the residual component during peeling is from 5 mass % to 60 mass %. 10 mass % to 50 mass % is more preferred and from 20 mass % to 40 mass % is particularly preferred. Peeling at a high volatile component is preferred since the drying speed can be increased to improve the productivity. On the other hand, at high volatile component, the strength and the elasticity of the film are small and the film is cut or elongated being not endurable to the peeling force. Further, self-retainability after peeling is poor tending to suffer from deformation, creases and cracks, Further, this causes occurrence of distribution in the retardation.

### (Stretching)

In a case of applying a stretching treatment to a cyclic polyolefin film of the invention, it is preferably conducted in a state just after peeling in which a solvent still remains sufficiently in the film. Stretching is conducted with an aim of (1) obtaining a film excellent in the planarity, with no crease or deformation and (2) increasing the in-plane retardation of the film. In a case of applying stretching with the aim for (1), stretching is conducted at a relatively high temperature and stretching is conducted also at a low stretching factor from 1% to 10% at the highest. Stretching at a factor of from 2% to 5% is particularly preferred. In a case of conducting stretching with the aims both for (1) and (2), or with the aim only for (2), stretching is conducted at a relatively low temperature and also at a stretching factor of from 5% to 150%.

Film stretching may be monoaxial stretching only for longitudinal or lateral direction, or simultaneous or sequential biaxial stretching. For the birefringence of an optically-compensatory film for use in VA liquid crystal cell or OCB liquid crystal cell, it is preferred that the refractive index in the width direction is larger than the refractive index in the longitudinal direction. Accordingly, it is preferred to apply stretching more in the width direction.

(Take-Up Step after Drying)

The cyclic polyolefin film is dried further after stretching and taken-up with a residual volatile component of 2% or less.

The thickness of a cyclic polyolefin film in the finished state (after drying) of the invention, while different depending on the purpose of use, is usually within a range from 20 to 500 μm, preferably, within a range from 30 to 150 μm and, particularly preferably, from 40 to 110 μm for use in liquid crystal display device.

For the control of the film thickness, solid concentration solids contained in a dope, slit gap of the spinneret of a die, extruding pressure from the die, speed of metal support, etc. may be controlled so as to attain a desired thickness. The width of the cyclic polyolefin film obtained as described above is, preferably, from 0.5 m to 3 m, more preferably, form 0.6 m to 2.5 m and, further preferably, from 0.8 m to 2.2 m. At a film width of 0.5 m or more, productivity is not lowered and, at a film width of 3 m or less, web handlability is not worsened or optical uniformity of the film is not lowered and, further, undesired phenomena such as cramp, streak, etc. do not occur to the film, which is preferred. For the length, it is preferably taken-up by a length of 100 m to 10,000 m, more preferably, from 500 m to 7000 m and, further preferably, from 1,000 to 6,000 m per one roll. At a film length of 100 m or more, the productivity is not lowered by the increase of the frequency of roll exchange and, at 10,000 m or less, web handlability is not worsened or optical uniformity of the film is not deteriorated and, further, undesired phenomena such as cramp, streak, etc. do not occur to the film, which is preferred. Upon taking-up the film, it is preferred to provide knurling on at least one end, and the width thereof is from 3 mm to 50 mm and, more preferably, from 5 m to 30 mm, and the height is preferably from 0.5 to 500 μm and, more preferably, 1 to 200 μm. This may be one side or both side pressing. Variation of the Re value for the entire width is preferably ±5 nm and, more preferably, ±3 nm. Further, variation of the Rth value is, preferably, ±10 nm and, more preferably, ±5 nm. Further, it is also preferred that the variation of the Re value and the Rth value in the longitudinal direction is within the range of the variation in the width direction, Haze is preferably from 0.01 to 2% for keeping the feeling of transparency.

### (Step of Coating a Coating Solution Containing Higher Fatty Acid and Derivative Thereof)

Description is to be made to a step in the second method of coating a coating solution containing at least one compound selected from higher fatty acids and derivatives thereof on at least one surface of a film after casting. The coating step may be conducted in any step after casting.

Constituent ingredients containing a higher fatty acid and a derivative thereof are dissolved or dispersed in an appropriate solvent to prepare a coating solution. In a case of using ingredients insoluble to the solvent, they are used being dispersed by the dispersion method described above. In a case where a binder resin is contained in the coating solution, or in a case of adding other additives, they can be added during dispersion or after dispersion of the higher fatty acid and the derivative thereof. The thus prepared coating solution can be coated and dried on a film by a known method such as a rotary coating, blade coating, knife coating, reverse roll coating, dip coating, rod-bar coating, a spray coating, etc.

The solvent for preparing the coating solution includes halogenated hydrocarbons such as dichloromethane, dichloroethane, and chloroform, alcohols such as methanol and ethanol, ketones such as acetone, methyl ethyl ketone, and cyclohexanone, glycol ethers such as ethylene glycol monomethyl ether and 2-methoxy ethyl acetate, ethers such as tetrahydrofuran and dioxane, and esters such as ethyl acetate and butyl acetate.

For improving the coating surface property, surfactant, plasticizers, matting agents, and other various additives can be added optionally in addition to the higher fatty acid and derivatives thereof, and binder resin forming the layer to the layer formed by the coating step described above.

### (Optical Characteristics of Cyclic Polyolefin Film)

Preferred optical characteristics of the cyclic polyolefin film of the invention are different depending on the use of the film. Description is to be made for each of items which are to be described later for the application use of a protective Film and the application use of an optically-compensatory film for use in polarizing plate.

The cyclic polyolefin film of the invention can provide desired optical characteristics by properly controlling the structure of the cyclic polyolefin resin, etc. to be used, the kind and addition amount of additives, and step conditions such as the stretching factor and the residual volatile component upon peeling.

In the present specification, Re (λ) and Rth (λ) represent, respectively, the in-plane retardation and the retardation in the thickness direction at wavelength λ (under circumstance of 25° C., 60% RH). Re (λ) is measured by incidence of a light at a wavelength of λ nm in the normal direction to the film in KOBRA 21ADH (produced by Oji Scientific Instruments). Rth (λ) is calculated by KOBRA 21ADH based on retardation values measured in the three directions of Re (λ) described above, a retardation value measured by incidence of a light at a wavelength λ nm in the direction inclined by +40° relative to the normal direction to the film with the in-plane retardation phase axis (judged by KOBRA 21ADH) as an axis of inclination (rotational axis), and a retardation value measured by incidence of a light at a wavelength λ nm in the direction inclined by −40° relative to the normal direction to the film with the in-plane retardation phase axis as the axis of inclination (rotational axis). In this case, an average refractive index (η) is necessary as a parameter, and a value measured by Abbe's refractometer (“Abbe refractometer 2-T” produced by Atago Co.) was used therefor. The measuring wavelength is 590 nm in the present specification unless otherwise specified.

Then, description is to be made to a protective film for use in polarizing plate having the cyclic polyolefin film of the invention described above, and an optically-compensating film, as well as a polarizing plate having the protective film for use in polarizing plate.

### (Phase Difference Film—Optically-Compensatory Film)

In a case of using the cyclic polyolefin film as a phase difference film, ranges for Re and Rth are different depending on the kind of the phase difference film for which various needs are present. Use as the optically-compensatory film is preferred. The optically-compensatory film of the invention may consist of the cyclic polyolefin film of the invention per se or may comprise other constituent layers to be described later. Further, it desirably contains a substituent of high polarizing rate at an appropriate ratio in the molecule.

It is preferred that the optical characteristics of the cyclic polyolefin film of the invention in a case of use as the optically-compensatory film is: 0 nm≦Re≦100 nm, and 40≦Rth≦400 nm. It is, more preferably; 0 nm≦Re≦20 nm, and 40 nm≦Rth≦80 nm for TN mode, and 20 nm≦Re≦80 nm, and 80 nm≦Rth≦400 nm for VA mode. Particularly preferred range for the VA mode is: 30 nm≦Re≦75 nm, and 120≦Rth≦250 nm. In a case of compensation with a sheet of an optically-compensatory film, 50 nm≦Re≦75 nm, and 180 nm≦Rth≦250 nm. In a case of compensation with two sheets of optically-compensatory film, 30 nm≦Re≦50 nm, and 80 nm≦Rth≦140 nm is a more preferred embodiment in view of the color shift upon black display and the view angle dependency of the contrast in a case of using as the optically-compensatory film of the VA mode.

### (Protective Film for Use in Polarizing Plate)

In a case of using the cyclic polyolefin film of the invention as a protective film for use in polarizing plate, the in-plane retardation (Re) is, preferably, 5 nm or less and, more preferably, 3 nm or less. Also the retardation in the thickness direction (Rth) is, preferably, 50 nm or less and, more preferably, 35 nm or less and, particularly preferably 10 nm or less.

The protective film for use in polarizing plate of the invention may consist of the cyclic polyolefin film of the invention per se or it may have other constituent layers as will be described later.

### (Polarizing Plate)

A polarizing plate usually has a polarizer and two sheets of transparent protective films disposed on both sides thereof. The polarizing plate of the invention uses the protective film for use in polarizing plate of the invention as one or both of the protective films, In a case of using the protective film for use in polarizing plate of the invention only for one side, a usual cellulose acetate film, etc. may also be used as the other protective film, The polarizer includes iodine type polarizers, dye type polarizers using dichroic dye, and polyene type polarizer. The iodine type polarizer and the dye type polarizer are generally prepared by using a polyvinyl alcohol (PVA) type film. PVA is a polymer material formed by saponifying polyvinyl acetate and it may also contain an ingredient copolymerizable with vinyl acetate an unsaturated carboxylic acid, unsaturated sulfonic acid, olefins, and such as vinyl ether. Further, a modified PVA containing an acetoacetyl group, sulfonic acid group, carboxyl group, oxyalkylene group, etc. may also be used.

While the saponification degree of PVA is not particularly restricted, it is, preferably, from 80 to 100 mol % and, most preferably, from 90 to 100 mol %, with a view point of the solubility or the like. Further, while the polymerization degree of PVA is not particularly restricted, it is preferably from 1,000 to 10,000 and, particularly preferably, from 1,500 to 5,000.

Syndiotacticity of PVA is preferably 55% or more for improving the durability as described in JP No 2978219, but it can be used preferably also by from 45 to 52.5% as described in JP No. 3317494.

In a case of using the cyclic polyolefin film of the invention as the protective film for use in polarizing plate, it is preferred that a surface treatment is applied as will be described later to the film and then the film treated surface and a polarizer are bonded by using an adhesive. The polarizing plate comprises a polarizer and protective films for protecting both surfaces thereof and, further, comprises a protective film bonded on one surface and a separate film bonded on the opposite surface of the polarizing plate. The protective film and the separate film are used with an aim of protecting the polarizing plate upon shipping the polarizing plate, upon inspection of products, etc. In this case, the protect film is bonded with an aim of protecting the surface of the polarizing plate and used on the side opposite to the surface of bonding the polarizing plate to a liquid crystal plate. Further, the separate film is used with an aim of covering the adhesive layer to be bonded to the liquid crystal plate and used on the side of the surface of bonding the polarizing plate to the liquid crystal plate.

When the protective film for use in polarizing plate of the invention is bonded to the polarizer, it is preferred to bond them so as to align the axis of transmission of the polarizer with the retardation phase axis of the protective film for use in polarizing plate according to the invention. When a polarizing plate produced under the Crossed Nichol state of the polarizing plate was evaluated, it has been found that in a case where the crossing accuracy between the retardation phase axis of the protective film for use in polarizing plate of the invention and an absorption axis of the polarizer (axis crossing the axis of transmission) is greater than 1°, the performance of the polarization degree of the polarizing plate under the Crossed Nichol is lowered to cause light leakage. In this case, no sufficient black level and contrast can be obtained when it is combined with a liquid crystal cell. Accordingly, the deviation between the direction of a main refractive index nx of the protective film for use in polarizing plate of the invention and the direction of the axis of transmission of the polarizing plate is preferably within 1° and, more preferably, within 0.5°.

For the measurement of simplex transmittance TT, parallel transmittance PT, and cross transmittance CT, UV 3100 PC (produced by Shimazu Seisakusho Co.) can be used. In the measurement, it is measured within a range from 380 nm to 780 nm, and an average value of measurement for 10 times can be used for each of simplex, parallel, and cross transmittance.

A durable test to the polarizing plate can be conducted for two kinds of forms, that is, (1) only for the polarizing plate and; (2) for the polarizing plate bonded by way of an adhesive to glass as described below. Measurement only for the polarizing plate is conducted by combining a protective film for use in polarizing plate so as to be sandwiched between two polarizers in a crossed state and using two identical sets. For the glass-bonded form, a sample in which a polarizing plate is bonded on glass such that a protective film for use in polarizing plate is on the side of the glass (5 cm×5 cm) is prepared by the number of two. In the simplex transmission measurement, the sample is measured by setting the sample with the side of the film to a light source. The two samples are measured respectively and an average value for them is defined as the simplex transmittance. Preferred ranges for the polarizing performance in the order of the simplex transmittance TT, parallel transmittance PT, and cross transmittance CT are: as 40.5≦TT≦45, 32≦PT≦39.5, and CT≦1.5, respectively. More preferred ranges are: 41.0≦TT≦44.5, 34≦PT≦39.0, and CT≦1.3. In the durability test of the polarizing plate, it is preferred that the amount of change is smaller.

### (Surface Treatment of Cyclic Polyolefin Film)

In the protective film for use in polarizing plate of the invention, it is preferred to apply a surface treatment to the surface of a cyclic polyolefin film for improving the adhesion with a polarizer. While any method may be utilized for the surface treatment so long as the adhesion is improved, a preferred surface treatment includes, for example, glow discharging treatment, UV-light radiation treatment, corona treatment, and flame treatment. The glow discharging treatment referred to herein is a so-called low temperature plasma that occurs in a low pressure gas. In the invention, a plasma treatment at an atmospheric pressure is also preferred. Further, details of the glow discharging treatment are described in the specifications of U.S. Pat. Nos. 3,462,335, 3,761,299, and 4,072,769, and BP No. 891469. A method described in JP-A No. 59-556430 in which a gas composition of the discharging atmosphere comprises only the gas species generated in a vessel from a polyester support per se that undergoes the discharging treatment is also used. Further, a method described in JP-B No. 60-16614 of conducting a discharging treatment with the surface temperature of the film at 80° C. or higher and 180° C. or lower upon vacuum glow discharging treatment can also be applied.

The vacuum degree during glow discharging treatment is, preferably, from 0.5 Pa to 3,000 Pa and, more preferably, from 2 Pa to 300 Pa. Further, the voltage is preferably between 500 V and 5,000 V and, more preferably, between 500 V to 3,000 V. The discharging frequency used ranges from DC current to several thousands MHz, more preferably, from 50 Hz to 20 MHz and, further preferably, from 1 KHz to 1 MHz. The intensity of the discharging treatment is from 0.01 KV·A·min/m² to 5 KV·A·min/m² and, further preferably, from 0.15 KV·A·min/m² to 1 KV·A·min/m².

In the invention, UV light irradiation method is also conducted preferably as the surface treatment. This can be conducted by the treating method described, for example, in each of the publications of JP-B Nos. 43-2603, 43-2604, and 45-3828. A mercury lamp is preferably a high pressure mercury lamp comprising a quartz tube having a wavelength of UV-light from 180 to 380 nm. For the method of UV-light irradiation, a high pressure mercury lamp having a main wavelength at 365 nm can be used as a light source so long as increase in the surface temperature of the protective film to about 150° C. results in no problem for the support in view of the performance. In a case where a low temperature treatment is necessary, a low pressure mercury lamp at a main wavelength of 254 nm is preferred. Further, ozone less type high pressure mercury lamp and low pressure mercury lamp can also be used. For the amount of light for treatment, while adhesion between a polymer resin film containing a thermoplastic saturated cycloaliphatic structure and a polarizer is improved more as the amount of light for the treatment increases, increase in the amount of light result in a problem that the film is colored and embrittled. Accordingly, in the high pressure mercury lamp having a main wavelength at 365 nm, the amount of irradiation light is, preferably, from 20 mJ/cm² to 10,000 mJ/cm² and, more preferably, 50 mJ/cm² to 2,000 mJ/cm². In a case of a low pressure mercury lamp having a main wavelength at 254 nm, the amount of irradiation light is, preferably, from 100 mJ/cm² to 10,000 mJ/cm² and, more preferably, from 300 mJ/cm² to 1,500 mJ/cm².

Further, in the invention, it is also preferred to conduct a corona discharging treatment as a surface treatment. For example, this can be conducted by the treating method described in each of the publications of JP-B No. 39-12838, and JP-A Nos. 47-19824, 48-28067, and 52-42114. As the corona discharging treatment apparatus, a solid state corona discharging machines LEPEL type surface treatment machine, VETAPHON type treating machine, etc. produced by Pillar Co. can be used. The treatment can be conducted at a normal pressure in the air. The discharging frequency upon treatment is from 5 KV to 40 KV and, more preferably, from 10 KV to 30 KV, and the waveform is, preferably, an AC sinusoidal wave. A gap (clearance) between an electrode and a dielectric roll is from 0.1 mm to 10 mm and, more preferably, 1.0 mm 2.0 mm, Discharging treatment is conducted above a dielectric support roller located in a discharging region, and the amount of treatment is from 0.34 KV·A·min/m² to 0.4 KV·A·min/m² and, more preferably, from 0.344 KV·A·min/m² to 0.38 KV·A·min/m².

In the invention, it is also preferred to conduct a flame treatment as the surface treatment. While a gas to be used may be any of natural gas, liquefied propane gas, or city gas. A mixing ratio with air is important, because it is considered that the effect of the surface treatment by the flame treatment is provided by plasmas including active oxygen. The plasma activity (temperature) and the existent amount of oxygen which are important nature of flame are critical point. A predominant factor of the point is a gas/oxygen ratio, and the energy becomes highest and the plasma activity increases in a case where they take place reaction in a just appropriate proportion. Specifically, a desirable mixing ratio by volume for natural gas/air is from 1/6 to 1/10 and, preferably, from 1/7 to 1/9. Further, in a case of liquefied propane gas/air, it is from 1/14 to 1/22 and, preferably, from 1/16 to 1/19. In a case of city gas/air, it is from 1/2 to 1/8 and, preferably, from 1/3 to 1/7. Further, the flame treatment is conducted, preferably, within a range from 1 Kcal/m² to 50 Kcal/m² and, more preferably, from 3 Kcal/m² to 20 Kcal/m². Further, the distance from the top end of the inner flame of a burner and a film is, preferably, from 3 cm to 7 cm and, more preferably, from 4 cm to 6 cm. For the nozzle shape of a burner, a ribbon type of Flin Burner Co. (USA), multi-hole type of Wise Co. (USA), ribbon type Aerogen (England) and zig-zag multi-hole type of Kasuga Electric Works Ltd. (Japan) and a zig-zag multi-hole type of Koike Sanso Kogyo Co., Ltd. (Japan) are preferred. A back-up roll supporting the film during the flame treatment is a hollow roll and treatment is preferably conducted under water cooling by passing cooling water always at a constant temperature of from 20° C. to 50° C.

For the degree of the surface treatment, while a preferred range is different depending on the kind of the surface treatment and the kind of the cyclic polyolefin, it is preferred that the angle of contact between the surface of a protective film applied with the surface treatment and pure water is less than 50° as a result of the surface treatment. The angle of contact is, more preferably, 25° or more and less than 45°. In a case where the angle of contact between the surface of the protective film and pure water is within the range described above, a bonding strength between the protective film and the polarizing film is improved.

### (Adhesive)

Upon bonding a polarizer comprising a polyvinyl alcohol type film and a surface treated cyclic polyolefin film as the protective film for use in polarizing plate, use of an adhesive containing a water soluble polymer is preferred. A water soluble polymer used preferably for the adhesive includes homopolymers or copolymers having, as constituent elements, ethylenically unsaturated monomers such as N-vinyl pyrrolidone, acrylic acid, methacrylic acid, maleic acid, β-hydroxyethyl acrylate, β-hydroxyethyl methacrylate, vinyl alcohol, methyl vinyl ether, vinyl acetate, acryl amide, methacryl amide, diacetone acrylamide, and vinyl imidazole, and polyoxylethylene, polyoxypropylene, poly-2-methyloxazoline, methyl cellulose, hydroxyethyl cellulose, and hydroxypropyl cellulose gelatin. In the invention, PVA and gelatin are preferred among them.

Preferred characteristics of PVA in a case of using PVA for the adhesive are identical with preferred characteristics of PVA used for the polarizer. In the invention, it is further preferred to use a crosslinker together. The crosslinker used preferably in combination in a case of using PVA for the adhesive includes boric acid, polyvalent aldehyde, polyfunctional isocyanate compound and polyfunctional epoxy compound, boric acid being particularly preferred in the invention. In a case of using gelatin for the adhesive, so-called lime-treated gelatin, acid-treated gelatin, enzyme-treated gelatin, gelatin derivatives, modified gelatin, etc. can be used. Among the gelatins, those used preferably are lime-treated gelatin and acid-treated gelatin. The crosslinker used preferably in combination in a case of using the gelatin for the adhesive includes active halogenated compounds (2,4-dochloro-6-hydroxy-1,3,5-triazine, sodium salts thereof, etc.), and active vinyl compound (1,3-bisvinyl sulfonyl-2-propanol, 1,2-bisvinyl sulfonylacetamide)ethane, bis(vinylsulfonyl methyl)ether, or vinylic polymers having vinyl sulfonyl groups on the side chain, etc.), N-carbamoyl pyridinium salts ((1-morpholinocarbonyl-3-pyridinio)methane sulfonate, etc.), and haloamidinium salts (1-(1-chloro-1-pyridinomethylene)pyrrolidinium-2-naphthalene sulfonate, etc.). In the invention, active halogen compound and the active vinyl compound are used particularly preferably.

A preferred addition amount of the crosslinker in a case of using the crosslinkers described above in combination is 0.1 mass parts or more and less than 40 mass parts and, more preferably, 0.5 mass parts or more and less than 30 mass parts based on 100 mass parts of the water-soluble polymer in the adhesive. It is preferred to conduct bonding by coating an adhesive on the surface of at least one of the protective film and the polarizer thereby forming an adhesive layer, and it is preferred to coat an adhesive on the surface to be treated of the protective film to form an adhesive layer and bond the same to the surface of the polarizer. The thickness of the adhesive layer after drying is preferably from 0.01 μm to 5 μm and, particularly preferably, from 0.05 μm to 3 μm.

### (Anti-Reflection Layer)

It is preferred to dispose a functional layer such as an anti-reflection layer to a transparent protective film disposed to a polarizing plate on the side opposite to the liquid crystal cell. Particularly, in the invention, an anti-reflection layer formed by laminating at least a light scattering layer and a low refractive index layer in this order on a transparent protective film, or an anti-reflection layer formed by laminating a medium refractive index layer, a high reflective index layer, and a low refractive index layer in this order on the transparent protective film is used preferably. That is, as a transparent support to which the anti-reflection layer is laminated, a transparent protective film is used preferably. Preferred examples thereof are to be described below.

Preferred examples of an anti-reflection layer in which a light scattering layer and a low refractive index layer are disposed on a transparent protective film are to be described. Matte particles are preferably dispersed in the light scattering layer. The light scattering layer may also have both anti-dazzling property and hard coatability and it may be a single layer or plural layers, for example, comprising 2 to 4 layers.

By designing the surface unevenness shape of the anti-reflection layer such that a center line average roughness Ra is from 0.08 to 0.40 μm, a 10 point average roughness Rz is 10 times or less of Ra, an average top to bottom distance Sm is from 1 to 100 μm, a standard deviation for the height of a protrusion from the deepest portion of the unevenness is 0.5 μm or less, a standard deviation for the average top to bottom distance Sm of the unevenness is 20 μm or less, and the surface with an angle of inclination of 0 to 5° occupies 10% or more, a sufficient anti-dazzling property and a uniform feeling of matt under visual observation are attained preferably.

Further, in a case where the tint of a reflection light under a C-light source is such that a* value is −2 to 2 and b* value is −3 to 3 and the ratio between the minimum value and the maximum value of the reflectivity within a range from 380 nm to 780 nm is from 0.5 to 0.99, the tint of the reflection light becomes neutral preferably. Further, in a case where b* value of the transmission light under a C-light source is from 0 to 3, yellowish tint in white indication is decreased preferably when applied to a display device.

Further, in a case when the standard deviation of the lightness distribution is 20 or less upon measuring the brightness distribution on a film by inserting 120 μm×140 μm lattice between a surface light source and an anti-reflection layer, glare is decreased preferably upon applying the film of the invention to a highly fine panel.

It is preferred that optical characteristics of the anti-reflection layer are such that the mirror phase reflectivity is 25% or less, transmittance is 90% or more and 60° glossiness is 70% or less, since the reflection of external light can be suppressed and the viewability is improved. Particularly, the mirror phase reflectivity is, more preferably, 1% or less and, most preferably, 0.5% or less. Prevention of glare, suppression of blur in characters, etc. on a highly fine LCD particle can be attained preferably by controlling the haze to 20% to 50%, the internal haze/entire phase value (ratio) to 0.3 to 1, lowering of the haze value from the haze value as far as the light scattering layer to the haze value after forming the low refractive index layer to 15% or less, clearness of transmission images at 0.5 mm comb-width to 20% to 50%, and the transmittance ratio of the transmission light: vertical direction/direction included by 2° from verticality to 1.5 to 5.5.

### (Low Refractive Index Layer)

The reflective index of the low refractive index layer in the anti-reflection layer is within a range, preferably, from 1.20 to 1.49 and, more preferably, from 1.30 to 1.44. Further, it is preferred that the low refractive index layer satisfies the following equation in view of lowering the reflectivity:

(m/4)×0.7<n1d1<(m/4)×1.3

in which m is a positive odd member, n1 is a refractive index of a low refractive index layer, and d1 is a film thickness (nm) of a low reflective index layer, λ is a wavelength which is a value within a range from 500 nm to 550 nm.

Materials forming the low refractive index layer are to be described below.

The low refractive index layer preferably contains a fluorine-containing polymer as a low refractive index binder As the fluoro-polymer a fluorine-containing polymer crosslinked by heating or ionic radiation rays having a dynamic friction coefficient of from 0.03 to 0.20, an angle of contact to water of 90° to 120°, and a slipping angle to pure water of 70° or less is preferred. When the anti-reflection layer is mounted to an image display device, it is preferred that the peeling strength relative to a commercially available adhesive tape is lower since a seal or memo pad is peeled more easily after bonding, and the peeling strength is, preferably, 500 gf or less, more preferably, 300 gf or less and, most preferably, 100 gf or less, Further, it is less scratched as the surface hardness is higher when measured by micro hardness gage which is 0.3 GPa or more and, more preferably, 0.5 GPa or more.

The fluorine-containing polymer used for the low refractive index layer includes perfluoroalkyl group-containing silane compounds, for example, hydrolyzates or dehydrating condensates, for example, of (heptadecafluoro-1,1,2,2-tetrahydrodecyl)triethoxy silane, as well as fluorine-containing copolymers comprising, as constituent ingredients, fluorine-containing monomer units and constituent units for providing crosslinking reactivity, Specific example of the fluorine-containing monomer includes, for example, fluoroolefins (for example, fluoroethylene, vinylidene fluoride, tetrafluoroethylene, perfluorooctylethlene, hexafluoropropylene, perfluoro-2,2-dimethyl-1,3-dioxol, etc.), partially or completely fluorinated alkyl ester derivatives of (meth)acrylic acids, for example, Biscoat 6FM (produced by Osaka Yuki Kagaku) or M-2020 (produced by Daikin Co., etc), completely or partly fluorinated vinyl ethers. Perfluoro olefins are preferred and hexafluoropropylene is particularly preferred with a view point of refractive index, solubility, transparency, availability, etc.

The constituent unit for providing the crosslinking reactivity includes those constituent units obtained by polymerization of monomers previously having self-crosslinking functional group in the molecule such as glycidyl(meth)acrylate and glycidyl vinyl ether, constituent units obtained by polymerization of monomers having carboxyl group, hydroxyl group, amino group, or sulfo group ((meth)acrylic acid, methylol(meth)acrylate, hydroxylalkyl(meth)acrylate, allyl acrylate, hydroxyethyl vinyl ether, hydroxybutyl vinyl ether, maleic acid, crotonic acid, etc.), constituent units formed by introducing crosslinkable groups such as (meth)acryloyl groups by polymeric reaction to the constituent units described above (they can be introduced, for example, by a method of acting acrylic acid chloride to the hydroxyl group).

In addition to the fluorine-containing monomer units and the constituents unit for providing the crosslinking reactive group described above, monomers not containing fluorine atom may properly be copolymerized with a view point of solubility to a solvent, transparency of a film, etc. The monomer units that can be used in combination have no particular restriction and include, for example, olefins (ethylene, propylene, isoprene, vinyl chloride, vinylidene chloride, etc.), acrylate esters (methyl acrylate, methyl acrylate, ethyl acrylate, 2-ethylhexyl acrylate), methacrylate esters (methyl methacrylate, ethyl methacrylate, butyl methacrylate, ethylene glycol dimethacrylate, etc.), styrene derivatives (styrene, divinyl benzene, vinyl toluene, α-methyl styrene, etc.), vinyl ethers (methyl vinyl ether, ethyl vinyl ether, cyclohexyl vinyl ether, etc.), vinyl esters (vinyl acetate, vinyl propionate, vinyl succinate, etc.), acryl amides (N-tert-butyl acryl amide, N-cyclohexyl acryl amide, etc.), methacrylamides, acrylonitrile derivatives. For the polymer described above, a hardening agent may also be used properly in combination as described in each of the publications of JP-A Nos. 10-25388 and 10-147739.

### (Light Scattering Layer)

A light scattering layer is formed for providing a film with a light scattering property due to surface scattering and/or internal scattering, and hard coatability for improving the scratch resistance of the film. Accordingly, the scattering layer is formed by incorporation of a binder for providing the hard coatability, matt particles for providing the light scattering property and, optionally, an inorganic filler for increasing the refractive index, preventing crosslinking shrinkage and improving the strength. The thickness of the light scattering layer is, preferably, from 1 μm to 10 μm and, more preferably, from 1.2 μm to 6 μm with a view point of providing the hard coatability and a view point of suppressing the occurrence of curl and worsening of brittleness.

The binder for the scattering layer is preferably a polymer having a saturated hydrocarbon chain or a polyether chain as the main chain and, more preferably, a polymer having an unsaturated hydrocarbon chain as the main chain. Further, the binder polymer preferably has a crosslinked structure. As the binder polymer having the saturated hydrocarbon chain as the main chain, polymers of ethylenically unsaturated monomers are preferred. As the binder polymer having the saturated hydrocarbon chain as the main chain and has the crosslinked structure, copolymers of monomers having two or more ethylenically unsaturated groups are preferred. For making the binder polymer highly refractive, those containing an aromatic ring or at least one atom selected from halogen atom other than chlorine, sulfur atom, phosphorus atom, and nitrogen atom in the structure of the monomer can be selected.

The monomers having two or more ethylenically unsaturated groups include esters of polyhydric alcohols and (meth)acrylic acid (for example, ethylene glycol di(meth)acrylate, budanediol di(meth)acrylate, hexanediol di(meth)acrylate, 1,4-cyclohexane diacrylate, pentaerythritol tetra(meth)acrylate), pentaerythritol tri(meth)acrylate, trimethylolpropane (meth)acrylate, trimethylolethane (meth)acrylate, dipentaerythritol tetra(meth)acrylate, dipentaerythritol penta(meth)acrylate, dipentaerythritol hexa(meth)acrylate, pentaerythritol hexa(meth)acrylate, 1,2,3-cyclohexane tetramethacrylate, polyurethane polyacrylate, polyester polyacrylate), ethylene oxide modified products thereof, vinyl benzene and derivatives thereof (for example, 1,4-divinyl benzene, 4-vinyl benzoic acid-2-acryloyl ethyl ester, and 1,4-divinyl cyclohexanone), vinyl sulfone (for example, divinyl sulfone), acryl amide (for example, methylene bisacrylamide), and methacryl amide. Two or more of the monomers can be used in combination.

Specific examples of monomers having high refractive index include (bis(4-methacryloylthiophenyl) sulfide, vinyl naphthalene, vinyl phenylsulfide, and 4-methacryloxyphenyl-4′-methoxyphenyl thioether. Two or more of the monomers may also be used in combination.

Polymerization of the monomers having the ethylenically unsaturated groups can be conducted under the presence of a photoradical initiator or heat radial initiator, irradiation of ionic radiation rays, or heating.

Accordingly, the anti-reflection layer can be formed by preparing a coating solution containing a monomer having an ethylenically unsaturated group, a photoradical initiator or heat radical initiator, matt particles, and inorganic filler, coating the coating solution on a transparent support and then curing the same through polymerizing reaction by ionic radiation rays or heat, For the photoradical initiators, etc. those known so far can be used.

The polymer having the polyether as the main chain is preferably a ring-opened polymer of a multi-functional epoxy compound. The ring-opening polymerization of the polyfunctional epoxy compound can be conducted under the presence of a photoacid generator or a heat acid generator by irradiation of ionic radiation rays or heating.

Accordingly, the anti-reflection layer can be formed by preparing a coating solution containing a polyfunctional epoxy compound, a photoacid generator or a heat acid generator, matt particles and inorganic filler, coating the solution on a transparent support and then curing the same by polymerizing reaction by ionic radiation rays or heating.

Instead of or in addition to the monomers having two or more ethylenically unsaturated groups, crosslinkable polyfunctional groups may be introduced by using monomers having crosslinking functional groups, and a crosslinked structure may be introduced into the binder polymer by the reaction of the crosslinkable functional groups.

Examples of the crosslinking functional groups include isocyanate group, epoxy group, azilidine group, oxazoline group, aldehyde group, carbonyl group, hydrazine group, carboxyl group, methylol group, and active methylene group. Vinyl sulfonic acid, acid anhydride, cyano acrylate derivatives, melamine, etherfied methylol, ester, and urethane, and metal alkoxide such as tetramethyl silane can also be utilized as the monomer for introducing the crosslinked structure. A functional group showing crosslinkability as a result of the decomposing reaction such as blocked isocyanate group may also be used. That is, the crosslinking functional group in the invention may be those not necessarily showing direct reactivity but may be those the reactivity as a result of decomposition.

The binder polymer having the crosslinking functional groups can form a crosslinked structure by heating after coating the binder polymer.

With an aim of providing an anti-dazzling property, the light scattering layer is preferably incorporated with matt particles larger than filler particles, for example, particles of inorganic compounds or resin particles having an average particle size of from 1 μm to 10 μm, preferably, from 1.5 μm to 7.0 μm.

Specific examples of the matt particles preferably include, for example, particles of inorganic compounds such as silica particles and TiO₂ particles; and resin particles such as acrylic particles, crosslinked acrylic particles, polystyrene particles, crosslinked styrene particles, memaline resin particles, and benzoguanamine resin particles. Among all, crosslinked styrene particles, crosslinked acryl particles, crosslinked acrylstyrene particles, and silica particles are preferred. Matt particles either of spherical or indefinite shape can be used.

Further, two or more kinds of mat particles of different particle sizes may also be used in combination. It is possible to provide the anti-dazzling property by matt particles of larger particle size and other optical characteristics by matt particles of smaller particle size.

Further, for the particle size distribution of the matt particles, mono-dispersion is most preferred and it is more preferred that as the particle size of each of the particles becomes identical to each other. For instance, in a case of defining particles having the particle size larger by 20% or more than the average particle size as coarse particles, the ratio of the coarse particles is preferably 1& or less, more preferably, 0.1% or less and, further preferably, 0.01% or less based on the sum of the number of particles. Matt particles having such a particle size distribution can be obtained by classification after usual synthetic reaction, and fine particles of more preferred distribution can be obtained by increasing the number of classification or intensify the degree thereof.

The matt particles are contained in the light scattering layer such that the amount of the matt particles in the formed light scattering layer is, preferably, from 10 mg/m² to 1000 mg/m² and, more preferably, from 100 mg/m² to 700 mg/m². The grain size distribution of the matt particles is measured by a coulter counter method and the measured distribution is converted to a particle number distribution.

For increasing the refractive index of the layer, the light scattering layer is preferably incorporated, in addition to the matt particles described above, with an inorganic filler comprising oxides of at least one metal selected from titanium, zirconium, aluminum, indium, zinc, tin, and antimony, having an average particle size of 0.2 μm or less, preferably, 0.1 μm or less and, further preferably, 0.06 μm or less.

On the other hand, in a light scattering layer using matt particles of high refractive index in order to increase the difference of the refractive index relative to the matt particles, it is also preferred to use oxides of silicon in order to keep the refractive index of the layer lower. Preferred particle size is identical with that for the inorganic filler described above.

Specific example of the inorganic filler used in the light scattering layer includes, for example, TiO₂, ZrO₂, Al₂O₃, In₂O₃, ZnO, SnO₂, Sb₂O₃, ITO and SiO₂. TiO₂ and ZrO₂ are particularly preferred in view of increase of the refractive index, It is also preferred to apply a silane coupling treatment or a titanium coupling treatment to the surface of the inorganic filler, and a surface treating agent having a functional group capable of reacting with binder species is preferably used for the filler surface. The addition amount of the inorganic filler is, preferably, from 10% to 90%, more preferably, from 20% to 80% and, particularly preferably, from 30 to 75% based on the entire mass of the light scattering layer. Since the particle size of such filler is sufficiently smaller than the wavelength of a light, it does not cause scattering and the dispersion containing the filler dispersed in the binder polymer behaves as an optically uniform substance.

The bulk refractive index of a mixture of the binder and the inorganic filler in the light scattering layer is, preferably, from 1.48 to 2.00, more preferably, from 1.50 to 2.00 and, further preferably, 1.50 to 1.80. The refractive index can be in the range described above by properly selecting the kind and the ratio of the amount of the binder and the inorganic filler. How to select them can previously be determined easily experimentally.

The light scattering layer preferably contains a fluorine type, silicone type surfactant, or both of them in a coating solution for forming an anti-dazzling layer in order to ensure surface uniformity, particularly, with less coating unevenness, drying unevenness and spotwise defects. Particularly, the fluorine type surfactant is used preferably since this develops an effect by a smaller addition amount of improving the surface failure such as coating unevenness, drying unevenness and spotwise defects of the anti-reflection layer. It is intended to enhance the productivity by providing high speed coatability while improving the surface uniformity.

Then, description is to be made to an anti-reflection layer formed by laminating a medium refractive index layer, a high refractive index layer, and a low refractive index layer in this order on a transparent protective film.

The anti-reflection layer having a layer constitution comprising at least the medium refractive index layer, the high refractive index layer, and the low refractive index layer (outermost layer) in this order on a substrate is preferably designed so as to have a refractive index satisfying the following relation:

Refractive index of: high reflective index layer>refractive index of medium reflective index layer>refractive index of transparent support>refractive index of low refractive index layer.

Further, a hard coat layer may also be provided between the transparent support and the medium refractive index layer. Further, it may also comprise a medium refractive index hard coat layer, a high refractive index layer, and a low refractive index layer (refer, for example, to JP-A Nos. 8-122504, 8-110401, 10-300902, 2002-243906, and 2000-111706). Further, each of the layers may be provided with other functions and, for example, include an anti-contamination low refractive index layer, an antistatic high refractive index layer, etc. (refer, for example, to JP-A Nos. 20-206603 and 2002-243906).

The haze of the anti-reflection layer is, preferably, 5% or less and, more preferably, 3% or less. Further, the film strength is, preferably, H or more, more preferably, 2H or more and, most preferably, 3H or more in a pencil hardness test in accordance with JIS K 5400.

### (High Refractive Index Layer and Medium Refractive Index Layer)

A layer having high refractive index in the anti-reflection layer preferably comprises a curable film containing at least superfine particles of an inorganic compound having high refractive index with an average particle size of 100 nm or less and a matrix binder.

The fine particles of the inorganic compound of high refractive index include, for example, inorganic compounds having a refractive index of 1.65 or more and, preferably, a refractive index of 119 or more, For example, they include oxides of Ti, Zn, Sb, Sn, Zr, Ce, Ta, La, In, etc., or composite oxides containing such metal atoms.

Methods of forming such superfine particles include a treatment for the particle surface with a surface treating agent (for example, silane coupling agent: in JP-A Nos. 11-295503, 11-153703, and 2000-9908, anionic compound or organic metal coupling agent: in JP-A No. 2001-310432), formation of a core shell structure using particles at high refractive index as the core (JP-A Nos. 2001-166104 and 2001-310432, etc.) combined use of a specific dispersant, for example, in JP-A No. 11-153703, U.S. Pat. No. 6,210,858, and JP-A No. 2002-2776069.

Materials for forming the matrix include, for example, known thermoplastic resins and curable resin films.

Further, at least one composition selected from polyfunctional compound-containing composition having at least two radical polymerizable and/or cation polymerizable polymerizing groups and compositions containing organic metal compounds having hydrolysable groups and partial condensates thereof is preferred. For example, they include those compositions as described, for example, in JP-A Nos. 2000-47004, 2001-315242, 2001-31871, and 2001-296401.

Further, curable films obtained from compositions comprising a colloidal metal oxide obtained from hydrolysis condensates of metal alkoxides and metal alkoxide is also preferred. They are described, for example, in JP-A No. 2001-293818.

The refractive index of a high refractive index layer is generally from 1.70 to 2.20. The thickness of the high refractive index layer is, preferably, from 5 nm to 10 μm and, more preferably, from 10 nm to 1 μm, The refractive index of the medium refractive index layer is controlled so as to be a value between the refractive index for the low refractive index layer and the refractive index for the high refractive index layer. The refractive index of the medium refractive index layer is, preferably, from 1.50 to 1.70. Further, the thickness is, preferably, from 5 nm to 10 μm and, more preferably, from 10 nm to 1 μm.

### (Low Refractive Index Layer)

A low refractive index layer is formed by successive lamination on a high refractive index layer. The refractive index of the low refractive index layer is, preferably, from 1.20 to 1.55 and, more preferably, 1.30 to 1.50.

It is preferably constructed as an outermost layer having scratch resistance and anti-contamination property. As means for greatly improving the scratch resistance, provision of slipperiness to the surface is effective and known means for the thin film layer comprising introduction of silicone, introduction of fluorine, etc. are applicable.

The refractive index of the fluorine-containing compound is, preferably, from 1.35 to 1.50 and, more preferably, from 1.36 to 1.47. Further, as fluorine-containing compounds, compounds containing fluorine atoms within a range from 35 to 80 mass % are preferred. For example, they include compounds described in JP-A Nos. 9-222503 (column Nos. [0018] to 0026]), 11-38202 (column Nos. [0019] to [0030]), 2001-40284 (column Nos. [0027] to [0028], and 2000-284102.

The silicone compounds are preferably compounds having polysiloxane structures that contain curable functional groups or polymerizable functional groups in the polymer chain and have crosslinked structure in the film. For example, they include reactive silicones (for example, SILAPLANE produced by Chisso Co.) and polysiloxanes containing silanol groups on both terminal ends (JP-A No. 11-258403).

Crosslinking or polymerizing reaction of fluoro-containing and/or siloxane polymers having crosslinkable or polymerizable groups is preferably conducted by applying photo-irradiation or heating to a coating composition for forming the outermost layer containing polymerization initiator, sensitizer, etc. simultaneously with coating or after coating.

Further, it is also preferred to use sol-gel curable films which are cured by condensation reaction of organic metal compounds such as silane coupling agents and silane coupling agents containing specific fluoro-containing hydrocarbon groups.

For example, they include polyfluoro alkyl group-containing silane compounds or partial hydrolysis condensates thereof (compounds described, for example, in JP-A Nos. 58-142958, 58-147483, 58-147484, 9-157582, and 11-106704, and silyl compounds containing poly“perfluoroalkyl ether” group which are fluoro-containing long chained groups (JP-A Nos. 2000-117902, 2001-48590, and 2002-53804).

The low refractive index layer can contain, as other additives than described above, inorganic compounds of low refractive index having a primary average particle size of from 1 nm to 150 nm such as fillers (for example, silicon dioxide, fluoro-containing particles (such as magnesium fluoride, calcium fluoride, and barium fluoride), fine organic particles described in JP-A No. 11-3820 (column Nos. [0020] to [0038]), silane coupling agents, slipping agents, and surfactants.

In a case where the low refractive index layer situates below the outermost layer, the low refractive index layer may also be formed by a vapor phase method (vacuum vapor deposition method, sputtering method, ion plating method, plasma CVD method, etc.). A coating method is preferred in that it can be prepared at a reduced cost. The thickness of the low refractive index layer is, preferably, from 30 nm to 200 nm, more preferably, from 50 nm to 150 nm and, most preferably, from 60 nm to 120 nm.

### (Other Layers in Anti-Reflection Layer)

Further, a hard coat layer, forward diffusion layer, primer layer, anti-static layer, undercoat layer, or protective layer may also be disposed.

### (Hard Coat Layer)

A hard coat layer is disposed to the surface of a transparent support for providing a physical strength to the transparent protective film having the anti-reflection layer. Particularly, it is disposed preferably between the transparent support and the high refractive index layer. The hard coat layer is formed preferably by crosslinking reaction or polymerizing reaction of a photo- and/or heat curable compound, As the curing functional group, photo-polymerizable functional group is preferred and the organic metal compound containing the hydrolysable functional group is preferably an organic alkoxide silyl compound.

Specific example of the compounds includes compounds identical with those exemplified for the high refractive index layer.

Specific constituent compositions for the hard coat layer include, for example, those described in JP-A Nos. 2002-144913 and 2000-9908, and the pamphlet of WO-00/46617.

High refractive index layer can serve also as the hard coat layer. In such a case, it is preferably formed by finely dispersing fine particles and incorporating them in the hard coat layer by using the method described for the high refractive index layer.

The hard coat layer can serve also as an anti-dazzling layer provided with an anti-dazzling function (anti-glare function) by incorporating particles having an average particle size of 0.2 μm to 10 μm.

The thickness of the hard coat layer can be properly designed depending on the application use. The thickness of the hard coat layer is, preferably, from 0.2 μm to 10 μm and, more preferably, from 0.5 μm to 7 μm.

The strength of the hard coat layer is, preferably, H or more, more preferably, 2H or more and, most preferably, 3H or more in a pencil hardness in accordance with JIS K 5400. Further, it is more preferred as the amount of abrasion of a test specimen is smaller after the test in a taper test in accordance with JIS K 5400.

### (Antistatic Layer)

In a case of disposing an antistatic layer, it is preferred to provide a conductivity with a volumic resistivity of 10⁻⁸ Ωcm⁻³. While the volumic resistivity of 10⁻⁸ Ωcm⁻³ can be provided by the use of a hygroscopic material or water soluble organic salt, a certain kind of surfactant, cation polymer, anion polymer, colloidal silica, etc., it shows large dependence on temperature and humidity to involve a problem of not ensuring a sufficient conductivity at low humidity. Accordingly, metal oxides are preferred as the material for the antistatic layer. While some metal oxides are colored, in a case where such metal oxides are used as the material for the antistatic layer, a film is entirely pigmented which is not preferred Metals forming metal oxides causing no coloration, include Zn, Ti, Al, In, Si, Mg, Ba, Mo, W, or V and use of metal oxides comprising them as the main ingredient is preferred. Specific examples are preferably ZnO, TiO₂, SnO₂, Al₂O₃, In₂O₃, SiO₂, MgO, BaO, MoO₃, V₂O₅, etc., or composite oxides thereof, with ZnO, TiO₂, SnO₂ being particularly preferred. As examples of containing hetero atoms, addition of Al, In, etc. to ZnO, addition of Sb, Nb, halogen element, etc. to SnO₂, and addition of Nb or Ta, etc. to TiO₂ are preferred. Furthermore, as described in JP-B No. 59-6235, a material formed by depositing the metal oxide to other crystalline metal particles or fibrous materials (for example, titanium oxide) may also be used. While the volume resistance value and the surface resistance value are different physical values and can not be compared simply, for ensuring the conductivity of 10⁻⁸ Ωcm⁻³ or less in view of the volume resistance value, the antistatic layer may generally has a surface resistance value of 10⁻¹⁰Ω/□ or less, more preferably, 10⁻⁸Ω/□, It is necessary that the surface resistance value of the antistatic layer is measured as a value with the antistatic layer being as an outermost layer, and it can be measured in the intermediate stage of forming the laminate film described in the present specification.

Then, description is to be made to a liquid crystal display device of the invention having the cyclic polyolefin film, the protective film for use in polarizing plate, the optically-compensatory film, and the polarizing plate.

### (Liquid Crystal Display Device)

The cyclic polyolefin film, the optically-compensatory film having the film, and the polarizing plate using the film of the invention can be used in liquid crystal cells and liquid crystal display devices of various display modes. There have been proposed various display modes such as TN (Twisted Nematic), IPS (In-Plane Switching), FLC (Ferroelectric Liquid Crystal), AFLC (Anti-ferroelectric Liquid Crystal), OCB (Optically Compensatory Bend), STN (Super Twisted nematic), VA (Vertically Aligned) and HAN (Hybrid Aligned Nematic). They are used preferably for the OCB mode or VA mode among them.

The liquid crystal cell of the OCB mode is a liquid crystal display device using a liquid crystal cell of a bend alignment mode in which rod-like liquid crystalline molecules are aligned in substantially opposite directions (symmetrically) between the upper portion and the lower portion of the liquid crystal cell. The liquid crystal cell of OCB mode is disclosed in each of the specifications of U.S. Pat. Nos. 4,583,825 and 5,410,422. Since the rod-like liquid crystal molecules are aligned symmetrically between the upper portion and the lower portion of the liquid crystal cell, the liquid crystal cell of the bend alignment mode has a self-optically compensatory function. Accordingly, the liquid crystal mode is also referred to as an OCB (Optically Compensatory Bend) liquid crystal mode.

In the liquid crystal cell of the VA mode, the rod-like liquid crystalline molecules are aligned substantially vertically in a state of not applying the voltage.

The liquid crystal cell of the VA mode includes (1) a liquid crystal cell of VA mode in narrow meaning in which rod-like liquid crystalline molecules are aligned substantially vertically in a state of not applying voltage and aligned substantially horizontally in a state of applying voltage (described in JP-A No. 2-176625) and, in addition, (2) a liquid crystal cell of a multi-domained VA mode (MVA mode) for enlarging the view angle described in (SID97, Digest of “Tech. Paper (pre-text) 28 (1997) 845), (3) a liquid crystal cell of a mode in which rod-like liquid crystalline molecules are aligned substantially vertically in a state of not applying voltage and put to cramped multi-domain alignment in a state of applying voltage (n-ASM mode) (described in the Pretext of Japan Liquid Crystal Discussion Meeting, 58 to 59 (1998)) and (4) a liquid crystal cell of SURVAIVAL mode (presented in LCD International 98).

The liquid crystal display device of the VA mode comprises a liquid crystal cell and two sheets of polarizing plates disposed on both sides thereof, The liquid crystal cell supports liquid crystals between the two sheets of electrode substrates. In one embodiment of a transmission type liquid crystal display device of the invention, the optically-compensatory film of the invention is disposed by the number of one between the liquid crystal cell and one of the polarizing plates or disposed by the number of two between the liquid crystal cell and both of the polarizing plates.

In another embodiment of a transmission type liquid crystal display device of the invention, an optically-compensatory film having the cyclic polyolefin film of the invention is used as a transparent protective film for the polarizing plate disposed between the liquid crystal cell and the polarizer. That is, the transparent protective film of the polarizing plate can serve also as the optically-compensatory film. The optically-compensatory film may be used only for the transparent protective film of one of the polarizing plates (between the liquid crystal cell and the polarizer), or the optically-compensatory film described above may also be used for two sheets of transparent protective films for both of the polarizing plates (between the liquid crystal cell and the polarizer). In a case of using the optically-compensatory film only for one of the polarizing plates, it is used particularly preferably as the protective film for the polarizing plate on the side of the liquid crystal cell at the back light side of the liquid crystal cell. It is bonded preferably with the cyclic polyolefin film of the invention being on the side of the VA cell. The other protective film may also be a cellulose, acylate film usually used. For example, it is preferably from 40 μm to 80 μm and includes, for example, commercially available KC4UX2M (40 μm, produced by Yunicaopto Co.), KC5UX (60 μm, produced by Yunicaopto Co.), TD80 (80 μm, produced by Fuji Photographic Film), with no restriction to them.

In OCB mode liquid crystal display devices or TN liquid crystal display devices, an optically-compensatory film is used for enlarging the view angle. An optically-compensatory film for use in the OCB cell uses an optically anisotropic layer in which a discotic liquid crystal is fixed under hybrid alignment on an optically monoaxial or biaxial film. An optically-compensatory film for use in the TN cell uses an optically anisotropic layer in which descotic liquid crystal is fixed under hybrid alignment on an optically isometric film or a film having an optical axis in the direction of the thickness. The cyclic polyolefin film of the invention is useful also for the preparation of the optically-compensatory film for use in the OCB cell or the optically-compensatory film for use in the TN cell.

Next, the present invention, which achieves the second to fourth purposes of the present invention, is to be described specifically.

### <Preparation Method of Fine Particle Liquid Dispersion, and Fine Particle Liquid Dispersion>

At first, a method of preparing a liquid dispersion of fine particles according to the invention is to be described.

The method of preparing a liquid dispersion of fine particles according to the invention is a method of preparing a liquid dispersion of fine particles for obtaining the liquid dispersion of fine particles by applying a dispersing treatment under the presence of fine particles, an organic solvent, and a dispersant, in which the dispersant contains a cyclic olefin resin.

### (Fine Particle)

The fine particles used in the invention are used usually as additives for films For improving the poor slipperiness at the film surface, it is effective to provide the film surface with unevenness and they are used for decreasing adhesion by incorporating fine particles of organic or inorganic materials to increase the roughness at the film surface to provide a so-called matting state

However, since haze increases as the surface becomes coarser to lower the transparency, the average particle size and the content are restricted, The fine particles used in the invention have an average particle size of from 10⁻³ to 10² μm and, preferably, from 10⁻¹ to 10 μm and, more preferably, from 0.1 to 0.5 μm.

Further, the content in the film of the fine particles in a case of using them by addition to various kinds of films is from 0.03 to 0.60 mass %, preferably, from 0.03 to 0.30 mass % and, more preferably, from 0.03 to 0.15 mass % based on 100 mass % of the film irrespective that the fine particles are spherical or indefinite.

In the cyclic olefin resin film containing the fine particles in the invention has a haze within a range, preferably, 2.0% or less, more preferably, 1.2% or less and, particularly preferably, 0.5% or less. A preferred static friction coefficient of the cyclic olefin resin film with addition of the fine particles is 0.8 or less and, particularly preferably 0.5 or less. At a static friction coefficient of 0.8 or less, the cyclic olefin resin film does not result in cramps or creases in winding during take-up in the film formation and fabrication and, accordingly, figure of winding is not impaired by cramps or creases in winding, or no uniform tension exerts on the cyclic olefin resin film due to cramps or creases and it does not results in a problem that unintentional not uniform optical characteristics are developed to the film surface.

The static friction coefficient is measured between identical materials to each other, and it is measured specifically in accordance with a method described in examples.

Fine particles to be used have no particular restriction so long as they are usually used for the films and two or more kinds of fine particles can be used in admixture. The fine particles include those of inorganic compounds or polymeric compounds. The inorganic compounds include, for example, fine powder of inorganic materials such as barium sulfate, colloidal manganese, titanium dioxide, strontium barium sulfate, and silicon dioxide and, further, include, for example, silicon dioxide such as synthesis silica obtained by a wetting method or gelation of silicic acid and titanium dioxide formed from a titanium slug and sulfuric acid (rutile type or anatase type). Further, they can also be obtained by classification (vibratory filtration, pneumatic classification, etc.) after pulverization from inorganic materials of relatively large particle size, for example, of 20 μm or more. Inorganic fine particles are preferably those containing silicon in that the turbidity is lowered and the haze of the film can be lowered. Most of particles such as of silicon dioxide are surface treated with organic materials and they are preferred since they can lower the surface haze of the film. Preferred organic materials for the surface treatment include, for example, halosilanes, alkoxy silanes, silazanes, and siloxanes.

Further, the polymeric compounds include, polytetrafluoroethylene, cellulose acetate, polystyrene, polymethyl methacrylate, polypropyl methacrylate, polymethyl acrylate, polyethylene carbonate, starch, etc., as well as pulverization classified products thereof. Alternatively, polymeric compounds synthesized by a suspension polymerization method, polymeric compounds or inorganic compounds formed spheroidized by a spray dry method or a dispersion method can also be used.

Further, polymeric compounds which are polymers of one or more monomeric compounds to be described below particulates by various means may also be used. Monomeric compounds for the polymeric compounds specifically include acrylic acid ester, methacrylic acid ester, itaconic acid diester, crotonic acid ester, maleic acid diester, and phthalic acid diesters. The ester residues include, for example, methyl, ethyl, propyl, isopropyl, butyl, hexyl, 2-ethylhexyl, 2-chroroethyl, cyanoethyl, 2-acetoxyethyl, dimethylaminoethyl, benzyl, cyclohexyl, fulfuryl, phenyl, 2-hydroxyethyl, 2-ethoxyethyl, glycidyl, and ω-methoxy polyethylene glycol (addition mol number: 9).

Examples of vinyl esters include, vinyl acetate, vinyl propionate, vinyl butyrate, vinyl isobutyrate, vinyl caproate, vinyl chloroacetate, vinyl methoxy acetate, vinyl phenyl acetate, vinyl benzoate, and vinyl salicynate. Further examples of olefins include, dicyclopentadiene, ethylene, propylene, 1-butene, 1-pentene, vinyl chloride, vinylidene chloride, isoprene, chloroprene, butadiene, and 2,3-dimethyl butadiene.

Styrenes include, for example, styrene, methyl styrene, dimethyl styrene, trimethyl styrene, ethyl styrene, isopropyl styrene, chloromethyl styrene, methoxy styrene, acetoxy styrene, chloro styrene, dichloro styrene, bromo styrene, trifluoromethyl styrene and methyl vinyl benzoate ester.

The acrylamides include acrylamide, methyl acrylamide, ethyl acrylamide, propyl acrylamide, butyl acrylamide, tert-butyl acrylamide, phenyl acrylamide, dimethyl acrylamide; methacrylamides, for example, methacryl amide, ethyl methacrylamide, and methyl methacrylamide, propyl methacrylamide, tert-butyl methacrylamide; allyl compounds, for example, allyl acetate, allyl capronate, allyl laurate, and allyl benzoate; vinyl ethers, for example, methyl vinyl ether, butyl vinyl ether, hexyl vinyl ether, methoxyethyl vinyl ether, and dimethyl aminoethyl vinyl ether; vinyl ketones, for example, methyl vinyl ketone, phenyl vinyl ketone, and methoxyethyl vinyl ketone; vinyl hetero ring compounds, for example, vinyl pyridine, N-vinyl imidazole, N-vinyl oxazolidone, N-vinyl triazole, and N-vinyl pyrrolidone; unsaturated nitriles, for example, acrylonitrile and methacrylonitrile; polyfunctional monomers, for example, divinyl benzene, methylene bisacryloamide, and ethylene glycol dimethacryalte.

There are further included acrylic acid, methacrylic acid, itaconic acid, maleic acid, monoalkyl itaconate (for example, monoethyl itaconiate); monoalkyl maleate (for example, monomethyl maleate); styrene sulfonic acid, vinylbenzyl sulfonic acid, vinyl sulfonic acid, acryloyloxyalkyl sulfonic acid (for example, acryloyloxy methyl sulfonic acid); methacryloyloxy alkyl sulfonic acid (for example, methacryloyloxy ethyl sulfonic acid); acrylamide alkyl sulfonic acid (for example, 2-acrylamide-2-methyl ethane sulfonic acid); methacrylamide alkyl sulfonic acid (for example, 2-methacrylamide-2-methyl ethane sulfonic acid); and acryloyloxy alkyl phosphate (for example, acryloyloxy ethyl phosphate). The acids may also be salts of alkali metals (for example, Na and K) or ammonium ions. Further, other monomeric compounds can include, crosslinking monomers described, for example, in the specification of U.S. Pat. Nos. 3,459,790, 3,438,708, 3,554,987, 4,215,195, and 4247673, and JP-A No. 57-205735 are preferably used Examples of such crosslinking monomers include, specifically, N-(2-acetoacetoxy)ethyl)acrylamide, and N-(2-(2-acetoacetoxy ethoxy)ethyl)acrylamide, etc.

The monomeric compounds may be used as polymer particles by homo-polymer of them may be used as copolymer particles by polymerization of a plurality of monomers in combination. Among the monomeric compounds, acrylic acid esters, methacrylic acid esters, vinyl esters, styrenes, and olefins are used preferably. Further, particles containing fluorine atoms or silicon atoms as described in JP-A Nos. 62-14647, 62-17744, and 62-17743 may also be used in the invention.

Polymer compositions used preferably among them include polystyrene, polymethyl(meth)acrylate, polyethyl acrylate, poly(methyl methacrylate/methacrylic acid=95/5 (molar ratio), poly(styrene/styrene sulfonic acid=95/5 (molar ratio), polyacrylonitrie, poly(methyl methacrylate/ethyl acrylate/methacrylic acid=50/40/10), silica, etc.

As the fine particles used in the invention, particles having reactive groups (particularly, gelatin) described in JP-A No. 64-77052, and EP No. 307855 can be used. Further, groups that are soluble in an alkaline or acidic condition may also be incorporated in a great amount. Specific examples of fine particles or materials therefor used in the invention are shown below but they are not restrictive.

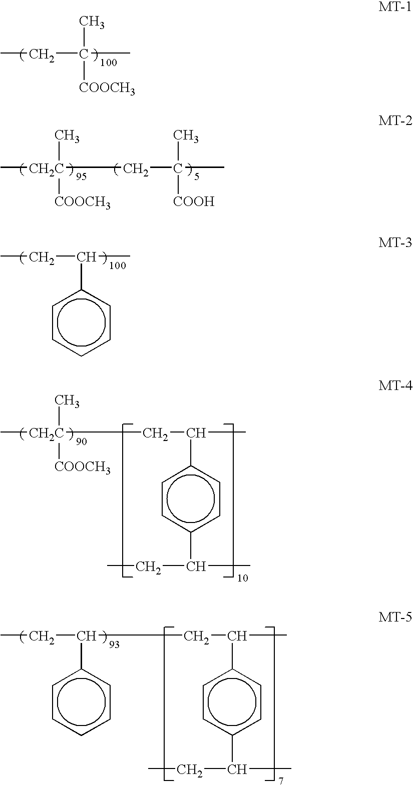

MT-6 silica (spherical)

MT-7 silica (amorphous)

The liquid dispersion of fine particles containing the fine particles in the invention is prepared separately from the starting material for the cyclic olefin resin dope and finally mixed therewith and used for the preparation of the dope.

As described above, the fine particle contains an inorganic compound or polymeric compound and the average primary particle size is preferably from 10⁻³ to 10 μm. The average primary particle size is, preferably, from 10⁻³ to 10 μm, further preferably, from 0.005 to 5 μm and, most preferably, from 0.01 to 3 μm. The fine particle is preferably a fine particle of silicon dioxide.

### (Organic Solvent Used for the Fine Particle Liquid Dispersion)

The organic solvent used in the method of preparing liquid dispersion of fine particles of the invention is not particularly restricted so long as it can disperse the fine particles and prepare the liquid dispersion. The organic solvent used in the invention is preferably a solvent selected, for example, from chlorine type solvents such as dichloromethane and chloroform, and chained hydrocarbons, cyclic hydrocarbons, aromatic hydrocarbon, esters, ketones, and ethers of 3 to 12 carbon atoms. The ester, ketone and ether may have a cyclic structure. Examples of the chain hydrocarbons of 3 to 12 carbon atoms include hexane, octane, isooctane, and decane. Examples of cyclic hydrocarbons of 3 to 12 carbon atoms include cyclopentane, cyclohexane, decaline, and derivatives thereof. Examples of aromatic hydrocarbons of 3 to 12 carbon atoms include benzene, toluene, and xylene. Examples of esters of 3 to 12 carbon atoms include ethyl formate, propyl formate, pentyl formate, methyl acetate, ethyl acetate, and pentyl acetate. Examples of ketones of 3 to 12 carbon atoms include acetone, methyl ethyl ketone, diethyl ketone, diisobutyl ketone, cyclopentanone, cyclohexanone, and methyl cyclohexanone. Examples of ethers of 3 to 12 carbon atoms include diisopropyl ether, dimethoxy methane, dimethoxy ethane, 1,4-dioxane, 1,3-dioxolane, tetrahydrofuran, anisole, and phenetole. Examples of organic solvents having two or more kinds of functional groups include 2-ethoxyethyl acetate, 2-methoxyethanol, and 2-butoxyethanol. For the organic solvent used in the method of preparing the liquid dispersion of the fine particles of the invention, an organic solvent may be used alone, or two or more kinds of organic solvents may be used being mixed at an optional ratio.

When the fine particles are dispersed, in a case where the amount of the organic solvent is smaller, no sufficient dispersion can be attained and coagulates are formed to cause obstacle failure. On the other hand, in a case where the amount of the organic solvent is excessive, although the dispersibility of the fine particles is excellent, a great amount of liquid dispersion is prepared which is not preferred in view of handling in the production. Accordingly, the amount of the organic solvent to be used is, preferably, from 1000 to 100,000 mass parts, more preferably, from 1,500 to 40,000 mass parts and, most preferably, from 2,000 to 20,000 parts based on 100 mass parts of the fine particles.

### (Dispersant)

Then, dispersant to be used in the invention is to be described. In a case of in-line mixing the liquid dispersion of fine particles and the dope, when a liquid dispersion of low viscosity is used, addition to the dope of high viscosity is somewhat difficult being effectuated by the difference of the viscosity and mixing can not be attained satisfactorily. The problem can be overcome by dissolving a dispersant in the liquid dispersion to slightly increase the viscosity. For this purpose, a resin is usually used as the dispersant. While it is preferred that the viscosity is equal between the dope and the liquid dispersion only in view of mixing, the viscosity of the liquid dispersion of fine particles is, preferably, 0.7 MPa·S or more and, more preferably, 1 MPa·S or more considering the dispersibility of the liquid dispersion of the fine particles and the convenience of handling. Further, in a case where the mass average molecular weight of the dipersant is increased excessively for increasing the viscosity, this results in dissolution failure of the dispersant or worsening of the filterability. Accordingly, for preparing a liquid dispersion excellent in the solubility and the filterability not effectuated by the dope, the mass average molecular weight of the dispersant is, preferably, from 10,000 to 50,000, more preferably, from 10,000 to 300,000 and, further preferably, from 30,000 to 200,000 by mass average molecular weight.

As a result of the study according to the present inventors while varying the kind of the dispersant, it has been surprisingly found that the dispersed state and the dispersion stability of the liquid dispersion of the fine particles can be enhance by using a cyclic olefin resin as the dispersant and dispersing the fine particles under the presence of the dispersant. The cyclic olefin resin used as the dispersant has no particular restriction and the following cyclic olefin resins can be used preferably. Further, it has been found that the liquid dispersion of the fine particles of the invention are utilized preferably for the production of the cyclic olefin resin film and the compatibility between the liquid dispersion of the fine particles and the dope can be improved upon preparation of the dope, the stability of the dispersed fine particles can also be improved when formed as a cast dope and that a dope with no coagulates can be formed.

The cyclic olefin resin usable as the dispersant in the invention includes, specifically (1) norbornene polymers, (2) polymers of mono-nuclear cyclic olefins, (3) polymers of cyclic conjugated dienes, (4) vinyl alicyclic hydrocarbon polymers, and hydrogenation products of (1) to (4). Polymers preferred for the invention are addition (co)polymer cyclic olefin resin containing at least one kind of repetitive units represented by the following formula (2-II) and addition (co)polymer cyclic olefin resin further containing at least one kind of repetitive units represented by the formula (2-I) optionally. Further, ring-opened (co)polymers containing at least one kind of cyclic repetitive units represented by the formula (2-III) can also be used suitably.

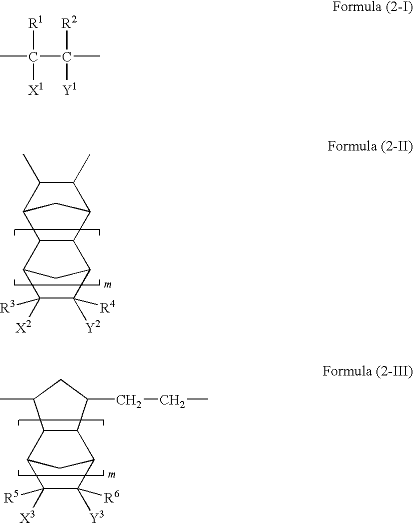

In the formulae, m represents an integer of 0 to 4. R¹ to R⁶ represents a hydrogen atom or hydrocarbon group of 1 to 10 carbon atoms, X¹ to X³, Y¹ to Y³ each represents a hydrogen atom, hydrocarbon group of 1 to 10 carbon atoms, halogen atom, hydrocarbon group of 1 to 10 carbon atoms substituted with halogen atom, —(CH₂)ₙCOOR¹¹—, —(CH₂)ₙOCOR¹²—, —(CH₂)ₙNCO, —(CH₂)ₙNO₂, —(CH₂)ₙCN, —(CH₂)ₙCONR¹³R¹⁴—, —(CH₂)ₙNR¹³R¹⁴—, —(CH₂)ₙOZ, —(CH₂)ₙW, or (—CO)₂, (—CO)₂NR¹⁵ constituted from X¹ and Y¹, X² and Y², or X³ and Y³. R¹¹, R¹², R¹³, R¹⁴, and R¹⁵ each represents a hydrogen atom, or hydrocarbon group of 1 to 20 carbon atoms, Z represents a hydrocarbon group or hydrocarbon group substituted with halogen, W represents SiR¹⁶ₚD₃₋ₚ (R¹⁶ represents a hydrocarbon group of 1 to 10 carbon atoms, D represents a halogen atom, —OCOR¹⁶, or —OR¹⁶, p represents an integer of 0 to 3), and n represents an integer of 0 to 10.

By introducing highly polarizing a functional group to the substituent of X¹ to X³ and Y¹ to Y³, it is possible to increase the retardation in the thickness direction of an optical film (Rth) and increase the developability of the in-plane retardation (Re).

Norbornene addition (co) polymers are disclosed, for example, in JP-A No. 10-7732, JP-W No. 2002-504184, US No. 2004229157A1, and WO2004/070463A1. They can be obtained by addition polymerization of unsaturated norbornene polycyclic compounds to each other. Further, unsaturated norbornene polycyclic compounds can also be put to addition polymerization with ethylene, propylene, butane; conjugated diene such as butadiene and isoprene; non-conjugated diene such as ethylidene norbornene; linear diene compounds such as acrylonitrile, acrylic acid, methacrylic acid, maleic acid anhydride, acrylic acid water, methacrylic acid ester, maleimide, vinyl acetate, and vinyl chloride. The norbornene type addition (co)polymers are marketed available under the trade name of APEL from Mitsui Chemical Co. and include grades such as APL8008T (Tg 70° C.), APL6013T (Tg 125° C.) and APL6015T (Tg 145° C.) of different glass transition temperatures (Tg). Pellets such as TOPAS 8007, 6013, 6015 a marketed from polyplastics Co. Further, APPEAR 3000 is marketed from Ferrania Co.

The norbornene type polymer hydrogenation products are prepared by addition polymerization or metathesis ring opening polymerization of unsaturated polycyclic compounds followed by hydrogenation as disclosed, for example, in JP-A Nos. 1-240517, 7-196736, 60-26024, 62-19801, 2003-1159767, or 2004-309979. In the norbornene type polymer used in the invention, R⁵ to R⁶ each preferably represents atom or —CH₃, X³ and Y³ each preferably a hydrogen atom, Cl, or COOCH₃, and other groups are properly selected. The norbornene type resins marketed from JSR Co. under the trade name of Arton G and Arton F and further marketed under the trade name of Zeonor ZF14, ZF16 and Zeonex 250 and Zeonex 280 from Nippon Zeon Co. and they can be used.

The cyclic olefin resin as the dispersant can enhance the affinity with fine particles having a polar group at the substituent which is more preferred. A cyclic olefin resin film produced by preparing a dope using a liquid dispersant by the use of a resin having a polar group at the substituent as the dispersant and produced by a solution casting method shows less detachment of fine particles after film formation to prevent lowering of the yield upon fabrication of a polarizing plate due to obstacle failure. In the repetitive units of the cyclic olefin type resin polymer, the unit having the polar group is present preferably by 40% or more, more preferably, 60% or more, further preferably, 80% or more and, particularly preferably, 100%. The polar group has no particular restriction and a halogen atom, hydrocarbon group of 1 to 10 carbon atoms substituted with a halogen atom, —(CH₂)ₙCOOR²¹, —(CH₂)ₙOCOR²², —(CH₂)ₙNCO, —(CH₂)ₙNO₂, —(CH₂)ₙCN, —(CH₂)ₙCONR²³R²⁴—, —(CH₂)ₙOZ, —(CH₂)ₙW¹, or (—CO)₂O, (—CO)₂NR²⁵ and, among all, —(CH₂)ₙCOOR²¹, or —(CH₂)ₙOCOR²² is particularly preferred. R²¹, R²², R²³, R²⁴, and R²⁵ each represents a hydrogen atom or hydrocarbon group of 1 to 20 carbon atoms, Z¹ represents a hydrocarbon group or hydrocarbon group substituted with halogen, W¹ represents SiR²⁶_{P}D_{3-P} (R²⁶ represents a hydrocarbon group of 1 to 10 carbon atoms, D represents a halogen atom, —OCOR²⁶ or —OR²⁶, and p represents an integer of from 0 to 3), and n represents an integer of from 0 to 10.

The present inventor have found for the light transmittance of the cyclic olefin resin film produced by the solution casting method, that the dispersant in the liquid dispersion of the fine particles more preferably contains a resin identical with the film resin and that a film showing excellent light transmittance can be produced by providing the dispersibility for the high particles and the compatibility of the dispersant with the dope together. Accordingly, the dispersant used in the invention may contain the cyclic olefin resin. While the cyclic olefin resin and various kinds of dispersants used as the dispersant for the fine particles can be used in admixture, it is preferred in the invention to use only the cyclic olefin resin as the dispersant.

The compounding amount of the dispersant is from 50 to 400 mass parts based on 100 mass parts of the fine particles in view of mixing with the dope, the dispersibility and the convenience upon handling of the liquid dispersion of the fine particles and it is more, preferably, from 100 to 200 mass parts.

The methods of preparing the liquid dispersion of the fine particles of the invention has a feature in applying a dispersing treatment by a dispersion device or the like in a state where the cyclic olefin resin is present as the dispersant described above, and the specific preparation method includes the methods, for example, as shown below. (1) A small amount of the cyclic olefin resin is added to the solvent, dissolved under stirred, to which fine particles are added and dispersed by a dispersion device into the liquid dispersion of the fine particles. (2) After mixing and stirring the solvent, the dope of the cyclic olefin resin, and the fine particles, they are dispersed by a dispersion device into a liquid dispersion of the fine particles.

Customary methods can be used with no particular restriction for the method of the dispersing treatment. For example, a media dispersion device includes an atriter, ball mill, sand mill or Dyno-mill. A medialess dispersion device includes, for example, a supersonic type, centrifugal type, or a high pressure type device. While dispersion may be conducted with or without using the dispersion device described above, use of the device is preferred.

In the method of preparing the liquid dispersion of the fine particles of the invention, the dispersion liquid is desirably filtered after the completion of the dispersing treatment and it is preferably transported by way of a conduit with no stagnation in a stock tank or the like and not by way of a delivery pump, and mixed in a junction pipe with the cyclic olefin resin solution transported through a conduit with view points of not stagnating both of the solutions and not forming additional coagulates in the pump after batchwise mixing. For rapidly mixing both of the solutions, they are further preferably mixed in an in-line mixer located just after the junction pipe. This is preferred since both of the solutions are not stagnated and additional coagulates due to the delivery pump are not generated. Filtration is conducted by a filtering device located just before the in-line mixer. A filtration material in the filtration device includes, for example, particle-filled layer, metal mesh (particularly, folded mesh), woven fabric, filter paper, perforated plate (containing micropore). While they are not particularly restricted so long as they can be used for long time at a predetermined absolute filtration rating, a metal material is preferred in view of the solvent resistance or the durability and stainless steel is more preferred. With a view point of clogging, the absolute filtration rating is, preferably, from 10 to 100 μm and, more preferably, from 30 to 60 μm, by which long time use at a predetermined absolute filtration rating is possible.

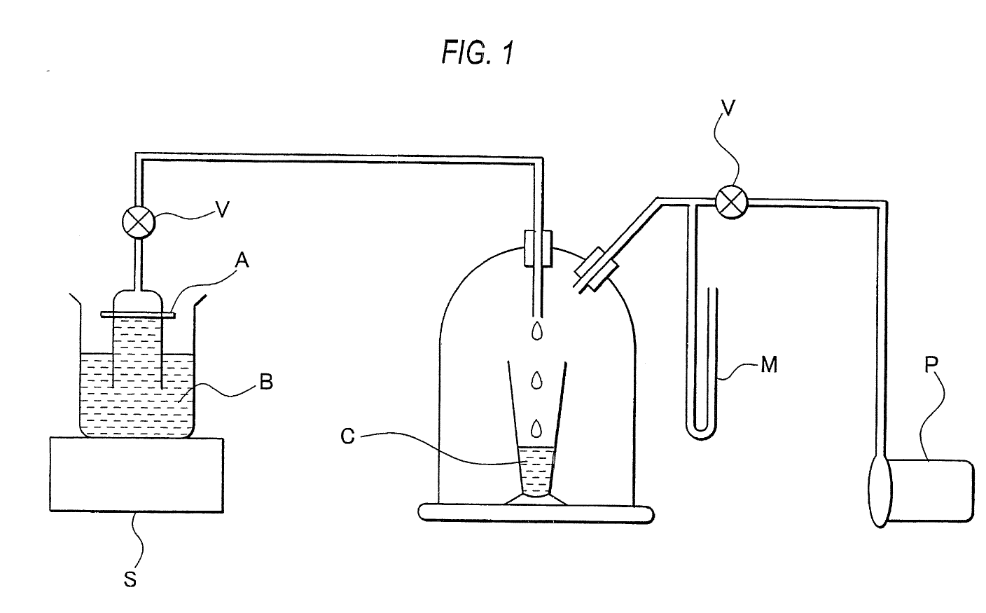

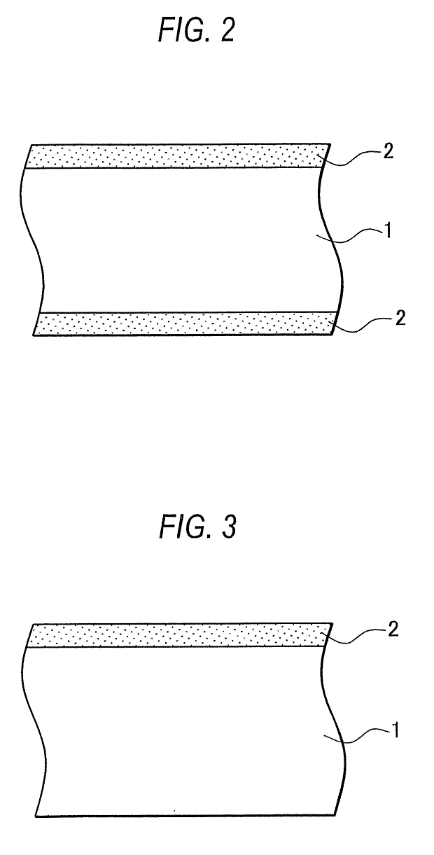

In the invention, the absolute filtration rating is defined as described below. Glass beads as a test powder of different particle sizes in accordance with JIS Z 8901 and purified water are placed in a beaker and put to filtration under suction while stirring by a stirrer in a device as shown in FIG. 1. FIG. 1 schematically shows a device for measuring an absolute filtration rating. In the drawing, A represents a sample of filter material to be measured, B represents a liquid to be filtrated, and C represents filtrate. The liquid B to be filtered is stirred by a stirrer S and filtered while kept at a pressure from an atmospheric pressure to −4 kPa by a low pressure vacuum pump P. V represents an on/off valve and M represents a manometer. The numbers of glass beads in the liquid B to be filtrated and the filtrate C are observed under a microscope and the particle capturing rate is determined according to the following equation. The particle size at the particle capturing ratio of 90% is defined as an absolute filtration rating.

Particle capturing rate (%)=(number of particles in the liquid to be filtrated−number of particles in the filtrate)/(number of particles in the liquid to be filtrated)×100 In the invention, the absolute filtration rating is preferably from 10 to 100 μm.

The porosity of the filter material is, preferably, from 60 to 80% and, more preferably, 65 to 75%. While higher porosity is preferred since the pressure loss decreases, lower porosity is preferred in view of excellent pressure proofness. The porosity is determined by at first dipping a filter material in a medium of low surface tension to remove air in the filter material and determining the amount of pores in the filter based on the amount of the solvent increased and then dividing the same with the volume of the filter material.

The liquid dispersion of the fine particles of the invention is produced by the method of preparing the liquid dispersion of the fine particles of the invention described above in which fine particles, an organic solvent, and a dispersing are dispersed and mixed preferably at a blending ratio described above.

### <Dope Preparation Method>

Then, a method of preparing a dope in the invention is to be described.

The method of preparing the dope in the invention has a feature in admixing a liquid dispersion of the fine particles of the invention to a cyclic olefin resin solution containing a cyclic olefin resin and a organic solvent.

Further, the dope obtained by the preparation method of the invention is a resin solution used upon production of the cyclic olefin resin film of the invention.

As described above, in the invention, the liquid dispersion of the fine particles is transported through a conduit, added in an in-line manner in a junction pipe with a cyclic olefin resin solution transported through another conduit and then preferably mixed by an in-line mixer. Further, the liquid dispersion of the fine particle is preferably filtered through a filtration device at an absolute filtration rating of from 10 to 100 μm.

Now, the ingredients for the starting material of the dope are to be described.

In the invention, the dope preferably comprises the liquid dispersion of the fine particles, the cyclic olefin resin, the solvent, and additives used optionally.

### (Cyclic Olefin Resin)

At first, a cyclic olefin resin used as the starting ingredient of the dope in the invention is to be described.

The cyclic olefin resin used in the invention is a polymer resin having the olefin structure and, specifically, includes those compounds exemplified in the description for the method of preparing the liquid dispersion of the fine particles,

Particularly, in the invention, the cyclic olefin resin in the liquid dispersion of the fine particles and the cyclic olefin resin in the cyclic olefin resin solution are preferably identical. That is, it is preferred that a material identical with the cyclic olefin resin used as the main ingredient of a desired cyclic olefin resin film is used as the dispersant of the liquid dispersion of the fine particles.

### (Additive)

Various additives (for example, aging inhibitor, UV-ray inhibitor, retardation (optical anisotropy) developer, fine particle, separation accelerator, IR absorbent, etc.) can be used depending on the application use in each of the film producing steps, and they may be either solids or oily products. That is, they are not particularly restricted in view of the melting point and the boiling point thereof. For example, they include mixtures of UV-ray absorbing materials of 20° C. or lower and 20° C. or higher and in the same manner, mixtures of aging inhibitors. Furthermore, IR-absorbing dye is described, for example, in JP-A No. 2001-194522. Further, as the timing of addition, they may be added at any stage in the step of preparing the cyclic polyolefin solution (dope), they may be added by additionally providing a step of adding and preparing additives at the final preparation step of the dope preparation step. Furthermore, the addition amount for each of the materials is not particularly restricted so long as the function is developed. Further, in a case where the cyclic polyolefin film is formed of multiple layers, the kind and the addition amount of the additives in each of the layers may be different.

### (Aging Inhibitor)

In the invention, known aging (oxidizing) inhibitors can be added to the cyclic polyolefin solution and, for example, they include phenol or hydroquinone type antioxidant such as 2,6-di-t-butyl, 4-methylphenol, 4,4′-thiobisp(6-t-butyl-3-methylphenol), 1,1′-bis(4-hydroxyphenyl)cyclohexanone, 2,2′-methylenebis(4-ethyl-6-t-butylphenol), 2,5-di-t-butylhydroquinone, and pentaerythrityl-tetrakiss[3-(3,5-di-t-butyl-4-hydroxyphenyl) propionate]. Further, it is preferred to add phosphoric antioxidants such as tris(4-methoxy-3,5-diphenyl)phosphate, tris(nonylphenyl)phosphite, tris(2,4-di-t-butylphenyl)phosphite, bis(2,6-di-t-butyl-4-methylphenyl)pentaerythritol diphosphite, and bis(2,4-di-t-butylphenyl)pentaerythritol diphosphite. The addition amount of the antioxidant is from 0.05 to 5.0 mass parts based on 100 parts of the cyclic polyolefin resin.

### (UV-Absorbent)

In the Invention, a UV-Absorbent is Used Preferably to the Cyclic Polyolefin solution with a view point of preventing the deterioration of a polarizing plate or liquid crystals. UV-absorbents with less absorption for visible light at a wavelength of 400 nm or more are used preferably with a view point of excellent absorbancy of UV-light at a wavelength of 370 nm or less and favorable liquid crystal display property. Specific examples of the UV-absorbents used preferably in the invention include, for example, hindered phenol type compounds, oxybenzophenon type compounds, benzotriazole type compound, salicylate ester type compounds, benzophenone type compounds, cyanoacrylate type compounds, and nickel complex salt type compounds. Examples of the hindered phenolic compounds include, for example, 2,6-di-tert-butyl-p-cresole, pentaerythrityl-tetrakis[3-(3,5-di-tert-butyl-4-hydroxyphenyl)propionate], N,N′-hexamethylenebis(3,5-di-tert-butyl-4-hydroxy-hydrocinnamide), 1,3,5-trimethyl-2,4,6-tris(3,5-di-tert-butyl-4-hydroxybenzyl)benzene, and tris-(3,5-di-tert-butyl-4-hydroxybenzyl)-isocyanurate. Examples of the benzotriazole type compounds include, for example, 2-(2′-hydrixy-5′-methylphenyl)benzotriazole, 2,2-methylenebis(4-(1,1,3,3-tetramethylbutyl)-6-(2H-benzotriazol-2-yl)phenol), (2,4-bis-(n-octylthio)-6-(4-hydroxy-3,5-di-tert-butylanilino)-1,3,5-triazine, triethyleneglycol-bis[3-(3-tert-butyl-5-methyl-4-hydroxyphenyl)propionate], N,N′-hexamethylenebis(3,5-di-tert-butyl-4-hydroxy-hydrocinnamide), 1,3,5-trimethyl-2,4,6-tris(3,5-di-tert-butyl-4-hydroxybenzyl)benzene, 2(2′-hydroxy-3′, 5′-di-tert-butylphenyl)-5-chlorbenzotriazole, 2(2′-hydroxy-3′,5′-di-tert-amylphenyl)-5-chlorbenzotriazole, 2,6-di-tert-butyl-p-crezole, and pentaerythrityl-tetrakis[3-(3,5-di-tert-butyl-4-hydroxyphenyl)propionate]. The addition amount of the UV-inhibitor is, preferably, from 1 ppm to 1.0% and, more preferably, from 10 to 1000 ppm at the mass ratio based on the entire cyclic polyolefin film.

### (Peeling Accelerator)

As additives for decreasing the peeling resistance of the cyclic polyolefin film, many additives having remarkable effect have been found in the surfactants. As preferred peeling accelerator, phosphate ester type surfactants, carbonate salt type surfactants, sulfonate salt type surfactants, and sulfate ester type surfactants are effective. Further, a fluoro surfactant in which a portion of hydrogen atoms bonded to the hydrocarbon chain of the surfactant is substituted with fluorine atoms is effective. Examples of the peeling accelerator that can be used preferably in the invention are shown below.

### RZ-1: C₈H₁₇O—P(═O)—(OH)₂

### RZ-2: C₁₂H₂₅O—P(═O)—(OK)₂

### RZ-3: C₁₂H₂₅OCH₂CH₂O—P(═O)—(OK)₂

### RZ-4: C₁₅H₃₁(OCH₂CH₂)₅O—P(═O)—(OK)₂

### RZ-5: {C₁₂H₂₅O(CH₂CH₂O)₅}₂—P(═O)—OH

### RZ-6: {C₁₈H₃₅O(OCH₂CH₂O)₈}₂—P(═O)—ONH₄

RZ-7: (t-C₄H₉)₃—C₆H₂—OCH₂CH₂O—P(═O)—(OK)₂
RZ-8: (iso-C₉H₁₉—C₆H₄—O—(CH₂CH₂O)₅—P(═O)—(OK)(OH)

### RZ-9: C₁₂H₂₅SO₃Na

### RZ-10: C₁₂H₂₅OSO₃Na

### RZ-11: C₁₇H₃₃COOH

### RZ-12: C₁₇H₃₃COOH.N(CH₂CH₂OH)₃

RZ-13: iso-C₈H₁₇—C₆H₄—O—(CH₂CH₂O)₃—(CH₂)₂SO₃Na
RZ-14: sodium triisopropyl naphthalene sulfonate
RZ-15: (iso-C₉H₁₉)₂—C₆H₃—O—(CH₂CH₂O)₃—(CH₂)₄SO₃Na
RZ-16: sodium tri-t-butyl naphthalene sulfonate

### RZ-17: C₁₇H₃₃CON(CH₃)CH₂CH₂SO₃Na

### RZ-18: C₁₂H₂₅C₆H₄SO₃.NH₄

The addition amount of the peeling accelerator is, preferably, from 0.05 to 5 mass parts, more preferably, from 0.1 to 2 mass parts and, most preferably, from 0.1 to 0.5 mass parts based on the cyclic polyolefin resin.

### (Retardation Developer)

In the invention, a compound having at least two aromatic rings can be used as a retardation developer for developing a retardation value. In a case of using the retardation developer, it is, preferably, used in a range from 0.05 to 20 mass parts, more preferably, used in a range from 0.1 to 10 mass parts, further preferably, used in a range from 0.2 to 5 mass parts and, most preferably, used in a range from 0.5 to 2 mass parts based on 100 mass parts of the cyclic polyolefin resin. Two or more kinds of retardation developers may also be used in combination.

The retardation developer preferably has a maximum absorption in a wavelength region from 250 to 400 nm and, preferably, has no substantial absorption in a visible region.

In the present specification, “aromatic ring” includes an aromatic hetero ring in addition to the aromatic hydrocarbon ring. The aromatic hydrocarbon ring is particularly preferably a 6-membered ring (that is, benzene ring). The aromatic hetero ring is generally an unsaturated hetero ring. The aromatic hetero ring is, preferably, a 5-membered ring, 6-membered ring or 7-membered ring and, further preferably, 5-membered ring or 6-membered ring. Aromatic hetero rings generally have utmost double bonds. As the hetero atom, a nitrogen atom, an oxygen atom, and a sulfur atom are preferred, with the nitrogen atom being particularly preferred. Examples of the aromatic hetero ring include a furan ring, thiphene ring, pyrrole ring, oxazole ring, isooxazole ring, thiazole ring, isothiazole ring, imidazole ring, pyrazole ring, furazan ring, triazole ring, pyran ring, pyridine ring, pyridazine ring, pyrimidine ring, pyridine ring, and 1,3,5-triazine ring. As the aromatic ring, benzene ring, furan ring, thiophene ring, pyrrole ring, oxazole ring, thiazole ring, imidazole ring, triazole ring, pyridine ring, pyrimidine ring, pyrazine ring, and 1,3,5-triazine ring are preferred, 1,3,5-triazine ring being used particularly preferably. Specifically, those compounds described, for example, in the JP-A No. 2001-166144 are used preferably.

The retardation developer has aromatic rings by the number of, preferably, from 2 to 20, more preferably, from 2 to 12, further preferably, from 2 to 8 and, more preferably, 2 to 6. The connection relation between the two aromatic rings can be classified into (a) a case of forming a condensed ring, (b) a case of direct coupling by a single bond and (c) a case of bonding by way of a connection group (spiro bonding can not be formed in view of the heterocyclic rings). The bonding relation may be any of (a) to (c).

Examples of the condensed ring (condensed ring of two or more aromatic rings) in (a) include indene ring, naphthalene ring, azulene ring, fluorene ring, phenanthrene ring, anthracene ring, acenaphthylene ring, biphenylene ring, naphthacene ring, pyrene ring, indole ring, isoindole ring, benzofuran ring, benzothiophene ring, indolizine ring, benzooxazole ring, benzothiazole ring, benzoimidazole ring, benzotriazole ring, purine ring, indazole ring, chromene ring, quinoline ring, isoquinoline ring, quinolidine ring, qulinazoline ring, cynnoline ring, quinoxaline ring, phthalazine ring, pteridine ring, carbazole ring, acridine ring, phenanthridine ring, xanthene ring, phenazine ring, phenothiazine ring, phenoxathine ring, phenoxadine ring, and thianthrene ring. Naphthalene ring, azulene ring, indole ring, benzooxazole ring, benzothiazole ring, benzoimidazole ring, benzotriazole ring, and quinoline ring are preferred.

Single bond in (b) is preferably a bond between carbon atoms of the two aromatic rings. An aliphatic ring or non-aromatic heterocyclic ring may also be formed between two aromatic rings by bonding two aromatic rings with two or more single bonds.

Also the connection group in (c) is preferably bonded with carbon atoms of the two aromatic rings. The connection group is preferably alkylene group, alkenylene group, alkynylene group, —CO—, —O—, —NH—, —S—, or combination thereof. Example of the connection group comprising the combination are shown below. The left-to-right relation for the following connection groups may be in an opposite relation

c1: —CO—O—

### C2: —CO—NH—

C3: -alkylene-O—

### C4: —NH—CO—NH—

### C5: —NH—CO—O—

### C6: —O—CO—O—

### C7: —O-alkylene-O—

### C8: —CO-alkenylene-

### C9: —CO-alkenylene-NH—

### C10: —CO-alkenylene-O—

C11: -alkylene-CO—O-alkylene-O—CO-alkylene-

### C12: —O-alkylene-CO—O-alkylene-O—CO-alkylene-O—

### C13: —O—CO-alkylene-CO—O—

### C14: —NH—CO-alkenylene-

### C15: —O—CO-alkenylene-

The aromatic ring and the connection group may have a substituent. Examples of the substituent include halogen atoms (F, Cl, Br, I), hydroxyl, carboxyl, cyano, amino, nitro, sulfo, carbamoyl, sulfamoyl, ureido, alkyl group, alkenyl group, alkynyl group, aliphatic acid group, aliphatic acyloxy group, alkoxy group, alkoxycarbonyl group, alkoxycarbonylamino group, alkylthio group, alkylsulfonyl group, aliphatic amide group, aliphatic sulfoneamide group, aliphatic substituted amino group, aliphatic substituted carbamoyl group, aliphatic substituted sulfamoyl group, aliphatic substituted ureido group, and non-aromatic heterocyclic ring.

The number of carbon atoms in the alkyl group is, preferably, from 1 to 8. A chained alkyl group is preferred to a cyclic alkyl group and a linear alkyl group is particularly preferred. The alkyl group may further have a substituent (for example, hydroxyl, carboxy, alkoxy group, alkyl-substituted amino group). Examples of the alkyl group (including substituted alkyl group) include methyl, ethyl, n-butyl, n-hexyl, 2-hydroxethyl, 4-carboxybutyl, 2-methoxyethyl and 2-diethylamino ethyl.

The number of carbon atoms in the alkenyl group is preferably, from 2 to 8. A chained alkenyl group is preferred to a cyclic alkenyl group and a linear alkenyl group is particularly preferred. The alkenyl group may further have a substituent. Examples of the alkenyl group include vinyl, allyl, and 1-hexenyl. The number of carbon atoms in the alkynyl group is, preferably, from 2 to 8. A chained alkynyl group is preferred to a cyclic alkenyl group and a linear alkynyl group is particularly preferred. The alkynyl group may further have a substituent. Examples of the alkynyl group include, ethynyl, 1-butynyl, and 1-hexynyl.

The number of carbon atoms in the aliphatic acyl group is, preferably, from 1 to 10. Examples of the aliphatic acyl group include acetyl, propanoyl, and butanoyl. The number of carbon atoms in the aliphatic acyloxy group is, preferably, from 1 to 10. Examples of the aliphatic acyloxy group include acetoxy. The number of carbon atoms in the alkoxy group is, preferably, from 1 to 8. The alkoxy group may have substituent (for example, alkoxy group). Examples of the alkoxy group (including substituted alkoxy group) include methoxy, ethoxy, butoxy, and methoxyethoxy. The number of carbon atoms in the alkoxy carbonyl group is, preferably, from 2 to 10. Examples of the alkoxycarbonyl group include methoxycarbonyl and ethocycarbonyl. The number of carbon atoms in the alkoxycarbonyl group is, preferably, from 2 to 10. Examples of the alkoxycarbonyl amino group include methoxycarbonyl amino and ethoxycarbonyl amino.

The number of carbon atoms in the alkylthio group is, preferably, from 1 to 12. Examples of the alkylthio group include methylthio, ethylthio, and octylthio. The number of carbon atoms in the alkylsulfonyl group is, preferably, from 1 to 8. Examples of the alkylsulfonyl group include methane sulfonyl and ethane sulfonyl. The number of carbon atoms in the aliphatic amino group is, preferably, from 1 to 10. Examples of the aliphatic amide group include acetoamide. The number of carbon atoms in the aliphatic sulfone amide is, preferably, from 1 to 8. Examples of the aliphatic sulfone amide group include methane sulfone amide, butane sulfone amide, and n-octane sulfone amide. The number of carbon atoms in the aliphatic substituted amino group is, preferably, from 1 to 10. Examples of the aliphatic substituted amino group include dimethyl amino group, diethylamino, and 2-carboxyethylamino.

The number of carbon atoms in the aliphatic substituted carbamoyl group is, preferably, from 2 to 10. Examples of the aliphatic substituted carbamoyl group include methyl carbamoyl and diethyl carbamoyl. The number of carbon atoms in the aliphatic substituted sulfamoyl group is, preferably, from 1 to 8. Examples of the aliphatic substituted sulfamoyl group include methyl sulfamoyl and diethyl sulfamoyl. The number of carbon atoms in the aliphatic substituted ureido group is, preferably, from 2 to 10.

Examples of the aliphatic substituted ureido group include methyl ureido. Examples of the non-aromatic heterocyclic group include piperidino and morpholino. The molecular weight of the retardation developer is, preferably, from 300 to 800.

In the invention, a rod-like compound having a linear molecular structure in addition to the compound using the 1,3,5-triazine ring can also be used preferably. The linear molecular structure means that the molecular structure of the rod-like compound is linear in the thermodynamically most stable structure. The thermodynamically most stable structure can be determined by analysis for crystal structure or molecular orbit calculation. For example, a molecular structure in which the heat of formation of the compound becomes minimum can be determined by conducting molecular orbit calculation using a molecular orbit calculation software (for example, WinMOPAC2000, produced by Fujitsu Co). A linear molecular structure means that an angle constituted with the main chain in the molecular structure is 140 degree or more in a thermodynamically most stable structure obtained by calculation as described above.

As the rod-like compound having at least two aromatic rings, a compound represented by the following formula (2-IV) is preferred.

Ar¹-L¹-Ar² Formula (2-TV)

In the formula (2-IV) described above, Ar¹ and Ar² each represents independently an aromatic group. In the present specification, the aromatic group includes an aryl group (aromatic hydrocarbon group), substituted aryl group, aromatic heterocyclic ring, and substituted aromatic heterocyclic group. The aryl group and the substituted aryl group are preferred to the aromatic heterocyclic and the substituted aromatic heterocyclic group. The hetero ring in the aromatic heterocyclic group is generally unsaturated. The aromatic heterocyclic group is preferably a 5-membered ring, 6-membered ring, or 7-membered ring, the 5-membered ring or 6-membered ring being more preferred. The aromatic hetero ring generally has utmost double bonds. As the hetero atom, a nitrogen atom, oxygen atom, or sulfur atom is preferred, and the nitrogen atom or sulfur atom is more preferred. As the aromatic ring in the aromatic group, benzene ring, furan ring, thiophene ring, pyrrole ring, oxazole ring, thiazole ring, imidazole ring, triazole ring, pyridine ring, pyrimidine ring, and pyrazine ring are preferred, the benzene ring being particularly preferred.

In the formula (2-IV), L¹ is a bivalent connection group selected from an alkylene group, alkenylene group, alkynylene group, —O—, —CO— and a group comprising a combination thereof. The alkylene group may have a cyclic structure. The cyclic alkylene group is preferably cyclohexylene and 1,4-cyclohexylene is particularly preferred. As the chained alkylene group, a linear alkylene group is preferred to the branched alkylene group. The number of carbon atoms in the alkylene group is, preferably, from 1 to 20, more preferably, from 1 to 15, further preferably, from 1 to 10, furthermore preferably, from 1 to 8 and, most preferably, from 1 to 6.

The alkenylene group and the alkynylene group preferably have a chained structure than the cyclic structure, and, more preferably, have a linear structure than the branched structure. The number of the carbon atoms in the alkenylene group and the alkynylene group is, preferably, from 2 to 10, more preferably, from 2 to 8, further preferably, from 2 to 6, furthermore preferably, from 2 to 4 and, most preferably, 2 (vinylene or ethynylene). The number of carbon atoms in the arylene group is, preferably, from 6 to 20, preferably, from 6 to 16 and, more preferably, from 6 to 12. In the molecular structure of the formula (2-IV), the angle formed between Ar¹ and Ar² with L¹ being put therebetween is preferably 140° or more.

As the rod-like compound, a compound represented by the following formula (2-V) is more preferred.

Ar¹-L²-X-L³-Ar² Formula (2-V)

In the formula (2-V), Ar¹ and Ar² each represents independently an aromatic group. The definition and the examples for the aromatic group are identical with those for Ar¹ and Ar² in the formula (2-IV).

In the formula (2-V), L² and L³ each represents independently a bivalent connection group selected from the group consisting of alkylene group, —O—, —CO—, and a combination thereof. The alkylene group preferably has a chained structure than the cyclic structure and it is further preferably has a linear structure than the branched structure. The number of the carbon atoms in the alkylene group is, preferably, from 1 to 10, more preferably, from 1 to 8, further preferably, 1 to 6, furthermore preferably, 1 to 4 and, most preferably, 1 or 2 (methylene or ethylene). L² and L³ are particularly preferably —O—CO— or —CO—O—. In the formula (2-V), X is 1,4-cyclohexylene, vinylene, or ethynylene. Rod-like compounds having a maximum absorption wavelength (λmax) shorter than the wavelength of 250 nm in a UV-ray absorption spectrum of the solution may be used by two or more in combination.

The addition amount of the retardation developer is, preferably, from 0.1 to 30 mass parts and, more preferably, from 0.5 to 20 mass parts based on 100 mass parts of the cyclic polyolefin resin.

### (Solvent)

Then, the solvent for dissolving the cyclic olefin resin in the dope is to be described. As the solvent, an organic solvent is used preferably. In the invention, the organic solvent usable is not particularly restricted so long as the purpose can be attained to the extent that the cyclic olefin resin can be dissolved, cast, and formed into the film. The organic solvent used in the invention is preferably a solvent selected, for example, from chlorine type solvents such as dichloromethane and chloroform, chained hydrocarbons, cyclic hydrocarbons, aromatic hydrocarbon, esters, ketones and ethers of 3 to 12 carbon atoms. The ester, ketone or ether may also have a cyclic structure. Examples of the chained hydrocarbons of 3 to 12 carbon atoms include hexane, octane, isooctane, and decane. Examples of the cyclic hydrocarbons of 3 to 12 carbon atoms include cyclopentane, cyclohexane, decaline, and derivatives thereof. Examples of the aromatic hydrocarbons of 3 to 12 carbon atoms include benzene, toluene, and xylene. Examples of the esters of 3 to 12 carbon atoms include ethyl formate, propyl formate, pentyl formate, methyl acetate, ethyl acetate, and pentyl acetate. Examples of the ketones of 3 to 12 carbon atoms include acetone, methyl ethyl ketone, diethyl ketone, diisobutyl ketone, cyclopentanone, cyclohexanone, and methyl cyclohexanone. Examples of the ethers of 3 to 12 carbon atoms include diisopropyl ether, dimethoxy methane, dimethoxy ethane, 1,4-dioxane, 1,3-dioxolane, tetrahydrofuran, anisole, and phenetole. Examples of the organic solvents having two or more kinds of functional groups include 2-ethoxyethyl acetate, 2-methoxyethanol, and 2-butoxyethanol. For the organic solvent an organic solvent may be used alone, or two more kinds of organic solvents may be used being mixed at an optical ratio.

The amount of the solvent to be used is, preferably, from 250 to 600 mass parts and, more preferably, from 300 to 300 mass parts based on 100 mass parts of the cyclic olefin resin.

### (Preparation of Dope)

In the preparation method of the dope of the invention, the liquid dispersion of the fine particles and the cyclic olefin resin solution are mixed.

Preparation of the dope includes a method by dissolution under stirring at a room temperature, a cooling-dissolving method of stirring at a room temperature to swell a polymer, then cooling it from −20 to −100° C. and then dissolving the same by heating again to 20 to 100° C., a high temperature dissolving method of dissolving while elevating the temperature above the boiling point of a main solvent in a sealed vessel and, further, a method of dissolving by increasing the temperature and the pressure till the critical point of the solvent. A polymer of high solubility is preferably dissolved at a room temperature, whereas a polymer of poor solubility is dissolved under heating in a sealed vessel. For those having not so poor solubility, it is easy in view of the step to select a temperature as low as possible.

In the invention, the viscosity of the cyclic olefin resin solution is, preferably, within a range from 1 to 500 Pa·s at 25° C. More preferably, it is within a range from 5 to 200 Pa·s. The viscosity was measured as described below. 1 mL of a specimen solution was measured by using a Steel Cone of a diameter 4 cm/2° for a rheometer (CLS 500) (both manufactured by TA Instruments Co).

Measurement was started after previously keeping the temperature of the specimen solution to a constant liquid temperature for the measurement starting temperature.

The cyclic polyolefin solution has a feature capable of obtaining a dope at high concentration by properly selecting the solvent to be used, and a cyclic polyolefin solution at a high concentration and excellent in the stability can be obtained without relying on the means of concentration. For facilitating dissolution further, it may be dissolved at a low concentration and then concentrated by using concentration means. While method of concentration is not particularly restricted, concentration can be practiced, for example, by a method of introducing a solution at a low concentration between a cylindrical body and a rotational trace at the outer circumference of a rotary vane that rotates in the circumferential direction at the inside thereof, and providing a temperature difference relative to the solution, to evaporate the solvent thereby obtaining a solution at a high concentration (for example, in JP-A No. 4-259511), a method of blowing a heated solution at a low concentration from a nozzle into a vessel, flash-evaporating the solvent between the nozzle to a position hitting the solution on the inner wall of the vessel, extracting the solvent vapor from the vessel and extracting the solution at a high concentration from the bottom of the vessel (for example, in each of the specifications of U.S. Pat. Nos. 2,541,012, 2,858,229, 4,414,34, and 4,504,355), etc.

Undissolved matters and obstacles such as dusts and impurities are preferably removed by filtration from the dope before casting by using an appropriate filter material such as metal gauge or flannel. For the filtration of the cyclic polyolefin solution, a filter having an absolute filtration fineness of from 0.1 μm to 100 μm is used and a filter having an absolute filtration fineness of 0.5 μm to 25 μm is used more preferably. The thickness of the filter is, preferably, from 0.1 μm to 10 μm and, more preferably, from 0.2 mm to 2 mm. In this case, filtration is preferably conducted at a filtration pressure of 1.6 MPa or less, more preferably, 1.3 MPa or less, further preferably, 1.0 MPa or less and, particularly preferably, 0.6 MPa or less. As the filter material, known materials such as glass fibers, cellulose fibers, filter paper, and fluoro resins such as tetrafluoroethylene resin can be used preferably, and ceramics, metals, etc. are also used preferably.

The viscosity of the dope just before film formation may be within such a range that it can be cast upon film formation, which is controlled, preferably, within a range usually from 5 Pa·s to 1,000 Pa·s, more preferably, from 15 Pa·s to 500 Pa·s and, further preferably, from 30 Pa·s to 200 Pa·s. The temperature is not particularly restricted so long as it is a temperature upon casting and, preferably, from −5 to 70° C., and, more preferably, from −5 to 35° C.

### (Cyclic Olefin Resin Film)

Then, the cyclic olefin resin film of the invention is to be described.

The cyclic olefin resin film of the invention has a feature in that it is produced by a solution casting film formation method by using the dope prepared by the preparation method of the invention described above.

Since the composition of the cyclic olefin resin film of the invention is identical with the composition in the dope described above, the production method and the physical property of the film are to be described.

### (Film Formation)

The production method of the film using the cyclic olefin resin solution is to be described. For the method and the facility of producing the cyclic olefin resin film of the invention, a solution casting film formation method and a solution casting film formation apparatus identical with those used so far for the production of cellulose triacetate films are used. A dope (cyclic olefin resin solution) prepared from a dissolving apparatus (tank) is once stored in a storing tank and then prepared finally by removing foams contained in the dope. The dope is delivered from a dope discharging port, for example, through a pressurized metering gear pump capable of delivering s liquid under metering at a high accuracy, for example, depending on the number of rotation to a pressurized die. The dope is uniformly cast on a metal support in a casting unit running in an endless manner from a slit of the pressurized die, and a damp-dried dope film (also referred to as a web) is peeled from the metal support at a peeling point where the metal support runs for about one turn. The obtained web was put at both ends with clips, transported by a tenter and dried and, successively, transported by a group of rolls of a drying device to complete drying and then taken-up to a predetermined length by a winding machine. Combination of the tenter and the drying device of the roll group changes depending on the purpose. In a solution casting film formation method used for a functional protective film for use in electronic displays, a coating device is often attached for the surface fabrication of a film such as a subbing layer, an antistatic layer, an anti-halation layer, a protective layer, etc. in addition to the solution casting film formation apparatus. While each of the production steps is to be described briefly, they are not restrictive.

In a case of manufacturing a cyclic olefin resin film by a solvent cast method, it is preferred that the thus prepared cyclic olefin resin solution (dope) is at first cast, for example, on a metal drum or metal support (band or belt) to evaporate the solvent and form a film. The dope before casting is preferably controlled for the concentration such that the amount of the cyclic olefin resin is from 10 to 35 mass %. The surface of the drum or the band is preferably mirror-finished. The dope is preferably cast on the drum or the band at a surface temperature of 30° C. or lower and the temperature of the metal support is, particularly preferably, from −10 to 20° C.

Further, cellulose acylate film forming techniques described in each of the publications of JP-A Nos. 2000-301555, 2000-301558, 7-032391, 3-193316, 5-086212, 62-37113, 2-276507, 55-014201, 2-11511, and 2-208650 can be applied in the invention.

### (Stacked Casting)

The cyclic polyolefin solution may be cast as a single layered solution on a smooth band or drum as a metal support or two or more layers of cyclic polyolefin solutions may be cast.

In a case of casting a plurality of cyclic polyolefin solutions, solutions containing cyclic polyolefins may be cast respectively from a plurality of casting ports arranged each at an interval in the advancing direction of the metal support and a film may be prepared while laminating them, and methods described, for example, in each of the publications of JP-A. Nos. 61-158414, 1-122419, and 11-198285 can be adopted.

Further, cyclic polyolefin solutions may also be formed into a film by casting from two casting ports, which can be practiced by the method described in each of the publications of JP-B No. 60-27562, and JP-A Nos. 61-94724, 61-947245, 61-104813, 61-158413, and 6-134933. Further, a casting method for a cyclic polyolefin film described in JP-A 56-162617 of surrounding a stream of a cyclic polyolefin solution at high viscosity with a cyclic polyolefin solution at a low viscosity and simultaneously extruding the cyclic polyolefin solutions at high and low viscosities may also be used. Furthermore, it is also a preferred embodiment of incorporating an alcohol ingredient, which is a poor solvent, more in the outer solution than in the inner solution as described in each of the publications of JP-A No. 61-94724 and 61-94725. Alternatively, a film may also be prepared by using two casting ports, peeling a film formed from a first casting port to a metal support and conducting second casting on the side of the film in contact with the metal support surface, which is a method described, for example, in JP-B No. 44-20235. The cyclic polyolefin method may be an identical cyclic polyolefin solution, or different cyclic polyolefin solutions with no particular restriction. For providing functions to a plurality of cyclic polyolefin layers, cyclic polyolefin solutions in accordance with the functions may be extruded from respective casting ports. Further, other functional layers (for example, adhesive layer, dye layer, antistatic layer, anti-halation layer, matting agent layer, UV-absorbent layer, or polarizing layer) may also be cast simultaneously with the cyclic polyolefin solution.

In the single layered film, it is necessary to extrude a cyclic polyolefin solution at a high concentration and a high viscosity in order to obtain a necessary film thickness. In this case, the stability of the cyclic polyolefin is poor to form solids thereby causing grainy failure or poor planarity tending to result in problems. As a countermeasure, by casting a plurality of cyclic polyolefin solutions from a casting port, a solution at a high viscosity can be extruded on the metal support at the same time and the planarity can be improved to prepare a film of excellent surface property, as well as the drying load can be decreased by using a thick cyclic polyolefin solution and the film production speed can be increased.

In a case of co-casting, while the thickness of the inner side and the outer side is not particularly restricted, the outer side is preferably from 1 to 50% and, more preferably, 2 to 30% thickness based on the entire film thickness. In a case of co-casting three or more layers, the total film thickness of the layer in contact with the metal surface and the layer in contact with air is defined as a thickness of the outer side. In a case of co-casting, a cyclic polyolefin film of a laminate structure can be produced by co-casting cyclic polyolefin solutions having different concentrations of the additives described above. For example, a cyclic polyolefin film of such a constitution as skin layer/core layer/skin layer can be prepared. For example, the fine particles can be incorporated at a higher content in the skin layer or only in the skin layer. The anti-aging agent or the UV-absorbent can be incorporated at a higher content in the core layer than in the skin layer, or may be incorporated only in the core layer. Further, the kinds of the aging inhibitor and the UV-absorbent can be changed between the core layer and the skin layer. For example, a less volatile aging inhibitor and/or a UV-ray absorbent may be incorporated in the skin layer and a plasticizer excellent in the plasticity, or a UV-absorbent excellent in the UV-absorbancy can also be added to the core layer. Further, it is also preferred to incorporate a peeling accelerator only in the skin layer on the side of the metal support Further, for gelling the solution by cooling the metal support in the cooling drum method, it is also preferred to add the alcohol as a poor solvent more in the skin layer than in the core layer. Tg may be different between the skin layer and the core layer and it is preferred that Tg of the skin layer is lower than Tg of the core layer. Further, the viscosity of the solution containing the cyclic polyolefin during casting may also be different between the skin layer and the core layer. While it is preferred that the viscosity of the skin layer is lower than the viscosity of the core layer, the viscosity of the core layer may be lower than the viscosity of the skin layer

### (Casting)

The casting method for the solution includes a method of uniformly extruding a prepared dope from a pressurized die to a metal support, a method by a doctor blade of controlling the thickness of the dope once cast on a metal support by a blade, or a method by a reverse roll coater of controlling the thickness by a roll that rotates in an opposite direction, the method by the pressurized die being preferred. The pressurized die includes a coat hunger type or T-die type, each of which can be used preferably. Further, in addition to the methods described herein, casting can be practiced by various methods of casting cellulose triacetate solutions to form films known so far and the effects identical with the contents described in respective publications can be obtained by setting each of the conditions while considering the difference of the boiling points of solvents used, etc. As the metal support that runs in an endless manner used for the manufacture of the cyclic polyolefin film of the invention, a drum mirror-finished at the surface by chromium plating, or a stainless steel belt (may also be referred to as a band) mirror-finished at the surface by polishing can be used. The pressurized die used for the manufacture of the cyclic polyolefin of the invention may be disposed by one or more above the metal support. Preferably, it is disposed by the number of 1 or 2. In a case of providing the supports by 2 or more, the amount of dope to be cast may be divided into various ratios to respective dies, and the dope may be delivered to the dies from a plurality of precision metering gear pump at each of the ratios. The temperature of the cyclic polyolefin solution used for the casting is, preferably, from −10 to 55° C. and, more preferably, from 25 to 50° C. In this case, the temperature may be identical throughout the step, or may be different at each of the positions in the step. In a case where the temperature is different, it may suffice that the temperature is at a desired temperature just before casting.

### (Drying)

Drying of the dope on the metal support concerned with the manufacture of the cyclic polyolefin film includes generally a method of applying a hot blow on the side of the surface of a metal support (for example, drum or band), that is, from the surface of the web on the metal support, a method of applying a hot blow on the rear face of the drum or the band, liquid heat conduction a method of bringing a liquid controlled for the temperature in contact with the rear face, that is, on the side opposite to the dope casting surface of the band or the drum and heating the drum or the band by heat conduction thereby controlling the surface temperature, with the rear face liquid heat conduction system being preferred. The surface temperature of the metal support before casting may be at any level so long as it is lower than the boiling point of the solvent used for the dope, However, for promoting drying or eliminating the fluidity of the metal support, it is preferred to set a temperature lower by 1 to 10° C. than the boiling point of the solvent having the lowest boiling point among the solvents used. This is not applied to a case of cooling the cast dope and peeling off the same without drying.

### (Peeling)

In a case where a damp-dried film is peeled off from the metal support, when the peeling resistance (peeling load) is large, the film is stretched irregularly in the direction of film formation to cause unevenness in the optical anisotropy. Particularly in a case where the peeling load is large, stretched portions stepwise and not stretched portions are formed stepwise alternately in the direction of the film formation to result in distribution in the retardation. When the film is loaded in the liquid crystal display device, linear or streaky unevenness is observed. In order to avoid the occurrence of such a problem, it is preferred that the peeling load of the film is 0.25N or less per 1 cm of film peeling width. The peeling load is, more preferably, 0.2N/cm or less, further preferably, 0.15N or less and, particularly preferably, 0.10N or less. In a case where the peeling load is 0.2 N/cm or less, unevenness attributable to peeling is not recognized at all even in a liquid crystal display device tending to develop unevenness, which is particularly preferred. The method of decreasing the peeling load includes a method of adding a peeling agent as described above, or a method of selecting the composition of the solvent to be used.

The peeling load is measured as described below. A dope is dripped on a metal plate having the same material and surface roughness as those of the metal support in the film formation apparatus and cast to uniform thickness by using a doctor blade and dried. Recesses each of an equivalent width are cut into the film by a cutter knife, the top end of the film is peeled by fingers and sandwiched by a clip in connection with a strain gage and the change of load is measured while pulling-up the strain gage in the oblique direction at 45° Volatile component in the peeled film is also measured. Identical measurement is conducted for several times while varying the drying time, and a peeling load is defined when the residual volatile component upon peeling is identical with that in the actual film formation step. The peeling load tends to increase as the feeling speed increases, and it is preferred to measure the peeling load at a peeling speed approximate to an actual case.

A preferred concentration of the residual component during peeling is from 5 mass % to 60 mass %. 10 mass % to 50 mass % is more preferred and from 20 mass % to 40 mass % is particularly preferred. Peeling at a high volatile component is preferred since the drying speed can be increased to improve the productivity. On the other hand, at high volatile component, the strength and the elasticity of the film are small and the film is cut or elongated being not endurable to the peeling force. Further, self-retainability after peeling is poor tending to suffer from deformation, creases and cracks. Further, this causes occurrence of distribution in the retardation.

### (Stretching)

In a case of applying a stretching treatment to a cyclic polyolefin film of the invention, it is preferably conducted in a state just after peeling in which a solvent still remains sufficiently in the film. Stretching is conducted with an aim of (1) obtaining a film excellent in the planarity, with no crease or deformation and (2) increasing the in-plane retardation of the film. In a case of applying stretching with the aim for (1), stretching is conducted at a relatively high temperature and stretching is conducted also at a low stretching factor from 1% to 10% at the highest. Stretching at a factor of from 2% to 5% is particularly preferred. In a case of conducting stretching with the aims both for (1) and (2), or with the aim only for (2), stretching is conducted at a relatively low temperature and also at a stretching factor of from 5% to 150%.

Film stretching may be monoaxial stretching only for longitudinal or lateral direction, or simultaneous or sequential biaxial stretching. For the birefringence of an optically-compensatory film for use in VA liquid crystal cell or OCB liquid crystal cell, it is preferred that the refractive index in the width direction is larger than the refractive index in the longitudinal direction. Accordingly, it is preferred to apply stretching more in the width direction.

### (Post Drying)

Preferably, the cyclic olefin resin film is further dried after stretching and taken-up at a residual volatile component of 2% or less. Before take-up, knurling is preferably applied to both ends. The width for the knurling is, preferably, from 3 mm to 50 mm, more preferably, from 5 mm to 30 mm, and the height is, preferably, from 1 to 50 μm, more preferably, from 2 to 20 μm and, further preferably, 3 to 10 μm. It may be applied either by one side pressing or both side pressing.

The thickness of a cyclic olefin resin film in the finished state (after drying) of the invention, while different depending on the purpose of use, is usually within a range from 20 to 500 μm, preferably, within a range from 30 to 150 μm and, particularly preferably, from 40 to 110 μm for use in liquid crystal display devices.

For the control of the film thickness, a concentration of solids contained in a dope, a slit gap of a spinneret of a die, an extruding pressure from the die, a speed of a metal support, etc. may be controlled so as to provide a desired thickness. The width of the cyclic olefin resin film obtained as described above is, preferably, from 0.5 m to 3 m, more preferably, from 0.6 m to 2.5 m and, further preferably, from 0.8 m to 2.2 m. For the length, it is taken-up by a length of, preferably, from 100 m to 10,000 m, more preferably, from 500 m to 7000 m and, further preferably, from 1,000 to 6,000 m per one roll. Upon taking-up the film, it is preferred to provide knurling on at least one side, and the width thereof is from 3 mm to 50 mm and, more preferably, from 5 m to 30 mm, and the height is, preferably, from 0.5 to 500 μm and, more preferably, 1 to 200 μm. This may be applied as one side or both side pressing. Variation of the Re value for the entire width is preferably ±5 nm and, more preferably, ±3 nm. Further, variation of the Rth value is, preferably, ±10 nm and, more preferably, ±5 nm. Further, it is also preferred that the variation of the Re value and the Rth value in the longitudinal direction is within the range of the variation in the width direction. Haze is preferably from 0.01 to 2% for keeping the feeling of transparency.

### (Optical Characteristics of Cyclic Olefin Resin Film)

Preferred optical characteristics of the cyclic olefin resin film of the invention are different depending on the application use of the film. In a case of the application use for the polarizing plate protective film, the in-plane retardation (Re) is, preferably, 5 nm or less and, more preferably, 3 nm or less. Also, the retardation in the thickness direction (Rth) is, preferably, 50 nm or less, more preferably, 35 nm or less and, particularly preferably, 10 nm or less.

### [Retardation, Re, Rth]

In the present specification, Re and Rth represent, respectively, the in-plane retardation and the retardation in the thickness direction at a wavelength λ. Re is measured by incidence of a light at a wavelength of λ nm in the normal direction to the film in KOBRA 21ADH (manufactured by Oji Scientific Instruments). Rth is calculated by KOBRA 21ADH based on retardation values measured in the three directions, i.e., of Re described above, a retardation value measured by incidence of a light at a wavelength λ nm in the direction inclined by +40° relative to the normal direction to the film with the in-plane retardation phase axis (judged by KOBRA. 21ADH) being as an axis of inclination (axis of rotation), and a retardation value measured by incidence of a light at a wavelength λ nm in the direction inclined by −40° relative to the normal direction to the film with the in-plane retardation phase axis being as an axis of inclination (axis of rotation). In this case, for the assumed value of an average refractive index, values described in Polymer Handbook (JOHM WILEY & SONS, INC) and various catalogs for optical films can be used. Those for which the values of the average refractive index are not known can be measured by Abbe's refractometer. KOBRA 21ADH calculates nx, ny, nz by inputting the assumed value for the average refractive index and the film thickness. The measuring wavelength is 590 nm in the present specification unless otherwise specified

### <Polarizing Plate>

Then, the polarizing plate of the invention is to be described.

The polarizing plate of the invention has a polarizer and two transparent protective films disposed on both sides thereof in which at least one of the protective films is a cyclic olefin resin film of the invention.

The polarizing plate usually has a polarizer and two transparent protective film disposed on both sides thereof.

The cyclic olefin resin film of the invention is used as one or both of the protective films. A usual cellulose acetate film, etc. may also be used as the other protective film. The polarizer includes an iodine type polarizer, a dye type polarizer or a polyene type polarizer using a dichroic dye. The iodine type polarizer and the dye type polarizer are generally prepared by using a polyvinyl alcohol type film.

In a case of using the cyclic polyolefin film of the invention as the protective film for use in polarizing plate, it is preferred that a surface treatment is applied as will be described later to the film and then the treated film surface and the polarizer are bonded by using an adhesive. The polarizing plate comprises a polarizer and protective films for protecting both surfaces thereof and, further, comprises a protective film bonded on one surface and a separate film bonded on the opposite surface of the polarizing plate. The protective film and the separate film are used with an aim of protecting the polarizing plate upon shipping the polarizing plate, upon inspection of products, etc. In this case, the protect film is bonded with an aim of protecting the surface of the polarizing plate and used on the side opposite to the surface of bonding the polarizing plate to a liquid crystal plate. Further, the separate film is used with an aim of covering the adhesive layer to be bonded to the liquid crystal plate and used on the side of the surface of bonding the polarizing plate to the liquid crystal plate.

As a method of bonding the cyclic olefin resin film of the invention to the polarizer, it is preferred to bond the film so as to align the axis of transmission of the polarizer with the retardation phase axis of the cyclic olefin resin film according to the invention. When a polarizing plate produced under the Crosses Nichol state of the polarizing plate was evaluated, it has been found that in a case where the crossing accuracy between the retardation phase axis of the cyclic olefin resin film of the invention and an absorption axis of the polarizer (axis crossing the axis of transmission) is greater than 1°, the performance of the polarization degree of the polarizing plate under Crosses Nichol state is lowered to cause light leakage. In this case, no sufficient black level and contrast can be obtained when it is combined with a liquid crystal cell. Accordingly, the deviation between the direction of a main refractive index nx of the cyclic olefin resin film of the invention and the direction of the axis of transmission of the polarizing plate is preferably within 1° and, more preferably, within 0.5°.

For the measurement of simplex transmittance TT, parallel transmittance PT, and cross transmittance CT of the polarizing plate, UV 3100 PC (produced by Shimazu Seisakusho Co.) can be used. In the measurement, they are measured within a range from 380 nm to 780 nm, and an average value of measurement for 10 times can be used for each of simplex, parallel, and cross transmittance.

A durable test for the polarizing plate can be conducted by two kinds of forms, that is, (1) only for the polarizing plate and (2) for the polarizing plate bonded by way of an adhesive to glass as described below. Measurement only for the polarizing plate is conducted by combining an optically-compensatory film so as to be sandwiched between two polarizers in a crossed state and using two identical sets. For the glass-bonded form, a sample in which a polarizing plate bonded on glass such that the optically-compensatory film is on the side of the glass (5 cm×5 cm) is prepared by the number of two. In the simplex transmission measurement, the sample is measured by setting the sample with the side of the film directed to a light source. Two samples are measured respectively and an average value for them is defined as the simplex transmittance. Preferred ranges for the polarizing performance in the order of simplex transmittance TT, parallel transmittance PT, and cross transmittance CT are: as 40.5≦TT≦45, 32≦PT≦39.5, and CT≦1.5, respectively. More preferred ranges are: 41.0≦TT≦44.5, 34≦PT≦39.0, and CT≦1.3. In the durability test of the polarizing plate, it is preferred that the amount of change is smaller.

### (Surface Treatment of Cyclic Polyolefin Film)

In the protective film for use in polarizing plate of the invention, it is preferred to apply a surface treatment to the surface of a cyclic polyolefin film for improving the adhesion with a polarizer. While any method may be utilized for the surface treatment so long as the adhesion is improved, a preferred surface treatment includes, for example, glow discharging treatment, UV-light radiation treatment, corona treatment, and flame treatment. The glow discharging treatment referred to herein is a so-called low temperature plasma that occurs in a low pressure gas. In the invention, a plasma treatment at an atmospheric pressure is also preferred. Further, details of the glow discharging treatment are described in the specifications of U.S. Pat. Nos. 3,462,335, 3,761,299, and 4,072,769, and BP No. 891469. A method described in JP-A No. 59-556430 in which a gas composition of the discharging atmosphere comprises only the gas species generated in a vessel from a polyester support per se that undergoes the discharging treatment is also used. Further, a method described in JP-B No. 60-16614 of conducting a discharging treatment with the surface temperature of the film at 80° C. or higher and 180° C. or lower upon vacuum glow discharging treatment can also be applied.

The vacuum degree during glow discharging treatment is, preferably, from 0.5 Pa to 3,000 Pa and, more preferably, from 2 Pa to 300 Pa. Further, the voltage is preferably between 500 V and 5,000 V and, more preferably, between 500 V to 3,000 V. The discharging frequency used ranges from DC current to several thousands MHz, more preferably, from 50 Hz to 20 MHz and, further preferably, from 1 KHz to 1 MHz. The intensity of the discharging treatment is from 0.01 KV·A·min/m² to 5 KV·A·min/m² and, further preferably, from 0.15 KV·A·min/m² to 1 KV·A·min/m².

In the invention, UV light irradiation method is also conducted preferably as the surface treatment. This can be conducted by the treating method described, for example, in each of the publications of JP-B Nos. 43-2603, 43-2604, and 45-3828 A mercury lamp is preferably a high pressure mercury lamp comprising a quartz tube having a wavelength of UV-light from 180 to 380 nm. For the method of UV-light irradiation, a high pressure mercury lamp having a main wavelength at 365 nm can be used as a light source so long as increase in the surface temperature of the protective film to about 150° C. results in no problem for the support in view of the performance. In a case where a low temperature treatment is necessary, a low pressure mercury lamp at a main wavelength of 254 nm is preferred. Further, ozone less type high pressure mercury lamp and low pressure mercury lamp can also be used. For the amount of light for treatment, while adhesion between a polymer resin film containing a thermoplastic saturated cycloaliphatic structure and a polarizer is improved more as the amount of light for the treatment increases, increase in the amount of light result in a problem that the film is colored and embrittled. Accordingly, in the high pressure mercury lamp having a main wavelength at 365 nm, the amount of irradiation light is, preferably, from 20 mJ/cm² to 10,000 mJ/cm² and, more preferably, 50 mJ/cm² to 2,000 mJ/cm². In a case of a low pressure mercury lamp having a main wavelength at 254 nm, the amount of irradiation light is, preferably, from 100 mJ/cm² to 10,000 mJ/cm² and, more preferably, from 300 mJ/cm² to 1,500 mJ/cm².

Further, in the invention, it is also preferred to conduct a corona discharging treatment as a surface treatment For example, this can be conducted by the treating method described in each of the publications of JP-B No. 39-12838, and JP-A Nos. 47-19824, 48-28067, and 52-42114. As the corona discharging treatment apparatus, a solid state corona discharging machines LEPEL type surface treatment machine, VETAPHON type treating machine, etc. produced by Pillar Co. can be used. The treatment can be conducted at a normal pressure in the air. The discharging frequency upon treatment is from 5 KV to 40 KV and, more preferably, from 10 KV to 30 KV, and the waveform is, preferably, an AC sinusoidal wave. A gap (clearance) between an electrode and a dielectric roll is from 0.1 mm to 10 mm and, more preferably, 1.0 mm 2.0 mm, Discharging treatment is conducted above a dielectric support roller located in a discharging region, and the amount of treatment is from 0.3 KV·A·min/m² to 0.4 KV·A·min/m² and, more preferably, from 0.34 KV·A·min/m² to 0.38 KV·A·min/m².

In the invention, it is also preferred to conduct a flame treatment as the surface treatment. While a gas to be used may be any of natural gas, liquefied propane gas, or city gas. A mixing ratio with air is important, because it is considered that the effect of the surface treatment by the flame treatment is provided by plasmas including active oxygen. The plasma activity (temperature) and the existent amount of oxygen which are important nature of flame are critical point. A predominant factor of the point is a gas/oxygen ratio, and the energy becomes highest and the plasma activity increases in a case where they take place reaction in a just appropriate proportion. Specifically, a desirable mixing ratio by volume for natural gas/air is from 1/6 to 1/10 and, preferably, from 1/7 to 1/9. Further, in a case of liquefied propane gas/air, it is from 1/14 to 1/22 and, preferably, from 1/16 to 1/19. In a case of city gas/air, it is from 1/2 to 1/8 and, preferably, from 1/3 to 1/7. Further, the flame treatment is conducted, preferably, within a range from 1 Kcal/m² to 50 Kcal/m² and, more preferably, from 3 Kcal/m² to 20 Kcal/m². Further, the distance from the top end of the inner flame of a burner and a film is, preferably, from 3 cm to 7 cm and, more preferably, from 4 cm to 6 cm. For the nozzle shape of a burner, a ribbon type of Flin Burner Co. (USA), multi-hole type of Wise Co. (USA), ribbon type Aerogen (England) and zig-zag multi-hole type of Kasuga Electric Works Ltd. (Japan) and a zig-zag multi-hole type of Koike Sanso Kogyo Co., Ltd. (Japan) are preferred. A back-up roll supporting the film during the flame treatment is a hollow roll and treatment is preferably conducted under water cooling by passing cooling water always at a constant temperature of from 20° C. to 50° C.

For the degree of the surface treatment, while a preferred range is different depending on the kind of the surface treatment and the kind of the cyclic polyolefin, it is preferred that the angle of contact between the surface of a protective film applied with the surface treatment and pure water is less than 50° as a result of the surface treatment. The angle of contact is, more preferably, 25° or more and less than 45°. In a case where the angle of contact between the surface of the protective film and pure water is within the range described above, a bonding strength between the protective film and the polarizing film is improved.

### (Adhesive)

Upon bonding a polarizer comprising a polyvinyl alcohol type film and a surface treated cyclic polyolefin film as the protective film for use in polarizing plate, use of an adhesive containing a water soluble polymer is preferred. A water soluble polymer used preferably for the adhesive includes homopolymers or copolymers having, as constituent elements, ethylenically unsaturated monomers such as N-vinyl pyrrolidone, acrylic acid, methacrylic acid, maleic acid, β-hydroxyethyl acrylate, β-hydroxyethyl methacrylate, vinyl alcohol, methyl vinyl ether, vinyl acetate, acryl amide, methacryl amide, diacetone acrylamide, and vinyl imidazole, and polyoxylethylene, polyoxypropylene, poly-2-methyloxazoline, methyl cellulose, hydroxyethyl cellulose, and hydroxypropyl cellulose gelatin. In the invention, PVA and gelatin are preferred among them,

Preferred PVA characteristic in a case of using PVA as the adhesive are to be described below. PVA is usually formed by saponifying polyvinyl acetate and it may also contain ingredients copolymerizable with vinyl acetate such as unsaturated carboxylic acids, unsaturated sulfonic acids, olefins, and vinyl ethers. Further, modified PVA containing acetoacetyl group, sulfonic acid group, carboxylic group and oxyalkylene group can also be used. While the saponification degree of PVA is not particularly restricted, it is preferably from 80 to 100 mol % and, particularly preferably, from 90 to 100 mol % in view of the solubility, polarizability, heat resistance, humidity resistance, etc. Further, while the polymerization degree of PVA is not particularly restricted, it is preferably from 1,000 to 10,000 and, particularly preferably from 1,500 to 5,000 in view of the strength, heat resistance, humidity resistance and stretchability of the film. Further, syndiotacticity of PVA is not also restricted particularly but may be of an optional value in accordance with the purpose.

In a case of using PVA as the adhesive in the invention, it is preferred to further use a crosslinker in combination. The crosslinker used preferably in combination in a case of using PVA as the adhesive includes boric acid, polyvalent aldehydes, polyfunctional isocyanate compounds and polyfunctional epoxy compounds, with boric acid being particularly preferred in the invention.

In a case of using the gelatin for the adhesive, so-called lime-treated gelatin, acid-treated gelatin, enzyme-treated gelatin, gelatin derivatives, modified gelatin, etc. can be used. Among the gelatins, those used preferably are lime-treated gelatin and acid-treated gelatin. The crosslinker used preferably in combination in a case of using the gelatin as the adhesive includes active halogenated compounds (2,4-dochloro-6-hydroxy-1,3,5-triazine, sodium salts thereof, etc.), and active vinyl compounds (1,3-bisvinyl sulfonyl-2-propanol, 1,2-bisvinyl sulfonylacetamide)ethane, bis(vinylsulfonyl methyl)ether, vinylic polymers having vinyl sulfonyl groups on the side chain, etc.), N-carbamoyl pyridinium salts ((1-morpholinocarbonyl-3-pyridinio)methane sulfonate, etc.), and haloamidinium salts (1-(1-chloro-1-pyridinomethyrele)pyrrolidinium-2-naphthalene sulfonate, etc.). In the invention, active halogen compounds and active vinyl compounds are used particularly preferably.

A preferred addition amount of the crosslinker in a case of using the crosslinker described above in combination is 0.1 mass parts or more and less than 40 mass parts and, more preferably, 0.5 mass parts or more and less than 30 mass parts based on the water-soluble polymer in the adhesive. It is preferred to conduct bonding by coating an adhesive on the surface of at least one of the protective film and the polarizer thereby forming an adhesive layer, and it is preferred to coat an adhesive on the surface of the protective film to be treated to form an adhesive layer and bond the same to the surface of the polarizer. The thickness of the adhesive layer after drying is preferably from 0.01 μm to 5 μm and, particularly preferably, from 0.05 μm to 3 μm.

### (Anti-Reflection Layer)

It is preferred to dispose a functional layer such as an anti-reflection layer to a transparent protective film disposed to a polarizing plate on the side opposite to the liquid crystal cell. Particularly, in the invention, an anti-reflection layer formed by laminating at least a light scattering layer and a low refractive index layer in this order on a transparent protective film, or an anti-reflection layer formed by laminating a medium refractive index layer, a high reflective index layer, and a low refractive index layer in this order on the transparent protective film is used preferably. That is, as a transparent support to which the anti-reflection layer is laminated, a transparent protective film is used preferably. Preferred examples thereof are to be described below.

Preferred examples of an anti-reflection layer in which a light scattering layer and a low refractive index layer are disposed on a transparent protective film are to be described. Matte particles are preferably dispersed in the light scattering layer. The light scattering layer may also have both anti-dazzling property and hard coatability and it may be a single layer or plural layers, for example, comprising 2 to 4 layers.

By designing the surface unevenness shape of the anti-reflection layer such that a center line average roughness Ra is from 0.08 to 0.40 μm, a 10 point average roughness Rz is 10 times or less of Ra, an average top to bottom distance Sm is from 1 to 100 μm, a standard deviation for the height of a protrusion from the deepest portion of the unevenness is 0.5 μm or less, a standard deviation for the average top to bottom distance Sm of the unevenness is 20 μm or less, and the surface with an angle of inclination of 0 to 5° occupies 10% or more, a sufficient anti-dazzling property and a uniform feeling of matt under visual observation are attained preferably.

Further, in a case where the tint of a reflection light under a C-light source is such that a* value is −2 to 2 and b* value is −3 to 3 and the ratio between the minimum value and the maximum value of the reflectivity within a range from 380 nm to 780 nm is from 0.5 to 0.99, the tint of the reflection light becomes neutral preferably. Further, in a case where b* value of the transmission light under a C-light source is from 0 to 3, yellowish tint in white indication is decreased preferably when applied to a display device.

Further, in a case when the standard deviation of the lightness distribution is 20 or less upon measuring the brightness distribution on a film by inserting 120 μm×140 μm lattice between a surface light source and an anti-reflection layer, glare is decreased preferably upon applying the film of the invention to a highly fine panel.

It is preferred that optical characteristics of the anti-reflection layer are such that the mirror phase reflectivity is 25% or less, transmittance is 90% or more and 60° glossiness is 70% or less, since the reflection of external light can be suppressed and the viewability is improved. Particularly, the mirror phase reflectivity is, more preferably, 1% or less and, most preferably, 0.5% or less. Prevention of glare, suppression of blur in characters, etc. on a highly fine LCD particle can be attained preferably by controlling the haze to 20% to 50%, the internal haze/entire phase value (ratio) to 0.3 to 1, lowering of the haze value from the haze value as far as the light scattering layer to the haze value after forming the low refractive index layer to 15% or less, clearness of transmission images at 0.5 mm comb-width to 20% to 50%, and the transmittance ratio of the transmission light: vertical direction/direction included by 2° from verticality to 1.5 to 5.5.

### (Low Refractive Index Layer)

The reflective index of the low refractive index layer in the anti-reflection layer is within a range, preferably, from 1.20 to 1.49 and, more preferably, from 1.30 to 1.44. Further, it is preferred that the low refractive index layer satisfies the following equation (IX) in view of lowering the reflectivity:

(m/4)×0.7<n1d1<(m/4)×1.3 (IX)

in which m is a positive odd number, n1 is a refractive index of the low refractive index layer, and d1 is a film thickness (nm) of the low reflective index layer. λ is a wavelength which is a value within a range from 500 nm to 550 nm.

Materials forming the low refractive index layer are to be described below.

The low refractive index layer preferably contains a fluorine-containing polymer as a low refractive index binder As the fluoro-polymer, a fluorine-containing polymer crosslinked by heating or ionic radiation rays, and having a dynamic friction efficient of from 0.03 to 0.20, an angle of contact with water of 90° to 120°, and a falling angle to pure water of 70° or less is preferred. When the anti-reflection film is mounted to an image display device, it is preferred that the peeling strength relative to a commercially available adhesive tape is lower since a seal or memo pad is peeled more easily after bonding, and the peeling strength is, preferably, 500 gf or less, more preferably, 300 gf or less and, most preferably, 100 gf or less. Further, it is less scratched as the surface hardness measured by micro hardness gage is higher, and it is, preferably, 0.3 GPa or more and, more preferably, 0.5 GPa or more

The fluorine-containing polymer used for the low refractive index layer includes of hydrolyzates or dehydration condensates perfluoroalkyl group-containing silane compounds, for example (for example, (heptadecafluoro-1,1,2,2-tetrahydrodecyl)triethoxy silane), as well as fluorine-containing copolymers comprising, as constituent ingredients, fluorine-containing monomer units and constituent units for providing crosslinking reactivity.

Specific examples of the fluorine-containing monomer include, for example, fluoro-olefins (for example, fluoroethylene, vinylidene fluoride, tetrafluoroethylene, perfluorooctylethylene, hexafluoropropylene, perfluoro-2,2-dimethyl-1,3-dioxol, etc.), partially or completely fluorinated alkyl ester derivatives of (meth)acrylic acids (for example, Biscoat 6FM (produced by Osaka Yuki Kagaku) or M-2020 (produced by Daikin Co., etc)), and completely or partly fluorinated vinyl ethers. Perfluoro-olefins are preferred and hexafluoropropylene is particularly preferred with a view point of the refractive index, solubility, transparency, availability, etc.

The constituent unit for providing the crosslinking reactivity includes those constituent units obtained by polymerization of monomers previously having self-crosslinkable functional group in the molecule such as glycidyl(meth)acrylate and glycidyl vinyl ether, constituent units obtained by polymerization of monomers having carboxyl group, hydroxyl group, amino group, or sulfo group (for example, (meth)acrylic acid, methylol(meth)acrylate, hydroxylalkyl(meth)acrylate, allyl acrylate, hydroxyethyl vinyl ether, hydroxybutyl vinyl ether, maleic acid, and crotonic acid), and constituent units formed by introducing crosslinkable groups such as (meth)acryloyl groups by polymeric reaction to the constituent units described above (they can be introduced, for example, by a method of acting acrylic acid chloride to the hydroxyl group).

The fluorine-containing polymer used for the low refractive index layer includes perfluoroalkyl group-containing silane compounds, for example, hydrolyzates or dehydrating condensates, for example, of (heptadecafluoro-1,1,2,2-tetrahydrodecyl)triethoxy silane, as well as fluorine-containing copolymers comprising, as constituent ingredients, fluorine-containing monomer units and constituent units for providing crosslinking reactivity.

Specific example of the fluorine-containing monomer includes, for example, fluoroolefins (for example, fluoroethylene, vinylidene fluoride, tetrafluoroethylene, perfluorooctylethlene, hexafluoropropylene, perfluoro-2,2-dimethyl-1,3-dioxol, etc.), partially or completely fluorinated alkyl ester derivatives of (meth)acrylic acids, for example, Biscoat 6FM (produced by Osaka Yuki Kagaku) or M-2020 (produced by Daikin Co., etc), completely or partly fluorinated vinyl ethers. Perfluoro olefins are preferred and hexafluoropropylene is particularly preferred with a view point of refractive index, solubility, transparency, availability, etc.

The constituent unit for providing the crosslinking reactivity includes those constituent units obtained by polymerization of monomers previously having self-crosslinking functional group in the molecule such as glycidyl(meth)acrylate and glycidyl vinyl ether, constituent units obtained by polymerization of monomers having carboxyl group, hydroxyl group, amino group, or sulfo group ((meth)acrylic acid, methylol(meth)acrylate, hydroxylalkyl(meth)acrylate, allyl acrylate, hydroxyethyl vinyl ether, hydroxybutyl vinyl ether, maleic acid, crotonic acid, etc.), constituent units formed by introducing crosslinkable groups such as (meth)acryloyl groups by polymeric reaction to the constituent units described above (they can be introduced, for example, by a method of acting acrylic acid chloride to the hydroxyl group).

In addition to the fluorine-containing monomer units and the constituents unit for providing the crosslinking reactive group described above, monomers not containing fluorine atom may properly be copolymerized with a view point of solubility to a solvent, transparency of a film, etc. The monomer units that can be used in combination have no particular restriction and include, for example, olefins (ethylene, propylene, isoprene, vinyl chloride, vinylidene chloride, etc.), acrylate esters (methyl acrylate, methyl acrylate, ethyl acrylate, 2-ethylhexyl acrylate), methacrylate esters (methyl methacrylate, ethyl methacrylate, butyl methacrylate, ethylene glycol dimethacrylate, etc.), styrene derivatives (styrene, divinyl benzene, vinyl toluene, α-methyl styrene, etc.), vinyl ethers (methyl vinyl ether, ethyl vinyl ether, cyclohexyl vinyl ether, etc.), vinyl esters (vinyl acetate, vinyl propionate, vinyl succinate, etc.), acryl amides (N-tert-butyl acryl amide, N-cyclohexyl acryl amide, etc.), methacrylamides, acrylonitrile derivatives. For the polymer described above, a hardening agent may also be used properly in combination as described in each of the publications of JP-A Nos. 10-25388 and 10-147739.

### (Light Scattering Layer)

A light scattering layer is formed for providing a film with a light scattering property due to surface scattering and/or internal scattering, and hard coatability for improving the scratch resistance of the film. Accordingly, the scattering layer is formed by incorporation of a binder for providing the hard coatability, matt particles for providing the light scattering property and, optionally, an inorganic filler for increasing the refractive index, preventing crosslinking shrinkage and improving the strength. The thickness of the light scattering layer is, preferably, from 1 μm to 10 μm and, more preferably, from 1.2 μm to 6 μm with a view point of providing the hard coatability and a view point of suppressing the occurrence of curl and worsening of brittleness.

The binder for the scattering layer is preferably a polymer having a saturated hydrocarbon chain or a polyether chain as the main chain and, more preferably, a polymer having an unsaturated hydrocarbon chain as the main chain. Further, the binder polymer preferably has a crosslinked structure. As the binder polymer having the saturated hydrocarbon chain as the main chain, polymers of ethylenically unsaturated monomers are preferred. As the binder polymer having the saturated hydrocarbon chain as the main chain and has the crosslinked structure, copolymers of monomers having two or more ethylenically unsaturated groups are preferred. For making the binder polymer highly refractive, those containing an aromatic ring or at least one atom selected from halogen atom other than chlorine, sulfur atom, phosphorus atom, and nitrogen atom in the structure of the monomer can be selected.

The monomers having two or more ethylenically unsaturated groups include esters of polyhydric alcohols and (meth)acrylic acid (for example, ethylene glycol di(meth)acrylate, budanediol di(meth)acrylate, hexanediol di(meth)acrylate, 1,4-cyclohexane diacrylate, pentaerythritol tetra(meth)acrylate), pentaerythritol tri(meth)acrylate, trimethylolpropane (meth)acrylate, trimethylolethane (meth)acrylate, dipentaerythritol tetra(meth)acrylate, dipentaerythritol penta(meth)acrylate, dipentaerythritol hexa(meth)acrylate, pentaerythritol hexa(meth)acrylate, 1,2,3-cyclohexane tetramethacrylate, polyurethane polyacrylate, polyester polyacrylate), ethylene oxide modified products thereof, vinyl benzene and derivatives thereof (for example, 1,4-divinyl benzene, 4-vinyl benzoic acid-2-acryloyl ethyl ester, and 1,4-divinyl cyclohexanone), vinyl sulfone (for example, divinyl sulfone), acryl amide (for example, methylene bisacrylamide), and methacryl amide. Two or more of the monomers can be used in combination.

Specific examples of monomers having high refractive index include (bis(4-methacryloylthiophenyl)sulfide, vinyl naphthalene, vinyl phenylsulfide, and 4-methacryloxyphenyl-4′-methoxyphenyl thioether. Two or more of the monomers may also be used in combination.

Polymerization of the monomers having the ethylenically unsaturated groups can be conducted under the presence of a photoradical initiator or heat radial initiator, irradiation of ionic radiation rays, or heating.

Accordingly, the anti-reflection layer can be formed by preparing a coating solution containing a monomer having an ethylenically unsaturated group, a photoradical initiator or heat radical initiator, matt particles, and inorganic filler, coating the coating solution on a transparent support and then curing the same through polymerizing reaction by ionic radiation rays or heat. For the photoradical initiators, etc. those known so far can be used.

The polymer having the polyether as the main chain is preferably a ring-opened polymer of a multi-functional epoxy compound. The ring-opening polymerization of the polyfunctional epoxy compound can be conducted under the presence of a photoacid generator or a heat acid generator by irradiation of ionic radiation rays or heating.

Accordingly, the anti-reflection layer can be formed by preparing a coating solution containing a polyfunctional epoxy compound, a photoacid generator or a heat acid generator, matt particles and inorganic filler, coating the solution on a transparent support and then curing the same by polymerizing reaction by ionic radiation rays or heating.

Instead of or in addition to the monomers having two or more ethylenically unsaturated groups, crosslinkable polyfunctional groups may be introduced by using monomers having crosslinking functional groups, and a crosslinked structure may be introduced into the binder polymer by the reaction of the crosslinkable functional groups.

Examples of the crosslinking functional groups include isocyanate group, epoxy group, azilidine group, oxazoline group, aldehyde group, carbonyl group, hydrazine group, carboxyl group, methylol group, and active methylene group. Vinyl sulfonic acid, acid anhydride, cyano acrylate derivatives, melamine, etherfied methylol, ester, and urethane, and metal alkoxide such as tetramethyl silane can also be utilized as the monomer for introducing the crosslinked structure. A functional group showing crosslinkability as a result of the decomposing reaction such as blocked isocyanate group may also be used. That is, the crosslinking functional group in the invention may be those not necessarily showing direct reactivity but may be those the reactivity as a result of decomposition.

The binder polymer having the crosslinking functional groups can form a crosslinked structure by heating after coating the binder polymer.

With an aim of providing an anti-dazzling property, the light scattering layer is preferably incorporated with matt particles larger than filler particles, for example, particles of inorganic compounds or resin particles having an average particle size of from 1 μm to 10 μm, preferably, from 1.5 μm to 7.0 μm.

Specific examples of the matt particles preferably include, for example, particles of inorganic compounds such as silica particles and TiO₂ particles; and resin particles such as acrylic particles, crosslinked acrylic particles, polystyrene particles, crosslinked styrene particles, memaline resin particles, and benzoguanamine resin particles. Among all, crosslinked styrene particles, crosslinked acryl particles, crosslinked acrylstyrene particles, and silica particles are preferred. Matt particles either of spherical or indefinite shape can be used.

Further, two or more kinds of mat particles of different particle sizes may also be used in combination. It is possible to provide the anti-dazzling property by matt particles of larger particle size and other optical characteristics by matt particles of smaller particle size.

Further, for the particle size distribution of the matt particles, mono-dispersion is most preferred and it is more preferred that as the particle size of each of the particles becomes identical to each other. For instance, in a case of defining particles having the particle size larger by 20% or more than the average particle size as coarse particles, the ratio of the coarse particles is preferably 1& or less, more preferably, 0.1% or less and, further preferably, 0.01% or less based on the sum of the number of particles. Matt particles having such a particle size distribution can be obtained by classification after usual synthetic reaction, and fine particles of more preferred distribution can be obtained by increasing the number of classification or intensify the degree thereof.

The matt particles are contained in the light scattering layer such that the amount of the matt particles in the formed light scattering layer is, preferably, from 10 mg/m² to 1000 mg/m² and, more preferably, from 100 mg/m² to 700 mg/m². The grain size distribution of the matt particles is measured by a coulter counter method and the measured distribution is converted to a particle number distribution.

For increasing the refractive index of the layer, the light scattering layer is preferably incorporated, in addition to the matt particles described above, with an inorganic filler comprising oxides of at least one metal selected from titanium, zirconium, aluminum, indium, zinc, tin, and antimony, having an average particle size of 0.2 μm or less, preferably, 0.1 μm or less and, further preferably, 0.06 μm or less.

On the other hand, in a light scattering layer using matt particles of high refractive index in order to increase the difference of the refractive index relative to the matt particles, it is also preferred to use oxides of silicon in order to keep the refractive index of the layer lower. Preferred particle size is identical with that for the inorganic filler described above.

Specific example of the inorganic filler used in the light scattering layer includes, for example, TiO₂, ZrO₂, Al₂O₃, In₂O₃, ZnO, SnO₂, Sb₂O₃, ITO and SiO₂. TiO₂ and ZrO₂ are particularly preferred in view of increase of the refractive index. It is also preferred to apply a silane coupling treatment or a titanium coupling treatment to the surface of the inorganic filler, and a surface treating agent having a functional group capable of reacting with binder species is preferably used for the filler surface. The addition amount of the inorganic filler is, preferably, from 10% to 90%, more preferably, from 20% to 80% and, particularly preferably, from 30 to 75% based on the entire mass of the light scattering layer. Since the particle size of such filler is sufficiently smaller than the wavelength of a light, it does not cause scattering and the dispersion containing the filler dispersed in the binder polymer behaves as an optically uniform substance.

The bulk refractive index of a mixture of the binder and the inorganic filler in the light scattering layer is, preferably, from 1.48 to 2.00, more preferably, from 1.50 to 2.00 and, further preferably, 1.50 to 1.80. The refractive index can be in the range described above by properly selecting the kind and the ratio of the amount of the binder and the inorganic filler. How to select them can previously be determined easily experimentally,

The light scattering layer preferably contains a fluorine type, silicone type surfactant, or both of them in a coating solution for forming an anti-dazzling layer in order to ensure surface uniformity, particularly, with less coating unevenness, drying unevenness and spotwise defects. Particularly, the fluorine type surfactant is used preferably since this develops an effect by a smaller addition amount of improving the surface failure such as coating unevenness, drying unevenness and spotwise defects of the anti-reflection layer. It is intended to enhance the productivity by providing high speed coatability while improving the surface uniformity.

Then, description is to be made to an anti-reflection layer formed by laminating a medium refractive index layer, a high refractive index layer, and a low refractive index layer in this order on a transparent protective film.

The anti-reflection layer having a layer constitution comprising at least the medium refractive index layer, the high refractive index layer, and the low refractive index layer (outermost layer) in this order on a substrate is preferably designed so as to have a refractive index satisfying the following relation: Refractive index of: high reflective index layer>refractive index of medium reflective index layer>refractive index of transparent support>refractive index of low refractive index layer.

Further, a hard coat layer may also be provided between the transparent support and the medium refractive index layer. Further, it may also comprise a medium refractive index hard coat layer, a high refractive index layer, and a low refractive index layer (refer, for example, to JP-A Nos. 8-122504, 8-110401, 10-300902, 2002-243906, and 2000-111706). Further, each of the layers may be provided with other functions and, for example, include an anti-contamination low refractive index layer, an antistatic high refractive index layer, etc. (refer, for example, to JP-A Nos. 20-206603 and 2002-243906).

The haze of the anti-reflection layer is, preferably, 5% or less and, more preferably, 3% or less. Further, the film strength is, preferably, H or more, more preferably, 2H or more and, most preferably, 3H or more in a pencil hardness test in accordance with JIS K 5400.

### (High Refractive Index Layer and Medium Refractive Index Layer)

A layer having high refractive index in the anti-reflection layer preferably comprises a curable film containing at least superfine particles of an inorganic compound having high refractive index with an average particle size of 100 nm or less and a matrix binder.

The fine particles of the inorganic compound of high refractive index include, for example, inorganic compounds having a refractive index of 1.65 or more and, preferably, a refractive index of 1.9 or more. For example, they include oxides of Ti, Zn, Sb, Sn, Zr, Ce, Ta, La, In, etc., or composite oxides containing such metal atoms.

Methods of forming such superfine particles include a treatment for the particle surface with a surface treating agent (for example, silane coupling agent: in JP-A Nos. 11-295503, 11-153703, and 2000-9908, anionic compound or organic metal coupling agent: in JP-A No. 2001-310432), formation of a core shell structure using particles at high refractive index as the core (JP-A Nos. 2001-166104 and 2001-310432, etc.) combined use of a specific dispersant, for example, in JP-A No. 11-153703, U.S. Pat. No. 6,210,858, and JP-A No. 2002-2776069.

Materials for forming the matrix include, for example, known thermoplastic resins and curable resin films.

Further, at least one composition selected from polyfunctional compound-containing composition having at least two radical polymerizable and/or cation polymerizable polymerizing groups and compositions containing organic metal compounds having hydrolysable groups and partial condensates thereof is preferred. For example, they include those compositions as described, for example, in JP-A Nos. 2000-47004, 2001-315242, 2001-31871, and 2001-296401.

Further, curable films obtained from compositions comprising a colloidal metal oxide obtained from hydrolysis condensates of metal alkoxides and metal alkoxide is also preferred. They are described, for example, in JP-A No. 2001-293818.

The refractive index of a high refractive index layer is generally from 1.70 to 2.20. The thickness of the high refractive index layer is, preferably, from 5 nm to 10 μm and, more preferably, from 10 nm to 1 nm. The refractive index of the medium refractive index layer is controlled so as to be a value between the refractive index for the low refractive index layer and the refractive index for the high refractive index layer. The refractive index of the medium refractive index layer is, preferably, from 1.50 to 1.70. Further, the thickness is, preferably, from 5 nm to 10 μm and, more preferably, from 10 nm to 1 μm.

### (Low Refractive Index Layer)

A low refractive index layer is formed by successive lamination on a high refractive index layer. The refractive index of the low refractive index layer is, preferably, from 1.20 to 1.55 and, more preferably, 1.30 to 1.50.

It is preferably constructed as an outermost layer having scratch resistance and anti-contamination property. As means for greatly improving the scratch resistance, provision of slipperiness to the surface is effective and known means for the thin film layer comprising introduction of silicone, introduction of fluorine, etc. are applicable.

The refractive index of the fluorine-containing compound is, preferably, from 1.35 to 1.50 and, more preferably, from 1.36 to 1.47. Further, as fluorine-containing compounds, compounds containing fluorine atoms within a range from 35 to 80 mass % are preferred, For example, they include compounds described in JP-A Nos. 9-222503 (column Nos. [0018] to 0026]), 11-38202 (column Nos. [0019] to [0030]), 2001-40284 (column Nos. [0027] to [0028], and 2000-284102.

The silicone compounds are preferably compounds having polysiloxane structures that contain curable functional groups or polymerizable functional groups in the polymer chain and have crosslinked structure in the film. For example, they include reactive silicones (for example, SILAPLANE produced by Chisso Co.) and polysiloxanes containing silanol groups on both terminal ends (JP-A No. 11-258403).

Crosslinking or polymerizing reaction of fluoro-containing and/or siloxane polymers having crosslinkable or polymerizable groups is preferably conducted by applying photo-irradiation or heating to a coating composition for forming the outermost layer containing polymerization initiator, sensitizer, etc. simultaneously with coating or after coating.

Further, it is also preferred to use sol-gel curable films which are cured by condensation reaction of organic metal compounds such as silane coupling agents and silane coupling agents containing specific fluoro-containing hydrocarbon groups.

For example, they include polyfluoro alkyl group-containing silane compounds or partial hydrolysis condensates thereof (compounds described, for example, in JP-A Nos. 58-142958, 58-147483, 58-147484, 9-157582, and 11-106704, and silyl compounds containing poly“perfluoroalkyl ether” group which are fluoro-containing long chained groups (JP-A Nos. 2000-117902, 2001-48590, and 2002-53804).

The low refractive index layer can contain, as other additives than described above, inorganic compounds of low refractive index having a primary average particle size of from 1 nm to 150 nm such as fillers (for example, silicon dioxide, fluoro-containing particles (such as magnesium fluoride, calcium fluoride, and barium fluoride), fine organic particles described in JP-A No. 11-3820 (column Nos. [0020] to [0038]), silane coupling agents, slipping agents, and surfactants.

In a case where the low refractive index layer situates below the outermost layer, the low refractive index layer may also be formed by a vapor phase method (vacuum vapor deposition method, sputtering method, ion plating method, plasma CVD method, etc.). A coating method is preferred in that it can be prepared at a reduced cost. The thickness of the low refractive index layer is, preferably, from 30 nm to 200 nm, more preferably, from 50 nm to 150 nm and, most preferably, from 60 nm to 120 nm.

### (Other Layers in Anti-Reflection Layer)

Further, a hard coat layer, forward diffusion layer, primer layer, anti-static layer, undercoat layer, or protective layer may also be disposed.

### (Hard Coat Layer)

A hard coat layer is disposed to the surface of a transparent support for providing a physical strength to the transparent protective film having the anti-reflection layer Particularly, it is disposed preferably between the transparent support and the high refractive index layer. The hard coat layer is formed preferably by crosslinking reaction or polymerizing reaction of a photo- and/or heat curable compound. As the curing functional group, photo-polymerizable functional group is preferred and the organic metal compound containing the hydrolysable functional group is preferably an organic alkoxide silyl compound.

Specific example of the compounds includes compounds identical with those exemplified for the high refractive index layer. Specific constituent compositions for the hard coat layer include, for example, those described in JP-A Nos 2002-144913 and 2000-9908, and the pamphlet of WO-00/46617.

High refractive index layer can serve also as the hard coat layer. In such a case, it is preferably formed by finely dispersing fine particles and incorporating them in the hard coat layer by using the method described for the high refractive index layer.

The hard coat layer can serve also as an anti-dazzling layer provided with an anti-dazzling function (anti-glare function) by incorporating particles having an average particle size of 0.2 μm to 10 μm.

The thickness of the hard coat layer can be properly designed depending on the application use. The thickness of the hard coat layer is, preferably, from 0.2 μm to 10 μm and, more preferably, from 0.5 μm to 7 μm.

The strength of the hard coat layer is, preferably, H or more, more preferably, 2H or more and, most preferably, 3H or more in a pencil hardness in accordance with JIS K 5400. Further, it is more preferred as the amount of abrasion of a test specimen is smaller after the test in a taper test in accordance with JIS K 5400.

### (Antistatic Layer)

In a case of disposing an antistatic layer, it is preferred to provide a conductivity with a volumic resistivity of 10⁻⁸ Ωcm⁻³. While the volumic resistivity of 10⁻⁸ Ω·cm⁻³ can be provided by the use of a hygroscopic material or water soluble organic salt, a certain kind of surfactant, cation polymer, anion polymer, colloidal silica, etc., it shows large dependence on temperature and humidity to involve a problem of not ensuring a sufficient conductivity at low humidity. Accordingly, metal oxides are preferred as the material for the antistatic layer. While some metal oxides are colored, in a case where such metal oxides are used as the material for the antistatic layer, a film is entirely pigmented which is not preferred. Metals forming metal oxides causing no coloration, include Zn, Ti, Al, In, Si, Mg, Ba, Mo, W, or V and use of metal oxides comprising them as the main ingredient is preferred. Specific examples are preferably ZnO, TiO₂, SnO₂, Al₂O₃, In₂O₃, SiO₂, MgO, BaO, MoO₃, V₂O₅, etc., or composite oxides thereof, with ZnO, TiO₂, SnO₂ being particularly preferred. As examples of containing hetero atoms, addition of Al, In, etc. to ZnO, addition of Sb, Nb, halogen element, etc. to SnO₂, and addition of Nb or Ta, etc. to TiO₂ are preferred. Furthermore, as described in JP-B No. 59-6235, a material formed by depositing the metal oxide to other crystalline metal particles or fibrous materials (for example, titanium oxide) may also be used. While the volume resistance value and the surface resistance value are different physical values and can not be compared simply, for ensuring the conductivity of 10⁻⁸ Ω·cm⁻³ or less in view of the volume resistance value, the antistatic layer may generally has a surface resistance value of 10⁻¹⁰Ω/□ or less, more preferably, 10⁻⁸Ω/□. It is necessary that the surface resistance value of the antistatic layer is measured as a value with the antistatic layer being as an outermost layer, and it can be measured in the intermediate stage of forming the laminate film described in the present specification.

### (Liquid Crystal Display Device)

Then, description is to be made to a liquid crystal display device of the invention having the cyclic polyolefin film, the protective film for use in polarizing plate, the optically-compensatory film, and the polarizing plate.

The cyclic polyolefin film, the optically-compensatory film having the film, and the polarizing plate using the film of the invention can be used in liquid crystal cells and liquid crystal display devices of various display modes. There have been proposed various display modes such as TN (Twisted Nematic), IPS (In-Plane Switching), FLC (Ferroelectric Liquid Crystal), AFLC (Anti-ferroelectric Liquid Crystal), OCB (Optically Compensatory Bend), STN (Super Twisted nematic), VA (Vertically Aligned) and HAN (Hybrid Aligned Nematic). They are used preferably for the OCB mode or VA mode among them.

The liquid crystal cell of the OCB mode is a liquid crystal display device using a liquid crystal cell of a bend alignment mode in which rod-like liquid crystalline molecules are aligned in substantially opposite directions (symmetrically) between the upper portion and the lower portion of the liquid crystal cell. The liquid crystal cell of OCB mode is disclosed in each of the specifications of U.S. Pat. Nos. 4,583,825 and 5,410,422. Since the rod-like liquid crystal molecules are aligned symmetrically between the upper portion and the lower portion of the liquid crystal cell, the liquid crystal cell of the bend alignment mode has a self-optically compensatory function. Accordingly, the liquid crystal mode is also referred to as an OCB (Optically Compensatory Bend) liquid crystal mode.

In the liquid crystal cell of the VA mode, the rod-like liquid crystalline molecules are aligned substantially vertically in a state of not applying the voltage.

The liquid crystal cell of the VA mode includes (1) a liquid crystal cell of VA mode in narrow meaning in which rod-like liquid crystalline molecules are aligned substantially vertically in a state of not applying voltage and aligned substantially horizontally in a state of applying voltage (described in JP-A No. 2-176625) and, in addition, (2) a liquid crystal cell of a multi-domained VA mode (MVA mode) for enlarging the view angle described in (SID97, Digest of “Tech. Paper (pre-text) 28 (1997) 845), (3) a liquid crystal cell of a mode in which rod-like liquid crystalline molecules are aligned substantially vertically in a state of not applying voltage and put to cramped multi-domain alignment in a state of applying voltage (n-ASM mode) (described in the Pretext of Japan Liquid Crystal Discussion Meeting, 58 to 59 (1998)) and (4) a liquid crystal cell of SURVAIVAL mode (presented in LCD International 98).

The liquid crystal display device of the VA mode comprises a liquid crystal cell and two sheets of polarizing plates disposed on both sides thereof. The liquid crystal cell supports liquid crystals between the two sheets of electrode substrates. In one embodiment of a transmission type liquid crystal display device of the invention, the optically-compensatory film of the invention is disposed by the number of one between the liquid crystal cell and one of the polarizing plates or disposed by the number of two between the liquid crystal cell and both of the polarizing plates.

In another embodiment of a transmission type liquid crystal display device of the invention, an optically-compensatory film having the cyclic polyolefin film of the invention is used as a transparent protective film for the polarizing plate disposed between the liquid crystal cell and the polarizer. That is, the transparent protective film of the polarizing plate can serve also as the optically-compensatory film, The optically-compensatory film may be used only for the transparent protective film of one of the polarizing plates (between the liquid crystal cell and the polarizer), or the optically-compensatory film described above may also be used for two sheets of transparent protective films for both of the polarizing plates (between the liquid crystal cell and the polarizer). In a case of using the optically-compensatory film only for one of the polarizing plates, it is used particularly preferably as the protective film for the polarizing plate on the side of the liquid crystal cell at the back light side of the liquid crystal cell. It is bonded preferably with the cyclic polyolefin film of the invention being on the side of the VA cell. The other protective film may also be a cellulose, acylate film usually used. For example, it is preferably from 40 μm to 80 μm and includes, for example, commercially available KC4UX2M (40 μm, produced by Yunicaopto Co.), KC5UX (60 μm, produced by Yunicaopto Co.), TD80 (80 μm, produced by Fuji Photographic Film), with no restriction to them.

In OCB mode liquid crystal display devices or TN liquid crystal display devices, an optically-compensatory film is used for enlarging the view angle. An optically-compensatory film for use in the OCB cell uses an optically anisotropic layer in which a discotic liquid crystal is fixed under hybrid alignment on an optically monoaxial or biaxial film. An optically-compensatory film for use in the TN cell uses an optically anisotropic layer in which descotic liquid crystal is fixed under hybrid alignment on an optically isometric film or a film having an optical axis in the direction of the thickness. The cyclic polyolefin film of the invention is useful also for the preparation of the optically-compensatory film for use in the OCB cell or the optically-compensatory film for use in the TN cell.

### EXAMPLE

The present invention achieving the first purpose of the present invention is to be described specifically with reference to examples but the invention is not restricted to the examples

### <Synthesis of Cyclic Polyolefin Polymer P-1-1>

100 mass parts of purified toluene and 100 mass parts of methyl norbornene carbonate ester were charged in a reaction vessel. Then, 25 mmol % of ethyl hexanoate-Ni (based on monomer mass) and 0.225 mol % of tri(pentefluorophenyl)boron (based on monomer mass) dissolved in toluene, and 0.25 mol % of triethyl anilinium (based on monomer mass) dissolved in toluene were charged in a reaction vessel. They were reacted under stirring at a room temperature for 18 hours and, after the completion of the reaction, the reaction mixture was charged in an excess ethanol to form precipitates of polymerizates. A cyclic polyolefin polymer (P-1-1) obtained by purifying the precipitates were dried by vacuum drying at 65° C. for 24 hours.

### Example 1-1

The following composition was charged in a mixing tank and stirred, and each of the ingredients was dissolved and then filtered through filter paper with an average pore size of 34 μm and a sintered metal filter with an average pore size of 10 μm.

(Cyclic polyolefin solution D-1-1)

| | |
|---|---|
| Cyclic polyolefin polymer P-1-1 | 150 mass parts |
| Dichloromethane | 414 mass parts |
| Methanol | 36 mass parts |

Then, the composition described in M-1-1 was charged in a tank having a stirrer to prepare an additive solution M-1-1.

(Additive solution M-1-1)

| | |
|---|---|
| Zinc stearate | 1 mass part |
| Dichloromethane | 91 mass parts |
| Methanol | 8 mass parts |

100 mass parts of the cyclic polyolefin solution D-1-1 and 1.25 mass parts of the additive solution M-1-1 were mixed to prepare a dope for preparing a film. The dope was cast by a band casting machine. A film peeled from a band at a residual amount of the solvent of about 35 mass % was stretched by a tenter in the width direction while drying by applying a hot blow at 140° C. Then, the tenter transportation was transferred to the roll transportation and the film was further dried at 120° C. to 140° C., and taken up to obtain a cyclic polyolefin film in which a higher fatty acid derivative was dispersed in the film. The film thickness was 80 μm. The rate of stretching and the various film characteristics are described in Table 1-1. Re retardation, and Rth retardation of the prepared film were measured by the method described above. As the optical unevenness, a difference between the maximum value and the minimum value for the scattering of the Re retardation and Rth retardation was shown for seven specimens each of 130 cm width sampled at a distance of 20 cm. Optical unevenness by visual observation was evaluated by inserting a sample between polarizing plates arranged in the crossed Nichol state,

### Example 1-2

A cyclic polyolefin film in which a higher fatty acid derivative was dispersed in a film was prepared by the method quite identical with that in Example 1-1 except for using zinc laurate instead of zinc stearate in Example 1-1. The result of evaluation is shown in Table 1-1.

### Example 1-3

A cyclic polyolefin film in which a higher fatty acid derivative was dispersed in a film was prepared by the method quite identical with that in Example 1-1 except for using barium stearate instead of zinc stearate in Example 1-1. The result of evaluation is shown in Table 1-1.

### Example 1-4

The following composition was charged in a mixing tank and stirred, and each of the ingredients was dissolved and then filtered through filter paper with an average pore size of 34 μm and a sintered metal filter with an average pore size of 10 μm.

(Cyclic polyolefin solution D-1-2)

| | |
|---|---|
| Appear 3000 | 150 mass parts |
| Dichloromethane | 414 mass parts |
| Methanol | 36 mass parts |

Then, the composition described in M-1-2 was charged in a tank having a stirrer to prepare an additive solution M-1-2.

(Additive solution M-1-2)

| | |
|---|---|
| Zinc stearate | 2 mass part |
| Dichloromethane | 90 mass parts |
| Methanol | 8 mass parts |

100 mass parts of the cyclic polyolefin solution D-1-2 and 1.25 mass parts of the additive solution M-1-2 were mixed to prepare a dope for preparing a film. The dope was cast by a band casting machine. A film peeled from a band at a residual amount of the solvent of about 25 mass % was stretched by a tenter in the width direction while drying by applying a hot blow at 140° C. Then, the tenter transportation was transferred to the roll transportation and the film was further dried at 120° C. to 140° C., and taken up to obtain a cyclic polyolefin film in which a higher fatty acid derivative was dispersed in the film. The film thickness was 80 μm. The rate stretching and the various film characteristics are described in Table 1-1.

### Example 1-5

A cyclic polyolefin film in which a higher fatty acid derivative was dispersed in a film was prepared by the method quite identical with that in Example 1-1 except for using stearic acid amide instead of zinc stearate in Example 1-4. The result of evaluation is shown in Table 1-1.

### Example 1-6

An additive solution was prepared by using stearic acid monoglyceride instead of zinc stearate in Example 1-4. 100 mass parts of a cyclic polyolefin solution and 12.5 mass parts of the additive solution were mixed to prepare a dope for forming film to prepare a cyclic polyolefin film in which higher fatty acid derivative was dispersed in the film quite in the same method as in Example 1-4. The result of evaluation are shown in Table 1-1.

### Example 1-7

The following composition was charged in a mixing tank and stirred, and each of the ingredients was dissolved, and then filtered through filter paper with an average pore size of 34 μm and a sintered metal filter with an average pore size of 10 μm.

(Cyclic polyolefin solution D-1-3)

| | |
|---|---|
| Cyclic polyolefin: Zeonor ZF-14 | 150 mass parts |
| Cyclohexane | 450 mass parts |

Then, the composition described in M-1-3 was charged in a tank having a stirrer to prepare an additive solution M-1-3.

(Additive solution M-1-3)

| | |
|---|---|
| Zinc stearate | 1 mass part |
| Cyclohexane | 99 mass parts |

Then, the following composition containing the cyclic polyolefin solution prepared by the method described above was charged in a dispersing machine to prepare a liquid dispersion of fine particles,

(Fine particle liquid dispersion M-1-4)

| | |
|---|---|
| Aerosil R972 (silica particle with 16 nm | 2 mass parts |
| primary average average grain size) | |
| Cyclohexane | 83 mass parts |
| Cyclic polyolefin solution D-1-3 | 10 mass parts |

100 mass parts of the cyclic polyolefin solution D-1-3, 1.25 mass parts of the additive solution M-1-3, and 1.35 mass parts of the fine particle liquid dispersion M-1-4 were mixed, to prepare a dope for preparing a film. The dope was cast by a band casting machine. A film peeled from a band at a residual amount of the solvent of about 35 mass % was dried at 120° C. to 140° C. while being kept so as not to cause creases in the film and taken-up to obtain a cyclic polyolefin film in which a higher fatty acid derivative was dispersed in the film. Various characteristics of the prepared film are shown in Table 1-1.

### Example 1-8

To 100 mass parts of D-1-1 and 1.25 mass parts of M-1-1 prepared in Example 1-1, were added 1.25 mass parts of the following additive solution M-1-5 to prepare a dope for preparing a film. The dope was cast by a band casting machine. A film peeled from a band at a residual amount of solvent of about 25 mass % was stretched by a tenter in the width direction while being dried by applying a hot blow at 140° C. Then, the tenter transportation was transferred to the roll transportation and the film was further dried at 120° C. to 140° C., and taken up to obtain a cyclic polyolefin film in which a higher fatty acid derivative was dispersed in the film. The film thickness was 80 μm. The stretching ratio and the various film characteristics are described in Table 1-1.

(Fine particle liquid dispersion M-1-5)

| | |
|---|---|
| Aerosil R972 (silica particle with | 2 mass parts |
| 16 nm primary grain size) | |
| Dichloromethane | 73 mass parts |
| Methanol | 10 mass parts |
| Cyclic polyolefin solution D-1-1 | 10 mass parts |

### Example 1-9

The cyclic polyolefin solution D-1-1 was used as a dope for preparing a film and cast by a band casting machine. A film peeled from the band at a residual amount of solvent of the about 25 mass % was stretched in the width direction by a tenter while being dried by applying a hot blow at 140° C. Then, a solution in which 1 mass part of behenic acid was dissolved in 99 mass parts of hexane (coating solution) was coated on one side of the film to a film thickness of about 1 μm. Further, the film was dried at 120° C. to 140° C. and taken up, to obtain a cyclic polyolefin film having a layer containing the compound described above on one surface of the layer comprising the cyclic polyolefin resin as a main ingredient. The film thickness was 80 μm. The rate of stretching and the various film characteristics are shown in Table 1-1.

### Example 1-10

100 mass parts of the cyclic polyolefin solution D-1-1 and 1.35 mass parts of the fine particle dispersion M-1-5 were added and a stirred solution was used as a dope for forming a film and cast by a band casting machine. A film peeled from the band at a residual amount of solvent of the about 25 mass % was stretched in the width direction by a tenter while being dried by applying a hot blow at 140° C. Then, a solution in which 1 mass part of behenic acid was dissolved in 99 mass parts of hexane (coating solution) was coated on one side of the film to a film thickness of about 1 μm. Further, the film was dried at 120° C. to 140° C. and taken up, to obtain a cyclic polyolefin film having a layer containing the compound described above on one surface of the layer comprising the cyclic polyolefin resin as a main ingredient. The film thickness was 80 μm. The stretching ratio and the various film characteristics are shown in Table 1-1.

### Example 1-11

The following composition was charged in a mixing tank and stirred, and each of the ingredients was dissolved, and then filtered through filter paper with an average pore size of 34 μm and a sintered metal filter with an average pore size of 10 μm.

(Cyclic polyolefin solution D-1-4)

| | |
|---|---|
| Cyclic polyolefin polymer P-1-1 | 150 mass parts |
| Dichloromethane | 322 mass parts |
| Methanol | 28 mass parts |

Then, in the same manner, the following composition was charged in a mixing tank and stirred to dissolve each of the ingredients and then filtered through filter paper of an average pore size of 34 μm and a sintered metal filter of an average pore size of 10 μm.

(Cyclic polyolefin solution D-1-5)

| | |
|---|---|
| Cyclic polyolefin polymer P-1-1 | 150 mass parts |
| Dichloromethane | 552 mass parts |
| Methanol | 48 mass parts |

Then, the composition described in M-1-6 was charged in a tank having a stirrer to prepare an additive solution M-1-6.

(Additive solution M-1-6)

| | |
|---|---|
| Zinc stearate | 0.1 mass parts |
| Dichloromethane | 92 mass parts |
| Methanol | 8 mass parts |

100 mass parts of the cyclic polyolefin solution D-1-5 and 2 mass parts of the additive solution M-1-6 were mixed to prepare a dope D-1-6 for forming a film. The dope was cast with the dope D-1-4 being as an inner layer and the dope D-1-6 being as the surface layer by a casting machine described in JP-A No. 56-162617. A film peeled from the band at a residual amount of the solvent of about 35 mass % was stretched in the width direction by a tenter while being dried by applying a hot blow at 140° C. Then, the tenter transportation was transferred to the roll transportation. Further, the film was dried at 120° C. to 140° C. and taken up, to obtain a cyclic polyolefin film in which the compound described above was contained on both surfaces of the film. The film thickness was 80 μm in total. The rate of stretching and various film characteristics are shown in Table 1-1.

### Comparative Example 1-1

The cyclic polyolefin solution D-1-1 was used as a dope for preparing a film and cast by a band casting machine. A film peeled from the band at a residual amount of the solvent of about 25 mass % was stretched in the width direction by a tenter while being dried by applying a hot blow at 140° C. Further, the film was dried at 120° C. to 140° C. and taken up. The film thickness was 80 μm. The rate of stretching and the various film characteristics are shown in Table 1-1.

### Comparative Example 1-2

100 mass parts of the cyclic polyolefin solution D-1-1 and 1.35 mass parts of fine particle dispersion M-1-5 were mixed to prepare a dope for forming a film, which was cast by a band casting machine. A film peeled from the band at a residual amount of the solvent of about 25 mass % was stretched in the width direction by a tenter while being dried by applying a hot blow at 140° C. Further, the film was dried at 120° C. to 140° C. and taken up. The film thickness was 80 μm. The rate of stretching and the various film characteristics are shown in Table 1-1.

### Comparative Example 1-3

A resin composition was prepared by mixing the following composition.

(Resin composition)

| | |
|---|---|
| Cyclic polyolefin: Apel APL5014 | 100 mass parts |
| Zinc stearate | 0.05 mass parts |
| Aerosil R972 (silica particle of 16 nm primary | 0.1 mass parts |
| average particle size) | |

Then, the resin composition was melted while being pre-heated at 90° C. by using a single screw extruder having an inner diameter of 50 mm and L/D=28. The temperature at the inlet was 200° C. and the temperature at the exit was 140° C. It was extruded by way of a gear pump at the exit of the extruder through a T die. In the cooling step, three cooling rolls were used. The cooling rolls were arranged each at a distance of 3 cm. The temperature of the first cooling roll nearest to the die was 130° C., the value of difference between the temperature of the second cooling roll and the temperature of the first cooling roll was 3° C. and the value of difference between the temperature of the second cooling roll and the temperature of the third cooling roll was 13° C.

Further, for the transportation speed of the rolls, the ratio of the difference between the transportation speed of the second cooling roll (Sr₂) and the transportation speed of the first cooling roll (Sr₁=50 m/min) reactive to the transporting speed of the first cooling roll (Sr₁) (ΔSr₂₁(%)=100×(Sr₂−Sr₁)/Sr₁) was 1%, and the ratio of the difference between the transportation speed of the third cooling roll (Sr₃) and the transportation speed of the second cooling roll (Sr₂) relative to the transportation speed of the second cooling roll (Sr₂) (ΔSr₂₁(%)=100×(Sr₂−Sr₃)/Sr₂) was 1%. All of the cooling rolls were arranged for a casing at 120° C. Further, in the first cooling roll, an electrostatic application method was used and pressing was applied only to 0.17 mm width for 1.7 m sheet width of the first cooling roll. The cooling speed between the cooling rolls arranged densely as described above was 2° C./sec. The cooling speed was shown by a value obtained by dividing the difference between the temperature of the film disposed to the first cooling roll and the temperature of the sheet just before peeling off the final cooling roll by a time required for passage between them. After the final cooling roll, the sheet was transported between rolls disposed each at 0.5 mm distance at a cooling speed of 2° C./sec. The thickness of the obtained film was 79 μm. A T die type film melt extrusion molding machine equipped with a resin melt kneader having a screw of 65 mmφ was used and a film of 80 μm thickness was extrusion molded under the molding condition at a molten resin temperature of 240° C. and a die width of 500 mm to obtain a cyclic polyolefin film in which a higher fatty acid derivative and fine inorganic particles were dispersed in the film. Various characteristics of the produced film are shown in Table 1-1.

TABLE 1-1

| | Cyclic | | Addition | | | | | | | | |
|---|---|---|---|---|---|---|---|---|---|---|---|
| | poly- | Higher | place/ | | Rate of | | | | | Trans- | Unevenness |
| | olefin | fatty acid | addition | Fine particle | stretching | Frictional | Han- | Re | Rth | mittance | in visual |
| No. | resin | derivative | amount | dispersion | (%) | dispersion | dling | (nm) | (nm) | (%) | observation |
| Example 1-1 | P-1-1 | Zinc stearate | in film/0.05 | none | 9% | 0.4 | A | 40 ± 1 | 220 ± 4 | 92 | A |
| Example 1-2 | P-1-1 | Zinc laurate | in film/0.05 | none | 9% | 0.5 | B | 32 ± 1 | 200 ± 5 | 90 | A |
| Example 1-3 | P-1-1 | Barium stearate | in film/0.05 | none | 9% | 0.5 | B | 35 ± 3 | 210 ± 5 | 91 | B |
| Example 1-4 | Appear | Zinc stearate | in film/0.1 | none | 7% | 0.4 | A | 30 ± 2 | 200 ± 3 | 90 | A |
| | 3000 | | | | | | | | | | |
| Example 1-5 | Appear | Stearate amide | in film/0.1 | none | 7% | 0.3 | B | 32 ± 3 | 210 ± 4 | 89 | B |
| | 3000 | | | | | | | | | | |
| Example 1-6 | Appear | Stearate | in film/1.0 | none | 7% | 0.5 | B | 35 ± 2 | 205 ± 4 | 90 | A |
| | 3000 | monoglyceride | | | | | | | | | |
| Example 1-7 | Zeonor | Barium stearate | in film/0.05 | none | none | 0.5 | B | 5 ± 0.5 | 7 ± 0.5 | 91 | B |
| | ZF-14 | | | | | | | | | | |
| Example 1-8 | P-1-1 | Barium stearate | in film/0.05 | Aerosil R972 | 9% | 0.3 | A | 38 ± 2 | 220 ± 4 | 91 | A |
| Example 1-9 | P-1-1 | Behenic acid | on one | none | 9% | 0.3 | A | 45 ± 2 | 230 ± 5 | 92 | B |
| | | | surface/0.01 | | | | | | | | |
| Example 1- | P-1-1 | Behenic acid | on one | Aerosil R972 | 9% | 0.2 | A | 44 ± 1 | 220 ± 4 | 92 | A |
| 10 | | | surface/0.01 | | | | | | | | |
| Example 1- | P-1-1 | Zinc stearate | on one | none | 9% | 0.3 | A | 42 ± 1 | 225 ± 4 | 92 | A |
| 11 | | | surface/0.01 | | | | | | | | |
| Comp. | P-1-1 | no | none | none | 9% | 0.8 | C | 42 ± 7 | 225 ± 10 | 92 | C |
| Example 1-1 | | | | | | | | | | | |
| Comp. | P-1-1 | no | none | Aerosil R972 | 9% | 0.6 | B | 35 ± 6 | 210 ± 12 | 92 | C |
| Example 1-2 | | | | | | | | | | | |
| Comp. | Apel | Zinc stearate | in film 0.05 | Aerosil R972 | No | 0.3 | B | 3 ± 0.5 | 4 ± 0.5 | 91 | C |
| Example 1-3 | APL | | | | | | | | | | with die |
| | 5014 | | | | | | | | | | line |

Handlability: A: capable of taking up with no squeaking B: with no occurrence of creases, etc. although squeaking occurred C: occurrence of creases, etc.
Unevenness in visual observation A: no unevenness observed B: practically usable although having unevenness C: not durable for practical use
* Addition amount: mass % based on cyclic polyolefin resin

### Example 1-12

### Preparation of Polarizing Plate

A polarizer was prepared by adsorption of iodine to a stretched polyvinyl alcohol film. Glow discharging treatment (high frequency voltage at 3000 Hz, 4200 V applied between upper and lower electrodes, treatment for 20 sec) applied to cyclic polyolefin films prepared in Examples 1-1 and 1-7 (F-1-1, F-1-7, respectively) to prepare protective films for use in polarizing plate which were then bonded to the surface and rear face of a polarizer by using a polyvinyl alcohol type adhesive and dried at 70° C. for 10 min or more. In the prepared polarizing plate A, the cyclic polyolefin film F-1-1 was bonded on one side and the cyclic polyolefin film F-1-7 was bonded on the opposite side of the polarizer. Further, they were arranged such that the axis of transmission of the polarizer and the retardation phase axis of the cyclic polyolefin film F-1-7 were in parallel. Further, they were arranged such that the axis of transmission of the polarizer and the phase retardation axis of the cyclic polyolefin film F-1-1 were crossed. In the prepared polarizing plate B, cyclic polyolefin films F-1-1 were bonded on both sides of the polarizer. Further, they were arranged such that the axis of transmission of the polarizer and the retardation phase axis of the cyclic polyolefin film F-1-1 were crossed.

### <Manufacture of VA Liquid Crystal Cell>

A liquid crystal cell was produced by dripping and injecting a liquid crystal material having a negative dielectric anisotropy (“MLC6608”, manufactured by Merck Co.) between substrates at a cell gap of 3.6 μm and sealing the same thereby forming a liquid crystal layer between the substrates. The retardation of the liquid crystal layer (that is, the product Δn·d of the thickness d (μm) of the liquid crystal layer and the refractive index anisotropy Δn) was defined as 300 nm. The liquid crystal material was aligned by vertical alignment. The prepared polarizing plate B was bonded by way of an adhesive to the upper side of the vertically aligned type liquid crystal cell (on the side of an observer). The prepared polarizing plate A was bonded by way of an adhesive to the lower side of the liquid crystal cell (on the side of the back light) such that the F-1-7 side was on the side of the liquid crystal cell.

They were arranged in a Crossed Nichol state such that the axis of transmission of the upper polarizing plate was in the vertical direction and the axis of transmission of the lower polarizing plate was in the right to left direction.

As a result of observation for the produced liquid crystal display device, it was satisfactory with no unevenness in the display along sides of images.

Next, the present invention achieving the second to fourth purposes of the present invention is to be described specifically based on examples but the invention is not restricted to the examples.

At first, various evaluation methods are to be described.

### [Measurement for Static Friction Coefficient]

A static friction coefficient was measured by using films produced in the following examples. In the measuring method, two types of specimens, i.e., specimens sized 7.5×10 cm (small specimen) and 10×20 cm (large specimen) were prepared. The large specimen was set to a table disposed to a tensilon (tensile tester), on which the small specimen was placed and, further, weight of 200 g was applied on the small specimen. The small specimen was pulled by the tensilon and the load (f) at which the small specimen started to slide was measured. The static friction coefficient (μ) was calculated according to the equation: μ=f/200.

### [Surface Property]

Films were observed with naked eyes under a transmission light or a reflection light to see the presence or absence of patterns, obstacles, injuries, etc.

In films of poor slipperiness, linear creases or clamps occurred particularly in the longitudinal direction. It was evaluated as “A” for transparent and colorless films with nothing to be seen and as “B” for those with conspicuous patterns, obstacles, injuries, etc.

### [Detached Fine Particles]

When films were rubbed with a hand putting on a cotton globe, fine particles were detached and absence or presence for the occurrence of powder was observed with naked eyes. It was evaluated as “A” for those with no detachment of fine particles and no occurrence of powder, as “B” for those causing detachment by friction and as “C” for those causing detachment even with no friction.

### [Evaluation for Crease in Winding]

Films produced in the following examples were taken up around a winding core with no lamination film and the number of taken-up meter at the instance where creases in winding started to occur was measured. It was evaluated as “A” for those that could be taken up for 100 m or more with no creases in winding and as “B” for those causing creases in winding till they were taken-up by 100 m.

### Synthesis Example

### Synthesis of Polymer P-2-1 as Cyclic Olefin

180 mass parts of purified toluene and 100 mass parts of norbornene-5-methanol acetate were charged in a reaction vessel. Then, 0.04 mass parts of palladium (II) acetyl acetonate, 0.04 mass parts of tricyclohexyl phosphine, and 0.20 mass parts of dimethyl aluminum tetrakis (pentafluorophenyl)borate dissolved in toluene were charged in a reaction vessel. They were reacted under stirring at 90° C. for 18 hours. After the completion of the reaction, the reaction mixture was charged in an excess ethanol to form precipitates of polymerizates. A polymer (P-2-1) obtained by purifying the precipitates was dried in vacuum at 65° C. for 24 hours.

The obtained polymer (P-2-1) was dissolved in tetrahydrofuran and, when the molecular weight was measured by gel permeation chromatography, the number average molecular weight was 79,000, and the mass average molecular weight was 205,000 being converted as polystyrene.

### Example 2-1

After charging the following composition in a mixing tank and dissolving each of the ingredients by stirring, they were filtered through filter paper with an average pore size of 34 μm and a sintered metal filter with an average pore size of 10 μm to obtain a cyclic olefin resin solution D-2-1.

(Cyclic olefin resin solution D-2-1)

| | |
|---|---|
| Cyclic olefin resin P-2-1 | 150 mass parts |
| Dichloromethane | 380 mass parts |
| Methanol | 70 mass parts |

The following composition containing the cyclic olefin resin solution D-2-1 prepared by the method described above was charged in a dispersing device, to prepare a fine resin particle liquid dispersion M-2-1.

(Fine particle liquid dispersion M-2-1)

| | |
|---|---|
| Silica paricles of 16 nm primary average particle size | 2 mass parts |
| (Aerosil R972 produced by Nippon Aerosil Co.) | |
| Dichloromethane | 73 mass parts |
| Methanol | 10 mass parts |
| Cyclic olefin resin solution D-2-1 | 10 mass parts |

100 mass parts of the cyclic olefin resin solution (D-2-1) and 1.43 mass of fine particle liquid dispersion (M-2-1) were mixed to prepare a dope for film formation.

The dope was cast by using a band casting device at a production speed of 20 m/min. A film peeled at a residual amount of the solvent of about 25 mass % was stretched by using a tenter at a rate of stretching of 2% in the width direction and dried by applying a hot blow while being held so as not to cause creases in the film.

Then, the tenter transportation was changed to the roll transportation, and the film was dried at 120° C. to 140° C., and taken up to obtain a cyclic olefin resin film. The thickness, the static friction coefficient, the transmittance at 550 nm, the surface shape, absence or presence of crease in winding and absence or presence of detachment of fine particles of the obtained film (F-2-1) were measured and shown in Table 2-1.

### Comparative Example 2-1

Only the cyclic olefin resin solution (D-2-1) was cast as a dope for film formation by using a band casting device at a production speed of 20 m/min. A film peeled off from the band at a residual amount of the solvent of about 25 mass % was stretched by using a tenter in the width direction at a rate of stretching of 2% and dried by applying a hot blow while being held so as not to cause creases in the film. The film was poor in the slipperiness and causes creases in winding upon take-up. The thickness, the static friction coefficient, the transmittance at 550 nm, the surface shape, absence or presence of crease in winding and absence or presence of detachment of fine particles of the obtained film (F-2-11) were measured and shown in Table 2-1.

### Comparative Example 2-2

After charging the following composition in a mixing tank and dissolving each of ingredients by stirring, they were filtered through filter paper with an average pore size of 34 μm and a sintered metal filter with an average pore size of 10 μm, to prepare a dope for film formation.

(Cyclic olefin resin solution D-2-11)

| | |
|---|---|
| Cyclic olefin resin P-2-1 | 150 mass parts |
| Dichloromethane | 380 mass parts |
| Methanol | 70 mass parts |
| Silica particles of 16 nm primary average particle size | 0.18 mass parts |
| (Aerosil R972 produced by Nippon Aerosil Co.) | |

Only the cyclic olefin resin solution (D-2-11) not using the liquid dispersion of fine particles of the invention was cast as a dope for film formation by using a band casting device at a production speed of 20 m/min. A film peeled off from the band at a residual amount of the solvent of about 25 mass % was stretched by using a tenter in the width direction at a rate of stretching of 2% and dried by applying a hot blow while being held so as not to cause creases in the film. Then, the tenter transportation was changed to the roll transportation, and the film was dried at 120° C. to 140° C., and taken up to obtain a cyclic olefin resin film. Detachment of fine particles was confirmed for the entire film. The thickness, the static friction coefficient, the transmittance at 550 nm, the surface shape, absence or presence of crease in winding and absence or presence of detachment of fine particles of the obtained film (F-2-12) were measured and shown in Table 2-1.

### Comparative Example 2-3

Then, the following composition was charged in a dispersing device to prepare a fine particle liquid M-2-11.

(Fine particle liquid dispersion M-2-11)

| | |
|---|---|
| Silica particles of 16 nm primary average particle size | 2 mass parts |
| (Aerosil R972 produced by Nippon Aerosil Co.) | |
| Dichloromethane | 73 mass parts |
| Methanol | 10 mass parts |

100 mass parts of the cyclic olefin resin solution (D-2-1) and 1.43 mass of the fine particle liquid dispersion (M-2-11) were mixed to prepare a dope for film formation.

The dope was cast by using a band casting device at a production speed of 20 m/min. A film peeled at a residual amount of the solvent of 25 mass % was stretched by using a tenter at a rate of stretching of 2% in the width direction and dried by applying a hot blow while being held so as not to cause creases in the film.

Then, the tenter transportation was changed to the roll transportation, and the film was dried at 120° C. to 140° C., and taken up to obtain a cyclic olefin resin film. Detachment of fine particles could be confirmed over the entire film. The thickness, the static friction coefficient, the transmittance at 550 nm, the surface shape, absence or presence of creases in winding and absence or presence or detachment of fine particles of the obtained film (F-2-13) were measured and shown in Table 2-11

### Example 2-2

After charging the following composition in a mixing tank and dissolving each of the ingredients by stirring, they were filtered through filter paper with an average pore size of 34 μm and a sintered metal filter with an average pore size of 10 μm to obtain a cyclic olefin resin solution D-2-2.

(Cyclic olefin resin solution D-2-2)

| | |
|---|---|
| Appear 3000 (produced by Ferrania) | 150 mass parts |
| Dichloromethane | 380 mass parts |
| Methanol | 70 mass parts |

The following composition containing the cyclic olefin resin solution D-2-2 prepared by the method described above was charged in a dispersing device, to prepare a fine resin particle liquid dispersion.

(Fine particle liquid dispersion M-2-2)

| | |
|---|---|
| Silica particles of 16 nm primary average particle size | 2 mass parts |
| (Aerosil R972 produced by Nippon Aerosil Co.) | |
| Dichloromethane | 73 mass parts |
| Methanol | 10 mass parts |
| Cyclic olefin resin solution D-2-2 | 10 mass parts |

100 mass parts of the cyclic olefin resin solution (D-2-2) and 1.43 mass parts of the fine particle liquid dispersion (M−2-2) were mixed to prepare a dope for film formation.

The dope was cast by using a band casting device at a production speed of 20 m/min. A film peeled at a residual amount of the solvent of 25 mass % was stretched by using a tenter at a rate of stretching of 2% in the width direction and dried by applying a hot blow while being held so as not to cause creases in the film.

Then, the tenter transportation was changed to the roll transportation, and the film was dried at 120° C. to 140° C., and taken up to obtain a cyclic olefin resin film. The thickness, the static friction coefficient, the transmittance at 550 nm, the surface shape, absence or presence of creases in winding and absence or presence of detachment of fine particles of the obtained film (F-2-2) were measured and shown in Table 2-1.

### Example 2-3

The following composition containing the cyclic olefin resin solution (D-2-2) prepared by the method described in Example 2-2 was charged in a dispersing device, to prepare a fine resin particle liquid dispersion.

(Fine particle liquid dispersion M-2-3)

| | |
|---|---|
| PTFE particles of 0.3 μm average particle size | 2 mass parts |
| (Luburon L-2 produced by Daikin Industries Ltd.) | |
| Dichloromethane | 73 mass parts |
| Methanol | 10 mass parts |
| Cyclic olefin resin solution D-2-1 | 10 mass parts |

100 mass parts of the cyclic olefin resin solution (D-2-2) and 1.43 mass of the fine particle liquid dispersion (M-2-3) were mixed to prepare a dope for film formation.

The dope was cast by using a band casting device at a production speed of 20 m/min. A film peeled at a residual amount of the solvent of 25 mass % was stretched by using a tenter at a rate of stretching of 2% in the width direction and dried by applying a hot blow while being held so as not to cause creases in the film.

Then, the tenter transportation was changed to the roll transportation, and the film was dried at 120° C. to 140° C., and taken up to obtain a cyclic olefin resin film. The thickness, the static friction coefficient, the transmittance at 550 nm, the surface shape, absence or presence of crease in the winding and absence or presence of detachment of fine particles of the obtained film (F-2-3) were measured and shown in Table 2-1.

### Example 2-4

100 mass parts of the cyclic olefin resin solution (D-2-1) prepared in Example 2-1 and 1.43 mass of fine particle liquid dispersion (M-2-2) prepared in Example 2-2 were mixed to prepare a dope for film formation.

The dope was cast by using, a band casting device at a production speed of 20 m/min. A film peeled at a residual amount of the solvent of 25 mass % was stretched by using a tenter at a rate of stretching of 2% in the width direction and dried by applying a hot blow while being held so as not to cause creases in the film.

Then, the tenter transportation was changed to the roll transportation, and the film was dried at 120° C. to 140° C., and taken up to obtain a cyclic olefin resin film. The thickness, the static friction coefficient, the transmittance at 550 nm, the surface shape, absence or presence of crease in the winding and absence or presence of detachment of fine particles of the obtained film (F-2-4) were measured and shown in Table 2-1,

### Example 2-5

After charging the following composition in a mixing tank and dissolving each of the ingredients by stirring, and they were filtered through filter paper with an average pore size of 34 μm and a sintered metal filter with an average pore size of 10 μm to obtain a cyclic olefin resin solution D-2-4.

(Cyclic olefin resin solution D-2-4)

| | |
|---|---|
| Arton G (produced by JSR Co.) | 150 mass parts |
| Dichloromethane | 550 mass parts |
| Ethanol | 50 mass parts |

The following composition containing the cyclic olefin resin solution (D-2-4) prepared by the method described above was charged in a dispersing device, to prepare a fine resin particle liquid dispersion (M−2-4).

(Fine particle liquid dispersion M-2-4)

| | |
|---|---|
| Silica particles of 16 nm primary average particle size | 2 mass parts |
| (Aerosil R972 produced by Nippon Aerosil Co.) | |
| Dichloromethane | 75 mass parts |
| Ethanol | 5 mass parts |
| Cyclic olefin resin solution D-2-4 | 10 mass parts |

100 mass parts of the cyclic olefin resin solution (D-2-4) and 1.1 mass parts of the fine particle liquid dispersion (M-2-4) were mixed to prepare a dope for film formation.

The dope was cast by using a band casting device. A film peeled at a residual amount of the solvent of 22 mass % was stretched by using a tenter at a rate of stretching of 2% in the width direction and dried by applying a hot blow while being held so as not to cause creases in the film.

Then, the tenter transportation was changed to the roll transportation, and the film was dried at 120° C. to 140° C., and taken up to obtain a cyclic olefin resin film. The thickness, the static friction coefficient, the transmittance at 550 nm, the surface shape, absence or presence of crease in the winding and absence or presence of detachment of fine particles of the obtained film (F-2-5) were measured and shown in Table 2-1.

### Comparative Example 2-4

The following composition containing triacetyl cellulose was charged in a dispersing device, to prepare a fine resin particle liquid dispersion M-2-12.

### (Fine Particle Liquid Dispersion M-2-12)

(Fine particle liquid dispersion M-2-12)

| | |
|---|---|
| Silica particles of 16 nm primary average particle size | 2 mass parts |
| (Aerosil R972 produced by Nippon Aerosil Co.) | |
| Dichloromethane | 73 mass parts |
| Methanol | 10 mass parts |
| Triacetyl cellulose | 2 mass parts |

100 mass parts of the cyclic olefin resin solution (D-2-1) of Example 2-1 and 1.43 mass of the fine particle liquid dispersion (M−2-12) were mixed to prepare a dope for film formation.

The dope was cast by using a band casting device at a production speed of 20 m/min. A film peeled at a residual amount of the solvent of 25 mass % was stretched by using a tenter at a rate of stretching of 2% in the width direction and dried by applying a hot blow while being held so as not to cause creases in the film.

Then, the tenter transportation was changed to the roll transportation, and the film was dried at 120° C. to 140° C., and taken up to obtain a cyclic olefin resin film. Whitening occurred over the entire surface of the obtained film. The thickness, the static friction coefficient, the transmittance at 550 nm, the surface shape, absence or presence of crease in winding and absence or presence of detachment of fine particles of the obtained film (F-2-14) were measured and shown in Table 2-1.

### Example 2-6

After charging and stirring the following composition in a pressure proof tightly closed tank, it was heated at 80° C. with warm water to dissolve each of the ingredients. After cooling, it was filtered through filter paper of 34 μm average pore size and a sintered metal filter of 10 μm average pore size to obtain a cyclic olefin resin solution D-2-5.

(Cyclic olefin resin solution D-2-5)

| | |
|---|---|
| Topas 5013 (marketed from Polyplastics Co.) | 150 mass parts |
| Cyclohexane | 350 mass parts |

The following composition containing the cyclic olefin resin solution (D-2-5) prepared by the method described above was charged in a dispersing device, to prepare a fine resin particle liquid dispersion (M−2-5).

(Fine particle liquid dispersion M-2-5)

| | |
|---|---|
| Silica particles of 16 nm primary average particle size | 2 mass parts |
| (Aerosil R972 produced by Nippon Aerosil Co.) | |
| Cyclohexane | 75 mass parts |
| Cyclic olefin resin solution D-2-2 | 10 mass parts |

100 mass parts of the cyclic olefin resin solution (D-2-5) described above and 1.1 mass parts of fine particle liquid dispersion (M−2-5) were mixed to prepare a dope for film formation.

The dope was cast by using a band casting device. A film peeled at a residual amount of the solvent of 25 mass % was stretched by using a tenter at a rate of stretching of 2% in the width direction and dried by applying a hot blow while being held so as not to cause creases in the film.

Then, the tenter transportation was changed to the roll transportation, and the film was dried at 100° C. to 120° C., and taken up to obtain a cyclic olefin resin film. In a case of compulsorily frictioning the obtained film, while detachment of fine particles from the surface was observed, detachment were not caused during film formation, transportation, take-up, and fabrication. The thickness, the static friction coefficient, the transmittance at 550 nm, the surface shape, absence or presence of creases in winding and absence or presence of detachment of fine particles of the obtained film (F-2-6) were measured and shown in Table 2-1.

TABLE 2-1

| | | | | Liquid | | | | | | | |
|---|---|---|---|---|---|---|---|---|---|---|---|
| | | | Addition | dispersion | | | | | | Presence | |
| | | | of fine | preparation | | | Static | | | or | Presence or |
| | | | particle | step | | Film | friction | Trans- | Surface | absence of | absence of |
| | Film | Film | Yes (Y) | Yes (Y) | Dispersant | thickness | coefficient | mittance | shape | or | fine particle |
| | No. | polymer | No (N) | No (N) | polymer t | (μm) | at | at 550 nm | cramp | crease | detachment |
| Example | F-2-1 | P-2-1 | Y | Y | P-2-1 | 70 | 0.4 | 91.4 | A | A | A |
| | F-2-2 | Appear 3000 | Y | Y | Appear 3000 | 80 | 0.5 | 90.7 | A | A | A |
| | F-2-3 | Appear 3000 | Y | Y | Appear 3000 | 80 | 0.7 | 89.4 | A | A | A |
| | F-2-4 | P-2-1 | Y | Y | Appear 3000 | 80 | 0.5 | 90.8 | A | A | A |
| | F-2-5 | Arton G | Y | Y | Arton G | 80 | 0.4 | 90.8 | A | A | A |
| | F-2-6 | Topas | Y | Y | Topas | 85 | 0.5 | 90.7 | A | A | B |
| Comparative | F-2-11 | P-2-1 | N | N | N | 85 | 1.0 | 91.8 | B | B | N |
| Example | F-2-12 | P-2-1 | N | N | N | 80 | 0.6 | 90.3 | B | A | C |
| | F-2-13 | P-2-1 | Y | Y | N | 80 | 0.5 | 90.9 | A | A | C |
| | F-2-14 | P-2-1 | Y | Y | TAC | 80 | 0.8 | 79.9 | B | A | C |

Y indicates Yes, and N indicates No.

As can be seen from Table 2-1, while the cyclic olefin resin film tends to cause crease in winding, films comprising the cyclic olefin resin of the invention cause no creases in winding by the use of fine particles. Further, it can be seen that the film is stable, does not deteriorate in the transparency and can be formed into films in a great amount by the use of the cyclic olefin resin as the dispersant. Further, it can be seen that excellent cyclic olefin resin film with no detachment of fine particles can be produced by using the cyclic olefin resin having a polar group to the substituent as the dispersant.

### (Aging Evaluation for Fine Particle Liquid Dispersion)

For fine particle liquid dispersion (M-2-1) and fine particle liquid dispersion (M-2-11), respective liquid dispersions were tightly closed in a vessel made of a fluoro resin, and stored at a room temperature and aging stability of secondary average particle size after dispersion was evaluated. Secondary average particle size of the respective liquid dispersions of fine particles before and after aging was measured and shown in Table 2-2.

For the secondary average particle size of fine particles in the fine particle liquid dispersion, after obtaining a grain size distribution graph by using a centrifugal type grain size distribution tester (CAPA 500, produced by Horiba Seisakusho Co.) and then the average particle size was determined based on the graph.

TABLE 2-2

| | |
|---|---|
| Fine particle | Fine particle size (μm) |

| | Liquid | Before | After aging |
|---|---|---|---|
| | dispersion | aging | for 80 days |
| Example | M-2-1 | 0.3 | 0.3 |
| Comp. Example | M-2-11 | 0.4 | 0.6 |

As can be seen from Table 2-2, it can be seen that the fine particle liquid dispersion of the invention can prevent detachment of fine particles after film formation and stabilize the fine particles of the film, as well as the liquid dispersion itself is an excellent liquid dispersion which is excellent in the aging stability and causes no coarse fine particle coagulates for a long time. It can be seen that the fine particle liquid dispersion of the invention is extremely effective with practical and economical points of view such that it can be stored for a long time while satisfactorily keeping the stably dispersed state and enables additional supplement of the dispersing treating agent in the production.

### Example 2-5

### Manufacture of Polarizing Plate

A polarizer was manufactured by adsorption of iodine to a stretched polyvinyl alcohol film.

Glow discharging treatment (high frequency voltage at 3000 Hz and 4200 V applied between upper and lower electrodes, treatment for 20 sec) was applied to cyclic polyolefin films prepared in Examples 2-1 and 2-2 (F-2-1, F-2-2, respectively) which were then bonded to the surface and rear face of a polarizer by using a polyvinyl alcohol type adhesive and dried at 70° C. for 10 min or more.

In the manufactured polarizing plate A, the cyclic polyolefin film F-2-1 was bonded on one side and the cyclic polyolefin film F-2-2 was bonded on the opposite side of the polarizer. Further, they were arranged such that the axis of transmission of the polarizer and the phase retardation axis of the cyclic polyolefin film F-2-2 were in parallel, Further, they were arranged such that the axis of transmission of the polarizer and the phase retardation axis of the cyclic polyolefin film F-2-1 were crossed.

In the manufactured polarizing plate B, cyclic polyolefin film F-2-1 was bonded on both sides of the polarizer. Further, the axis of transmission of the polarizer and the retardation phase axis of the cyclic polyolefin film F-2-1 were arranged such that they were crossed.

### <Manufacture of VA Liquid Crystal Cell>

A liquid crystal cell was produced by dripping and injecting a liquid crystal material having a negative dielectric anisotropy (“MLC6608”, produced by Merck Co.) between substrates at a cell gap of 3.6 μm and sealing the same thereby forming a liquid crystal layer between the substrates. The retardation of the liquid crystal layer (that is, the product Δn·d of the thickness d (μm) of the liquid crystal layer and the refractive index anisotropy Δn) was defined as 300 nm. The liquid crystal material was vertically aligned. The manufactured polarizing plate B was bonded by way of an adhesive to the upper side of the vertically aligned type liquid crystal cell (on the side of an observer). The manufactured polarizing plate A was bonded by way of an adhesive to the lower side of the liquid crystal cell (on the side of the back light). They were arranged in a crossed Nichol state such that the axis of transmission of the upper polarizing plate was in the vertical direction and the axis of transmission of the lower polarizing plate was in the right-to-left direction.

As a result of observing the produced liquid crystal display device, neutral black display could be attained both in the frontal direction and in the view angle direction. Further, as a result of measuring the view angle (at a contrast ratio of 10 or more, in a range with no gradation reversal on the black side) at 8 stages from black indication (L1) to white indication (L8) by using a measuring instrument (EZ-Contrast 160D, produced by ELDIM Co.), satisfactory view angle of 80° or more could be obtained both for right and left.

In what follows, the further invention will be specifically described with reference to examples. However, the invention is not restricted to the examples.

### Synthesis Example

### Synthesis of Polymer P-3-1 as Cyclic Polyolefin

In the beginning, 180 parts by mass of purified toluene and 100 parts by mass of norbornene-5-methanol acetate were charged in a reaction vessel. In the next place, 0.04 parts by mass of palladium (II) acetyl acetonate dissolved in 80 parts by mass of toluene, 0.04 parts by mass of tricyclohexylphosphine and 0.20 parts by mass of dimethylanilinium tetrakis (pentafluorophenyl) borate were charged in the reaction vessel, followed by allowing reacting at 90° C. for 18 hr under agitation. After the reaction came to completion, a reaction mixture was poured in excess ethanol to generate polymer precipitates. A polymer (P-3-1) obtained by purifying the precipitates was dried by vacuum drying at 65° C. for 24 hr.

### <Synthesis of Polymer P-3-2 as Cyclic Polyolefin>

Then, 100 parts by mass of purified toluene and 100 parts by mass of norbornene carbonic acid methyl ester were charged in a reaction vessel. Subsequently, 25 mmol % (relative to a mass of monomer) of ethylhexanoate Ni dissolved in toluene, 0.225 mol % (relative to a mass of monomer) of tri(pentafluorophenyl)boron and 0.25 mol % of triethylaluminate dissolved in toluene were charged in a reaction vessel, followed by allowing reacting at room temperature for 18 hr under agitation. After the reaction came to completion, a reaction mixture was poured in excess ethanol to generate polymer precipitates. A polymer (P-3-2) obtained by purifying the precipitates was dried by vacuum drying at 65° C. for 24 hr.

### [Preparation of Dope]

Dopes A through L were prepared in accordance with prescriptions shown Table 3-1 below.

TABLE 3-1

| | | Dope | | | | | | | | | | | |
|---|---|---|---|---|---|---|---|---|---|---|---|---|---|
| Composition | | A | B | C | D | E | F | G | H | I | J | K | L |
| 1) | | 21.0 | → | → | → | → | → | → | → | 0 | 21.0 | → | → |
| 2) | | 0 | → | → | → | → | → | → | → | 21.0 | 0 | → | → |
| 3) | Methylene chloride | 92.0 | → | → | → | → | → | → | → | → | 90.0 | 92.0 | → |
| | (% by mass) | | | | | | | | | | | | |
| | Metanol (% by mass) | 8.0 | → | → | → | → | → | → | → | → | 10.0 | 8.0 | → |
| 4) | 5) | 0 | 0.02 | 0.13 | 0.25 | 0.5 | 0.6 | 0.75 | 1.0 | 0.13 | → | 0 | 2.5 |
| | 6) | 0 | → | → | → | → | → | → | → | → | → | 0.13 | 0 |

| | | | | | | | | | | | | |
|---|---|---|---|---|---|---|---|---|---|---|---|---|
| 7) | None | Yes | → | → | → | → | → | → | → | → | → | → |

* A → mark shows that it is same as that in the left column.
1) Concentration of cyclic polyolefin resin (P-3-1) (% by mass)
2) Concentration of cyclic polyolefin resin (P-3-2) (% by mass)
3) Solvent composition
4) Additive
5) Aerosil R972 (trade name, produced by Nippon Aerosil Co., Ltd.) (% by mass to cyclic polyolefin resin)
6) Seahoster KE-P50 (trade name, produced by Nippon Shokubai Co., Ltd.) (% by mass to cyclic polyolefin resin)
7) Preparation step of dispersion solution

### Examples 3-1 through 3-7, Comparative Example 3-4

A base layer dope A in which fine particles are not added and a superficial layer dope C (E, G, H, J, K, I and L) in which fine particles are added in accordance with the dope prescription shown in Table 3-1 were co-cast to form one base layer and two superficial layers that have, respectively, a thickness of 60 μm (base layer) and 10 μm (superficial layer) (80 μm in total) after drying. Hot air heated at 100° C. was used to dry to an extent where an amount of residual solvent becomes 10% by mass, followed by further drying with hot air heated at 140° C. for 30 min, and thereby a cyclic polyolefin film having a three-layer structure of Example 3-1 (Examples 3-2 through 3-7 and Comparative Example 3-4) was obtained.

### Examples 3-8 Through 3-13

A base layer dope A in which fine particles are not added and a superficial layer dope C (E, G, H, J and K) in which fine particles are added in accordance with the dope prescription shown in Table 3-1 were sequentially cast to form one base layer and two superficial layers that have, respectively, a thickness of 60 μm (base layer) and 10 μm (superficial layer) (80 μm in total) after drying. Hot air heated at 100° C. was used to dry to an extent where an amount of residual solvent becomes 10% by mass, followed by further drying with hot air heated at 140° C. for 30 min, and thereby a cyclic polyolefin film having a three-layer structure of Example 3-8 (Examples 3-9 through 3-13) was obtained.

### Examples 3-14 Through 3-16

A base layer dope A in which fine particles are not added and a superficial layer dope D (F and H) in which fine particles are added in accordance with the dope prescription shown in Table 3-1 were co-cast to form one base layer and two superficial layers so as to have, respectively, a thickness of 70 μm (base layer) and 5 μm (superficial layer) (80 μm in total) after drying Hot air heated at 100° C. was used to dry to an extent where an amount of residual solvent becomes 10% by mass, followed by further drying with hot air heated at 140° C. for 30 min, and thereby a cyclic polyolefin film having a three-layer structure of Example 3-14 (Examples 3-15 through 3-16) was obtained.

### Comparative Examples 3-1 through 3-3

Only a dope B (G, H) in which fine particles are added in accordance with the dope prescription shown in Table 3-1 was cast to form a single layer with a dry thickness of 80 μm, followed by drying with hot air heated at 100° C. so that an amount of residual solvent may be 10% by mass, further followed by further drying with hot air heated at 140° C. for 30 min, and thereby a cyclic polyolefin film having a single layer structure of Comparative Example 3-1 (Comparative Examples 3-2 and 3-3) was obtained.

Of the obtained respective films, the static friction coefficient, dynamic friction coefficient, generation of squeaking and creases, the transparency and haze were measured and evaluated. Results are shown in Table 3-2.

In the next place, various kinds of measurement and evaluation methods will be described.

### [Static Friction Coefficient and Dynamic Friction Coefficient]

After test samples were kept for 2 hr in an atmosphere of 25° C. and 60% RH, one was cut in a 35 mm×35 mm size to use as a measurement needle and relatively slid over the other one at a speed of 60 cm/min under weight of 100 g. With a surface property measurement meter (trade name: HEIDON-14, produced by Shinto Kagaku Co., Ltd.), the static friction coefficient and dynamic friction coefficient of front and back surfaces of the test sample were measured.

### [Squeaking]

The squeaking is a phenomenon generated at the time of winding when the flatness of inner and outer surfaces of a roll is high when a film is wound at the time of preparing a film support and the dynamic friction coefficient between the inner surface and outer surface is high. This state was evaluated with the dynamic friction coefficient measured above.

The squeaking was evaluated in accordance with criteria shown below

A: the dynamic friction coefficient is 0.7 or less

B: the dynamic friction coefficient is larger than 0.7

### [Crease]

When a film is heat-treated to prepare a film support, owing to poor slidability thereof, elongation or contraction of a film causes irregularity to generate creases to the film, and thereby the flatness is deteriorated. In order to evaluate the phenomenon, with a narrow handling device, the handling is applied at a low tension to evaluate occurrence of the creases at a roll and winding.

The evaluation of the crease in the table was carried out as follows.

A: the crease was not generated

B: the creases were generated

### [Transparency]

The transparency was obtained by measuring the transmittance of visible rays with a transparency meter (for instance, one produced by Tokai Seisakusho Corp.).

The transparency in the table was evaluated as follows.

A: the transmittance is 92% or more

B: the transmittance is 90% or more and less than 92%

C: the transmittance is 88% or more and less than 90%

D: the transmittance is less than 88%

### [Haze]

A sample of 40 mm×80 mm was measured under 25° C. and 60% RH with a haze meter (trade name: HGM-2DP, produced by Suga Testing Machine Co., Ltd.) in accordance with JIS K-6714.

The haze in the table was evaluated as follows.

A: 1.0% or less

B: larger than 1.0% and 2.0% or less

C: more than 2.0%

TABLE 3-2

| | | Dope | | | | | | | |
|---|---|---|---|---|---|---|---|---|---|
| | | Prescription | | Measured | | Evaluation | | | |
| | | Base | Superficial | Value | | Result | | | |
| 1) | 2) | Layer | layer | 3) | 4) | 5) | 6) | 7) | 8) |
| Example 3-1 | 9) | A | C | 0.65 | 0.62 | A | A | A | A |
| Example 3-2 | | A | E | 0.61 | 0.55 | A | A | B | A |
| Example 3-3 | | A | G | 0.57 | 0.51 | A | A | B | A |
| Example 3-4 | | A | H | 0.55 | 0.51 | A | A | B | A |
| Example 3-5 | | A | J | 0.53 | 0.50 | A | A | B | A |
| Example 3-6 | | A | K | 0.52 | 0.48 | A | A | B | A |
| Example 3-7 | | A | I | 0.64 | 0.60 | A | A | C | B |
| Example 3-8 | 10) | A | C | 0.65 | 0.62 | A | A | A | A |
| Example 3-9 | | A | E | 0.61 | 0.55 | A | A | B | A |
| Example 3-10 | | A | G | 0.57 | 0.51 | A | A | B | A |
| Example 3-11 | | A | H | 0.55 | 0.51 | A | A | B | A |
| Example 3-12 | | A | J | 0.53 | 0.50 | A | A | B | A |
| Example 3-13 | | A | K | 0.52 | 0.48 | A | A | B | A |
| Example 3-14 | 11) | A | D | 0.64 | 0.61 | A | A | A | A |
| Example 3-15 | | A | F | 0.59 | 0.55 | A | A | B | A |
| Example 3-16 | | A | H | 0.55 | 0.51 | A | A | B | A |
| Comparative | 12) | B | — | 1.15 | 0.75 | B | B | B | A |
| Example 3-1 | | | | | | | | | |
| Comparative | | G | — | 0.57 | 0.50 | A | A | C | B |
| Example 3-2 | | | | | | | | | |
| Comparative | | H | — | 0.54 | 0.49 | A | A | D | C |
| Example 3-3 | | | | | | | | | |
| Comparative | 9) | A | L | 0.52 | 0.44 | A | A | D | C |
| Example 3-4 | | | | | | | | | |

1) Examples and Comparative Examples
2) Mode of Casting
3) Static Friction Coefficient
4) Dynamic Friction Coefficient
5) Squeaking
6) Crease
7) Transparency
8) Haze
9) Co-casting, superficial layer 10 μm
10) Sequential casting, superficial layer 10 μm
11) Co-casting, superficial layer 5 μm
12) Single layer casting, 80 μm

From results shown in Table 3-2, it was found that a cyclic polyolefin film according to the invention, while inhibiting the squeaking and creases from occurring, having adequate slidability, not deteriorating the transparency and not increasing the haze, is very excellent in the characteristics and the handling property as an optical film (Examples 3-1 through 3-16). In Example 3-7 where the base layer and the superficial layer were formed with separate resins, in comparison with other Examples where same resin was used to layer, the transparency was deteriorated a little and the haze was increased; accordingly, the base layer and the superficial layer are preferably formed of the same resin.

On the other hand, in a cyclic polyolefin film made of a single layer, even when there was no occurrence of the squeaking and the creases, when a content of particles exceeds a certain level, the transparency became poor (Comparative Examples 3-1 through 3-3).

### Example 3-17

### Preparation of Polarizing Plate

A stretched polyvinyl alcohol film was allowed absorbing iodine and thereby a polarizer was prepared

A cyclic polyolefin film (F-3-1) prepared in Example 3-1 was subjected to glow discharge treatment (a high frequency voltage of 3000 Hz and 4200 V was applied between upper and lower electrodes for 20 sec to treat), followed by adhering to one side of the polarizer as shown below with a polyvinyl alcohol base adhesive. Furthermore, a commercially available cellulose triacylate film (trade name: Fujitac TD80UF, produced by Fuji Photo Film Co., Ltd.) was saponified, adhered on an opposite side of the polarizer with a polyvinyl alcohol base adhesive, followed by drying at 70° C. for 10 min or more, and thereby a polarizing plate A was prepared.

A transmission axis of a polarizing film and a retardation axis of the cyclic polyolefin film (F-3-1) were disposed so as to be in parallel each other. The transmission axis of a polarizing film and a retardation axis of the commercially available cellulose triacylate film were disposed so as to be orthogonal each other.

### (Preparation of VA Liquid Crystal Cell)

In a liquid crystal cell, a cell gap between substrates was set at 3.6 μm, a liquid crystal material having negative dielectric anisotropy (trade name: MLC6608, produced by Merck Co., Ltd.) was dropped between the substrates and encapsulated, and thereby a liquid crystal layer was prepared between the substrates. The retardation of the liquid crystal layer (that is, a product Δn·d of a thickness d of the liquid crystal layer d (μm) and the refractive index anisotropy Δn of the liquid crystal layer) was set at 300 nm. The liquid crystal material was vertically aligned. On an upper side (observer side) of the vertically aligned liquid crystal cell, a commercially available super-high contrast article (trade name: HLC2-5618, produced by Sanritz Corporation) was adhered with an adhesive. With a transmission axis of the upper side polarizing plate directed vertically and with a transmission axis of a lower side polarizing plate directed horizontally, a cross Nicol state was taken.

When prepared liquid crystal display devices were observed, it was found that neutral black display is realized from both of a front direction and a view angle direction. Furthermore, by use of a measurement unit (trade name: EZ-Contrast 160D, produced by Eldim Corp.), in eight stages from black display (L1) to white display (L8), view angles (in a range where the contrast ratio is 10 or more and a gradation reversal on a black side is not caused) were measured; as a result thereof, it was found that in both of right and left directions the view angles are excellently 80° or more.

### INDUSTRIAL APPLICABILITY

Embodiment of the present invention can provide a cyclic polyolefin film excellent in the hygroscopicity or the moisture permeability, with less change of the optical characteristics caused by the change of temperature and humidity, excellent in the handling characteristics, and with no optical unevenness. Further, another embodiment of the invention can provide a polarizing plate or a liquid crystal device excellent in the stability in film formation and the fabrication characteristics, and with no image unevenness.

The invention can provide a liquid dispersion of fine particles excellent in dispersion stability for use in solution casting film formation. Since the liquid dispersion of fine particles is extremely excellent in the dispersion stability, it is extremely effective with practical and economical view points such that it can be stored for a long time while being kept in the dispersed state satisfactorily, and enables additional supplement of the dispersion treatment agent in the production. Further, by producing a cyclic olefin resin film prepared by using the liquid dispersion of fine particles of the invention, it is possible to obtain a cyclic olefin resin film excellent in the slipperiness and light transmittance, and reduced with frictional injuries and obstacle failure during fabrication of a polarizing plate caused by detachment of fine particles. Further, a polarizing plate and a liquid crystal display device having such excellent cyclic olefin resin film can be obtained. Further, since the cyclic olefin film of the invention causes extremely less detachment of fine particles, the fabricability upon production of the polarizing plate can be improved remarkably to enhance the yield in the fabrication.

The entire disclosure of each and every foreign patent application from which the benefit of foreign priority has been claimed in the present application is incorporated herein by reference, as if fully set forth.

1. A method of producing a cyclic polyolefin film comprising:
dissolving or dispersing a cyclic polyolefin resin and at least one compound selected from a higher fatty acid and a derivative of the higher fatty acid in a solvent;
a casting step; a drying step; and a taking-up step.

2. A method of producing a cyclic polyolefin film comprising:
dissolving a cyclic polyolefin resin in a solvent;
a casting step; a drying step; and a taking-up step,
wherein the method further comprises coating a coating solution containing at least one compound selected from a higher fatty acid and a derivative of the higher fatty acid on at least one surface of a film after casting.

3. The method of producing a cyclic polyolefin film according to claim 1,
wherein the derivative of the higher fatty acid is a metal salt of the higher fatty acid, an amide compound of the higher fatty acid or an ester compound of the higher fatty acid.

4. The method of producing a cyclic polyolefin film according to claim 1,
wherein fine particles having a primary average grain size of from 0.001 μm to 20 μm are added to the cyclic polyolefin resin.

5. The method of producing a cyclic polyolefin film according to claim 4,
wherein the fine particles are metal oxides or inorganic silicon compounds.

6. The method of producing a cyclic polyolefin film according to claim 1,
wherein a film formed from the solvent is stretched after the casting step.

7. A cyclic polyolefin film produced by a method according to claim 1.

8. The cyclic polyolefin film according to claim 7,
wherein the cyclic polyolefin film has a thickness of from 20 μm to 500 μm, and a light transmittance of the cyclic polyolefin film at a measured wavelength of 550 nm is 88% or more.

9. A protective film for a polarizing plate, which comprises a cyclic polyolefin film according to claim 7.

10. An optically-compensatory film comprising a cyclic polyolefin film according to claim 7.

11. A polarizing plate comprising a protective film for a polarizing plate according to claim 9.

12. A liquid crystal display device comprising at least one of a cyclic polyolefin film according to claim 7, a protective film for a polarizing plate comprising a cyclic polyolefin film according to claim 7 and an optically-compensatory film comprising a cyclic polyolefin film according to claim 7.

13. A method of preparing a liquid dispersion of fine particles, which comprises:
subjecting fine particles, an organic solvent and a dispersant to a dispersing treatment,
wherein the dispersant contains a cyclic olefin resin.

14. The method of preparing a liquid dispersion of fine particles according to claim 13,
wherein the cyclic olefin resin has a polar group at a substituent.

15. The method of preparing a liquid dispersion of fine particles according to claim 13,
wherein the fine particles comprise an inorganic compound or a polymeric compound, and an average primary particle size of the inorganic compound or the polymeric compound is from 10⁻³ to 100 μm.

16. The method of preparing a liquid dispersion of fine particles according to claim 13,
wherein the fine particles are fine silicon dioxide particles.

17. A liquid dispersion of fine particles produced by a method of preparing a liquid dispersion of fine particles according to claim 13.

18. A method of preparing a dope comprising:
admixing a liquid dispersion of fine particles according to claim 17 to a cyclic olefin resin solution containing a cyclic olefin resin and an organic solvent.

19. The method of preparing a dope according to claim 18, which comprises:
transporting the liquid dispersion of the fine particles by a conduit;
in-line adding the liquid dispersion of the fine particles to the cyclic olefin resin solution transported by another conduit at a joint pipe; and then
mixing by an inline mixer.

20. The method of preparing a dope according to claim 18,
wherein the cyclic olefin resin in the liquid dispersion of the fine particles and the cyclic olefin resin in the cyclic olefin resin solution are identical.

21. The method of preparing a dope according to claim 18,
wherein the liquid dispersion of the fine particles is obtained by filtration through a filter with an absolute filtration rating of from 10 to 100 μm.

22. A cyclic olefin resin film produced by a solution casting film forming method utilizing a dope produced by a preparation method according to claim 18.

23. The cyclic olefin resin film according to claim 22,
wherein a static friction coefficient between identical materials to each other is 0.8 or less.

24. A polarizing plate comprising:
a polarizer; and
at least two protective films disposed on both sides of the polarizer,
wherein at least one of the at least two protective films is a cyclic olefin resin film according to claim 22.

25. A liquid crystal display device comprising at least one of a cyclic olefin resin film according to claim 22 and a polarizing plate comprising:
a polarizer; and
at least two protective films disposed on both sides of the polarizer, wherein at least one of the at least two protective films is a cyclic olefin resin film according to claim 22.
